(19) United States
(12) Patent Application Publication
(10) Pub. No.: US 2026/0194755 A1
(43) Pub. Date: Jul. 9, 2026

(54) OPTICAL MODULE, NEAR-EYE DISPLAY MODULE AND APPARATUS, AND MANUFACTURING METHOD of NEAR-EYE DISPLAY MODULE

(71) Applicant: GYGES LABS PTE. LTD., Singapore (SG)

(72) Inventors: Jieyang JIA, Shenzhen (CN); Xudong DENG, Shenzhen (CN); Zheng LV, Shenzhen (CN); Yingnan ZHAI, Shenzhen (CN); Dong PU, Shenzhen (CN); Jiang SHEN, Shenzhen (CN)

(21) Appl. No.: 19/565,623

(22) Filed: Mar. 13, 2026

Related U.S. Application Data
(63) Continuation of application No. PCT/CN2024/117538, filed on Sep. 6, 2024.

(30) Foreign Application Priority Data
Sep. 13, 2023 (CN) 2023111912240
Sep. 13, 2023 (CN) 2023224964840
Sep. 25, 2023 (CN) 2023112456048
Sep. 25, 2023 (CN) 2023112460700
Sep. 25, 2023 (CN) 2023112564983
Sep. 28, 2023 (CN) 2023226722992
Oct. 31, 2023 (CN) 2023114398333
May 21, 2024 (CN) 2024211123466
Aug. 26, 2024 (CN) 2024220758162

(51) Int. Cl. G02B 27/01

(52) U.S. Cl. CPC G02B 27/0172

(57) ABSTRACT

The present application provides an optical module, a near-eye display module and apparatus, and a manufacturing method of a near-eye display module. The optical module includes: a first reflection window configured to reflect light; a second reflection window spaced apart at an opposite end of the first reflection window, where the second reflection window faces the first reflection window and receives light reflected from the first reflection window; an entrance window arranged at the center of the second reflection window and aligned with the first reflection window, the entrance window being configured to allow light to be incident into a space formed by the first reflection window and the second reflection window; and an exit window surrounding the first reflection window, the exit window being arranged opposite to the second reflection window, and the entrance window being configured to mount a micro-display.

This application claims priority to the following Chinese patent applications, the entire contents of each of which are incorporated herein by reference: Chinese Patent Application No. 2023224964840, filed on Sep. 13, 2023, and titled “OPTICAL MODULE AND AUGMENTED REALITY DISPLAY DEVICE”; Chinese Patent Application No. 2023111912240, filed on Sep. 13, 2023, and titled “AUGMENTED REALITY DISPLAY DEVICE AND MANUFACTURING METHOD THEREOF”; Chinese Patent Application No. 2023112564983, filed on Sep. 25, 2023, and titled “MANUFACTURING METHOD OF AUGMENTED REALITY DISPLAY MODULE AND AUGMENTED REALITY DISPLAY MODULE THEREOF”; Chinese Patent Application No. 2023114398333, filed on Oct. 31, 2023, and titled “PREPARATION METHOD OF AUGMENTED REALITY DISPLAY DEVICE, DISPLAY DEVICE AND INJECTION MOLD”; Chinese Patent Application No. 2023112460700, filed on Sep. 25, 2023, and titled “MOLD FOR MANUFACTURING OPTICAL MODULE, OPTICAL MODULE MANUFACTURING METHOD AND OPTICAL MODULE”; Chinese Patent Application No. 2023112456048, filed on Sep. 25, 2023, and titled “MANUFACTURING METHOD OF NEAR-EYE DISPLAY DEVICE AND NEAR-EYE DISPLAY DEVICE THEREOF”; Chinese Patent Application No. 2023226722992, filed on Sep. 28, 2023, and titled “NEAR-EYE DISPLAY DEVICE AND OPTICAL MODULE”; Chinese Patent Application No. 2024211123466, filed on May 21, 2024, and titled “A NEAR-EYE DISPLAY DEVICE AND WEARABLE APPARATUS”; and Chinese Patent Application No. 2024220758162, filed on Aug. 26, 2024, and titled “A NEAR-EYE DISPLAY DEVICE AND WEARABLE APPARATUS”.

### TECHNICAL FIELD

The present application belongs to the field of near-eye display technology, and in particular, to an optical module, a near-eye display module and apparatus, and a manufacturing method of a near-eye display module.

### BACKGROUND

Current mainstream AR (Augmented Reality) display technology mainly adopts waveguide technology. Waveguides couple light projected by a micro-display into their own glass substrate, couple the light into a transmission channel through the principle of “total internal reflection” to transmit it to the front of the eye, and then a decoupler releases the light into the human eye. As a core component, optical element technology generally includes prisms, free-form surfaces, and waveguides. However, the above optical technical solutions are relatively complex and have problems such as large volume.

### SUMMARY OF THE INVENTION

In a first aspect, the present application provides an optical module, applied in a near-eye display module, the optical module including: a first reflection window configured to reflect light; a second reflection window, spaced apart from the first reflection window at an opposite end of the first reflection window, the second reflection window facing the first reflection window, the second reflection window being configured to receive light reflected from the first reflection window; an entrance window, disposed at a center of the second reflection window and aligned with the first reflection window, the entrance window being configured to allow light to be incident into a space formed by the first reflection window and the second reflection window; and an exit window, surrounding the first reflection window, the exit window being disposed opposite to the second reflection window, the exit window being configured to allow light to exit from the space formed by the first reflection window and the second reflection window; where the entrance window is used for mounting a micro-display, and light from the micro-display enters the first reflection window from the entrance window, is reflected by the first reflection window to the second reflection window, and then exits through the exit window. Folding the optical path through primary and secondary reflections effectively reduces the overall volume. At the same time, this small volume can be assembled into other devices without significantly affecting those devices.

In a second aspect, the present application also provides a near-eye display module, the module including a micro-display and the optical module according to the first aspect described above, the micro-display is disposed at the entrance window of the optical module.

In a third aspect, the present application also provides a near-eye display apparatus, the apparatus including a second housing and the near-eye display module according to the second aspect described above disposed in the second housing.

In a fourth aspect, the present application also provides a method for manufacturing a near-eye display module, for manufacturing the near-eye display module according to the second aspect described above, where the method includes: providing a first mold; providing a second mold, where a plurality of convex surfaces, a plurality of first surfaces, a plurality of second surfaces, and a plurality of annular surfaces are between the first mold and the second mold; injecting a light-transmitting material in a molten state between the first mold and the second mold; pressing the first mold and the second mold together so that the light-transmitting material in a molten state conforms to the convex surfaces, the first surfaces, the second surfaces, and the annular surfaces; demolding the first mold and the second mold to obtain a base body formed by solidification of the light-transmitting material, where the base body includes: a concave wall complementary in shape to the convex surfaces, a first wall surrounding the concave wall, and the base body further includes an annular wall complementary to the annular surfaces, and a second wall surrounded by the annular wall; and depositing a reflective layer on the concave wall and the annular wall to form a first reflection window and a second reflection window respectively, while without depositing a reflective layer on the first wall and the second wall to form an exit window and an entrance window respectively.

Further relevant beneficial technical effects of the present application will be described in the following embodiments.

### BRIEF DESCRIPTION OF THE DRAWINGS

To describe the technical solutions in the embodiments of the present application more clearly, the following briefly introduces the accompanying drawings required for describing the embodiments. The accompanying drawings in the following description are some embodiments of the present application. For those of ordinary skill in the art, other drawings can be obtained based on these drawings without creative effort.

FIG. 1 is a schematic structural diagram of an embodiment of an optical module of the present application;

FIG. 2 is a schematic structural diagram of another embodiment of the optical module of the present application;

FIG. 3 is a schematic structural diagram of another embodiment of the optical module of the present application;

FIG. 4 is a schematic structural diagram of an embodiment of a near-eye display module of the present application;

FIG. 5 is a schematic structural diagram of an embodiment of a partial enlarged view of the near-eye display module of the present application;

FIG. 6 is a schematic structural diagram of another embodiment of the near-eye display module of the present application;

FIG. 7 is a schematic structural diagram of an embodiment of a packaged near-eye display module of the present application;

FIG. 8 is a schematic structural diagram of an embodiment of a near-eye display apparatus of the present application;

FIG. 9 is a schematic structural diagram of an embodiment of the near-eye display module of the present application before assembly;

FIG. 10 is a schematic structural diagram of an embodiment of the near-eye display module of the present application after assembly;

FIG. 11 is a schematic structural diagram of another embodiment of the near-eye display module of the present application;

FIG. 12 is a schematic overall structural diagram of an embodiment of the optical module of the present application;

FIG. 13 is a schematic cross-sectional structural diagram of an embodiment of the optical module of the present application;

FIG. 14 is a schematic structural diagram of another embodiment of the optical module of the present application;

FIG. 15 is a schematic structural diagram of an embodiment of the near-eye display module of the present application;

FIG. 16 is a schematic structural diagram of an embodiment of the near-eye display module of the present application;

FIG. 17 is an exploded perspective view of an embodiment of the near-eye display module of the present application;

FIG. 18 is a schematic structural diagram of an embodiment of a first housing of the near-eye display module of the present application;

FIG. 19 is a schematic structural diagram of an embodiment of the optical module of the near-eye display module of the present application;

FIG. 20 is a schematic cross-sectional structural diagram of an embodiment of the optical module of the near-eye display module provided by the present application.

FIG. 21 is a schematic cross-sectional structural diagram of another embodiment of the optical module of the near-eye display module provided by the present application;

FIG. 22 is an exploded perspective view of an embodiment of the first housing of the near-eye display module provided by the present application;

FIG. 23 is a schematic structural diagram of an embodiment of the near-eye display module provided by the present application;

FIG. 24 is a schematic structural diagram of an embodiment of the near-eye display apparatus provided by the present application;

FIGS. 25-32 are schematic flow diagrams illustrating an embodiment of a method for manufacturing a near-eye display module provided by the present application;

FIG. 33 is a schematic structural diagram of another embodiment of the near-eye display module provided by the present application;

FIG. 34 is a schematic flow diagram of an embodiment of a method for manufacturing a near-eye display module provided by the present application;

FIG. 35 is a schematic structural diagram of a mold according to an embodiment of the method for manufacturing a near-eye display module provided by the present application;

FIG. 36 is a schematic structural diagram of a mold according to another embodiment of the method for manufacturing a near-eye display module provided by the present application;

FIG. 37 is a schematic structural diagram of a mold according to another embodiment of the method for manufacturing a near-eye display module provided by the present application;

FIG. 38 is a schematic structural diagram of injecting molten material according to an embodiment of the method for manufacturing a near-eye display module provided by the present application;

FIG. 39 is a schematic structural diagram of pressing the molds together according to an embodiment of the method for manufacturing a near-eye display module provided by the present application;

FIG. 40 is a schematic structural diagram of the main body after demolding according to an embodiment of the method for manufacturing a near-eye display module provided by the present application;

FIG. 41 is a bottom schematic structural diagram of the main body after demolding according to an embodiment of the method for manufacturing a near-eye display module provided by the present application;

FIG. 42 is a bottom schematic structural diagram of the main body after demolding according to another embodiment of the method for manufacturing a near-eye display module provided by the present application;

FIG. 43 is a schematic diagram of the coating structure according to an embodiment of the method for manufacturing a near-eye display module provided by the present application;

FIG. 44 is a schematic diagram of the coating structure according to another embodiment of the method for manufacturing a near-eye display module provided by the present application;

FIG. 45 is a schematic structural diagram of mounting a micro-display according to an embodiment of the method for manufacturing a near-eye display module provided by the present application;

FIG. 46 is a schematic structural diagram of cutting according to an embodiment of the method for manufacturing a near-eye display module provided by the present application;

FIG. 47 is a schematic structural diagram of an embodiment of the near-eye display module provided by the present application;

FIG. 48 is a flow diagram of another embodiment of a method for manufacturing a near-eye display module provided by the present application;

FIGS. 49-56 are schematic structural diagrams of the positive lens corresponding to each step in the method for manufacturing a near-eye display module provided in FIG. 48;

FIG. 57 is a flow diagram of another embodiment of a method for manufacturing a near-eye display module provided by the present application;

FIG. 58 is a schematic left lens structural diagram of an embodiment of injection molding using the injection mold provided by the present application;

FIG. 59 is a schematic left lens structural diagram corresponding to an embodiment after demolding from the mold in FIG. 58;

FIG. 60 is a schematic structural diagram of another embodiment of the near-eye display module provided by the present application;

FIG. 61 is a flow diagram of an embodiment of a method for manufacturing a near-eye display module provided by the present application;

FIG. 62 is a schematic structural diagram of a mold according to an embodiment of the method for manufacturing a near-eye display module provided by the present application;

FIG. 63 is a schematic structural diagram of a mold according to another embodiment of the method for manufacturing a near-eye display module provided by the present application;

FIG. 64 is a schematic structural diagram of pressing the molds together according to an embodiment of the method for manufacturing a near-eye display module provided by the present application;

FIG. 65 is a schematic structural diagram of the optical base body after demolding according to an embodiment of the method for manufacturing a near-eye display module provided by the present application;

FIG. 66 is a bottom schematic structural diagram of the main body after demolding according to an embodiment of the method for manufacturing a near-eye display module provided by the present application;

FIG. 67 is a bottom schematic structural diagram of the main body after demolding according to another embodiment of the method for manufacturing a near-eye display module provided by the present application;

FIG. 68 is a schematic diagram of the coating structure according to an embodiment of the method for manufacturing a near-eye display module provided by the present application;

FIG. 69 is a schematic structural diagram of mounting a micro-display according to an embodiment of the method for manufacturing a near-eye display module provided by the present application;

FIG. 70 is a schematic structural diagram of cutting in an embodiment of the method for manufacturing a near-eye display module provided by the present application.

FIG. 71 is a schematic structural diagram of packaging according to an embodiment of the method for manufacturing a near-eye display module provided by the present application;

FIG. 72 is a schematic structural diagram of packaging according to an embodiment of the method for manufacturing a near-eye display module provided by the present application;

FIG. 73 is a schematic structural diagram of an embodiment of the near-eye display module provided by the present application;

FIG. 74 is a schematic structural diagram of an embodiment of a mold for manufacturing an optical module provided by the present application.

### DETAILED DESCRIPTION

To make the technical problems, technical solutions, and beneficial effects to be solved by the present application clearer, the following further describes the present application in detail with reference to the accompanying drawings and embodiments. It should be understood that the specific embodiments described herein are only used to explain the present application and are not intended to limit the present application.

It should be noted that when an element is referred to as being “fixed to” or “disposed on” another element, it can be directly on the other element or indirectly on the other element. When an element is referred to as being “connected to” another element, it can be directly connected to the other element or indirectly connected to the other element.

It should be understood that the terms “length”, “width”, “upper”, “lower”, “front”, “rear”, “left”, “right”, “vertical”, “horizontal”, “top”, “bottom”, “inner”, “outer”, and the like indicate orientations or positional relationships based on the orientations or positional relationships shown in the drawings. They are only for convenience of describing the present application and simplifying the description, and do not indicate or imply that the referred device or element must have a specific orientation, be constructed and operated in a specific orientation. Therefore, they should not be construed as limiting the present application.

Furthermore, the terms “first” and “second” are used for descriptive purposes only and should not be understood as indicating or implying relative importance or implicitly indicating the number of indicated technical features. Thus, features defined with “first” and “second” may explicitly or implicitly include one or more of these features. In the description of the present application, “plurality” means two or more, unless expressly and specifically defined otherwise.

The optical module, the near-eye display module and apparatus, and the manufacturing method of the near-eye display module provided by the embodiments of the present application will be described.

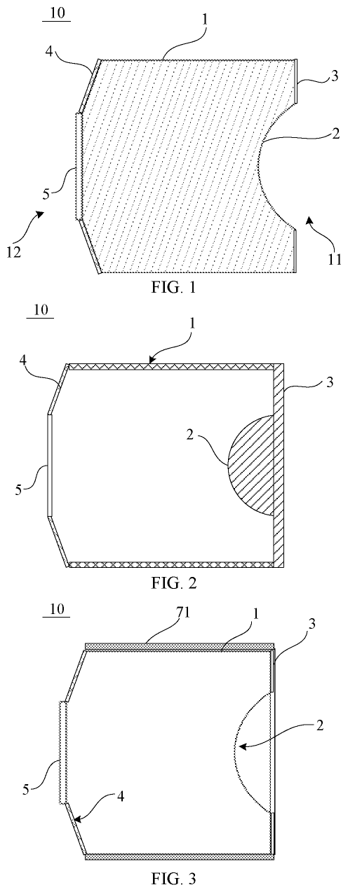

As shown in FIG. 1, the present application provides an optical module 10, applied in a near-eye display module, which includes: a first reflection window 2 configured to reflect light; a second reflection window 4 is spaced apart from the first reflection window 2 at an opposite end thereof, the second reflection window 4 faces the first reflection window 2, and the second reflection window 4 is configured to receive light reflected from the first reflection window 2. It can be understood that the first reflection window 2 and the second reflection window 4 can be coated with a reflective layer or reflective material to enable them to reflect light. The first reflection window 2 and the second reflection window 4 can be spherical curved reflection, aspherical curved reflection, non-curved reflection (specular reflection), etc. An entrance window 5 is disposed at the center of the second reflection window 4 and aligned with the first reflection window 2, i.e., the entrance window 5 and the first reflection window 2 are also center-aligned; the entrance window 5 is configured to allow light to enter the space formed by the first reflection window 2 and the second reflection window 4; and an exit window 3 is disposed parallel to the entrance window 5 and surrounds the first reflection window 2, the exit window 3 is configured to allow light to exit from the space formed by the first reflection window 2 and the second reflection window 4. Such a formed space can be solid or hollow. In the present application, the first reflection window 2 can also be described as a primary reflection mirror or a first reflective surface, and the second reflection window 4 can also be described as a secondary reflection mirror or a second reflective surface. The entrance window 5 is used for mounting a micro-display 6. Light from the micro-display 6 enters the first reflection window 2 through the entrance window 5, is reflected by the first reflection window 2 to the second reflection window 4, and then exits through the exit window 3. It can be understood that the entrance window 5 and the exit window 3 can be solid entities and made of the same material. For example, the material used for the entire optical module can be a transparent or light-transmitting hard machinable material, such as PMMA (polymethyl methacrylate), PC (polycarbonate) plastic, resin, glass, etc. It should be understood that the entrance window 5 and the exit window 3 can be virtual entities, for example, they can be openings in a solid part, as long as they can satisfy the corresponding light incidence and light exitance. The optical module 10 as a whole can be columnar, for example, it can be cylindrical, prismatic, truncated cone-shaped, or other regular shapes, it can also be irregular, etc. The formed whole can have opposite parallel the first end 11 and the second end 12.

In some embodiments, the first reflection window 2 can be any one of an inclined surface, a spherical surface, an aspherical surface, or a free-form surface; where the first reflection window 2 and the exit window 3 are arranged in a non-coplanar manner, i.e., they are not on the same plane. The second reflection window 4 can be any one of an inclined surface, a spherical surface, an aspherical surface, or a free-form surface. The second reflection window 4 and the entrance window 5 are arranged in a non-coplanar manner, i.e., they are not on the same plane. The first reflection window 2 and the second reflection window 4 can be formed by injection molding, turning, photolithography, or other processes. The schematic diagrams of the present application are cross-sectional schematic reference diagrams. In the diagrams, the first reflection window 2 is shown as curved, and the second reflection window 4 can be an aspherical inclined plane, or it can be curved.

The micro-display 6 can be Micro-LED (Micro Light-Emitting Diode), uLED (micro light-emitting diode), Micro-OLED (Micro Organic Light-Emitting Diode), LCOS (Liquid Crystal On Silicon), LCD (Liquid Crystal Display), DMD (Digital Micromirror Device) DLP (Digital Light Processing), LBS (Laser Beam Scanning), or any combination of these technologies. The micro-display 6 can provide an image source, such as text, video, information prompts, etc.

Light L enters through the entrance window 5, is first reflected by the first reflection window 2 to the second reflection window 4, and then exits through the exit window 3. In this folded optical path, light transmission can be unaffected. Folding the optical path through primary and secondary reflections effectively reduces the overall volume. At the same time, this small volume can be assembled into other devices without significantly affecting those devices, for example, by drastically altering the appearance or structure of previous devices and causing overly abrupt impacts.

In some embodiments, the reflective layer or reflective material coated on the first reflection window 2 and the second reflection window 4 can be a metal or metal alloy, such as aluminum, silver, or a mixture of aluminum and silver, etc. Of course, other materials such as metal oxides like aluminum oxide, dielectric materials like silicon dioxide or titanium oxide, high-reflectivity polymer materials, or special coating materials are also feasible. In the present application, “emission layer” and “reflective material” can be understood similarly.

In some embodiments, as shown in FIG. 1, the optical module 10 further includes a sidewall 1. The sidewall 1 can be annular. One end of the sidewall 1 is connected to the exit window 3, and the opposite end of the sidewall 1 is connected to the second reflection window 4. The region enclosed by the first reflection window 2, the exit window 3, the sidewall 1, the second reflection window 4, and the entrance window 5 is a solid light-transmitting (or transparent) medium with uniform light transmittance, such as transparent PMMA (polymethyl methacrylate), PC (polycarbonate) plastic, resin glass, or other media. The reflective materials of the first reflection window 2 and the second reflection window 4 are disposed on the side away from the solid light-transmitting medium. In some embodiments, the first reflection window 2 can be formed by recessing the solid transparent base body. For example, the shapes of the first reflection window 2 and the second reflection window 4 can be formed by processes such as cutting, injection molding, etc. Then, the reflective material or reflective layer can be disposed directly on their surfaces using processes such as coating, vacuum deposition, physical vapor deposition, chemical vapor deposition, electroplating, electroless plating, etc. For example, in FIG. 1, the first reflection window 2 is a solid recessed configuration, and the reflective material is disposed facing the direction of the exit window 3 plane. The solid light-transmitting (or transparent) medium with uniform light transmittance can ensure that light L propagates (reflects) in a uniform medium without refraction or scattering. Additionally, it can make the entire optical module 10 more robust.

In some embodiments, the entrance window 5 can be a plane, and the second reflection window 4 can be a plane, spherical surface, aspherical surface, or free-form surface, etc.; the entrance window 5 and the second reflection window 4 are respectively two different types of surfaces. In other embodiments, the entrance window 5 can be a spherical surface, aspherical surface, or free-form surface, etc., and the entrance window 5 and the second reflection window 4 together form a continuous surface. The entrance window 5 and the second reflection window 4 can be designed by the same function in optical design, for example, generated using Zernike polynomials. In some embodiments, the exit window 3 can be a plane, and the first reflection window 2 can be a spherical surface, aspherical surface, or free-form surface, etc.; the exit window 3 and the first reflection window 2 are respectively two different types of surfaces. In other embodiments, the exit window 3 can be a spherical surface, aspherical surface, or free-form surface, etc., and the exit window 3 and the first reflection window 2 together form a continuous surface. The exit window 3 and the first reflection window 2 can be designed by the same function in optical design, for example, generated using Zernike polynomials. In other embodiments, the first reflection window 2 and the entrance window 5 can be the same type of surface, for example, both being planes, or both being one of spherical, aspherical, or free-form surfaces. The outline shapes of the entrance window 5 and the first reflection window 2 can be the same, for example, polygonal, circular, or elliptical, etc. The first reflection window 2 and the entrance window 5 can be designed by the same function. In some embodiments, the first reflection window 2, the exit window 3, the second reflection window 4, and the entrance window 5 can be designed by the same function, for example, generated using Zernike polynomials.

In some embodiments, as shown in FIG. 2, the optical module 10 further includes a sidewall 1. One end of the sidewall 1 is connected to the exit window 3, and the opposite end of the sidewall 1 is connected to the second reflection window 4. The region enclosed by the first reflection window 2, the exit window 3, the sidewall 1, the second reflection window 4, and the entrance window 5 is hollow. The reflective material of the first reflection window 2 is disposed on the side facing the hollow region, and the reflective material of the second reflection window 4 is disposed on the side facing or away from the hollow region. In some embodiments, a solid assembly including the first reflection window 2 and the exit window 3 can be formed by injection molding or turning. Subsequently, a reflective material or reflective layer can be disposed on the surface of the first reflection window 2 using processes such as coating, vacuum deposition, physical vapor deposition, chemical vapor deposition, electroplating, electroless plating, etc. Then, a solid assembly including the second reflection window 4 and the sidewall 1 can be formed using similar processes. Subsequently, a reflective material or reflective layer can be disposed on the front or back side of the second reflection window 4 using processes such as coating, vacuum deposition, physical vapor deposition, chemical vapor deposition, electroplating, electroless plating, etc. Finally, the two assemblies with the reflective material disposed are fixed together, e.g., by adhesive bonding, to form a hollow optical module. For example, in FIG. 2, the first reflection window 2 is located in the hollow region, and the reflective material also faces the hollow region (i.e., faces the entrance window). The hollow configuration can reduce the weight of the optical module 10, which is further beneficial for its assembly into other wearable devices. Of course, it also saves material. On the other hand, it improves the overall production process flow from another perspective.

A transverse dimension of the first reflection window 2 is greater than or equal to a transverse dimension of the entrance window 5, and the first reflection window 2 and the entrance window 5 are center-aligned. The transverse dimension of the first reflection window 2 is greater than or equal to a transverse dimension of the micro-display 6. A dimension of a region enclosed by the first reflection window 2, the exit window 3, the sidewall 1, the second reflection window 4, and the entrance window 5 is from 1 cubic millimeter to 1 cubic centimeter. The size is relatively small, making it easier to integrate into various other devices, such as glasses, without affecting the original device's appearance or large-area structure, offering good adaptability.

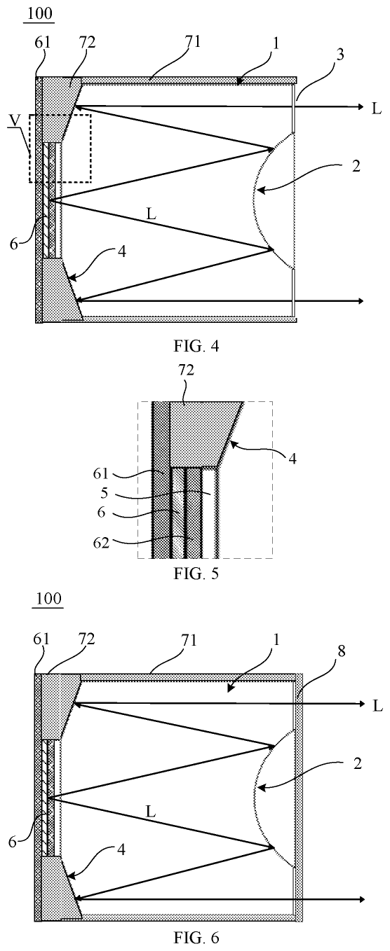

In some embodiments, as shown in FIGS. 1, 2, and 4, the transverse dimension of the first reflection window 2 is greater than or equal to the transverse dimension of the entrance window 5, and the first reflection window 2 and the entrance window 5 are center-aligned. The transverse dimension of the first reflection window 2 is greater than or equal to the transverse dimension of the micro-display 6. This ensures that all light L from the entrance window 5 can reach the first reflection window 2 and be reflected. If the transverse dimension of the first reflection window 2 were smaller than the entrance window 5 (or the mounted micro-display 6, as shown in FIG. 4), the light entering from the entrance window 5 and exiting directly from the exit window 3 would partially overlap with light entering from the entrance window 5, being reflected by the first reflection window 2 and the second reflection window, and then exiting directly from the exit window 3, affecting the final imaging. If such an effect is acceptable, then the transverse dimension of the first reflection window 2 being appropriately smaller than the transverse dimension of the micro-display 6 is also acceptable.

The micro-display 6 has a resolution of not less than 2 arcminutes per pixel for a wearer's field of view, and a pixel-to-pixel pitch of the micro-display does not exceed 5 micrometers.

In some embodiments, the micro-display 6 can be a light-emitting pixel array. In some embodiments, the pixel-to-pixel pitch of the micro-display does not exceed 4 micrometers. The magnification of the image projected by the micro-display 6 is not less than 2.5. For example, the image source is magnified 3, 4, or 10 times before reaching the retina, ensuring that the content of the projected image is clearly seen. This can be measured from the projected image of the micro-display 6 to the retina of the wearer. The projected image of the micro-display 6 covers at least an 8° field of view of the wearer, for example, 8°, 15°, 20°, etc.; it does not occupy the entire human field of view of about 60°, ensuring that the wearer can see both the projected image and the real-world image.

In some embodiments, in conjunction with FIGS. 3, 5, and 6, the optical module further includes a first non-transmissive layer 71 that does not allow light to pass through. The first non-transmissive layer 71 covers and shields the sidewall 1, allowing only the entrance window 5 and the exit window 3 to be exposed relative to the first non-transmissive layer 71. The first non-transmissive layer 71 can be integrated with the sidewall 1, for example, the outer side of the sidewall 1 itself is opaque; or the first non-transmissive layer 71 can be separately disposed on the sidewall 1 using processes such as coating, deposition, or other encapsulation methods. The first non-transmissive layer 71 can be made of an opaque material such as black, for example, black epoxy resin or black silicone rubber. The first non-transmissive layer 71 is flush with the second reflection window 4 and the exit window 3, and allows the entrance window 5 and the exit window 3 to be exposed relative to the first non-transmissive layer 71, ensuring that the entire circumferential sidewall 1 is completely covered and light L is not allowed to exit from the sidewall 1, reducing the loss of light ultimately exiting from the exit window 3. Of course, the transverse dimension of the entrance window exit window 3 equals the transverse dimension of the second reflection window 4, facilitating the formation of a regular shape and convenient subsequent packaging or adaptation with other devices. Of course, to achieve comprehensive shielding, the non-reflective surface of the second reflection window 4 can also be covered by the first non-transmissive layer 71. FIG. 3 is only for the convenience of illustrating the first non-transmissive layer 71. The first non-transmissive layer 71 can be a coating or material such as black epoxy resin, black silicone rubber, carbon black, nickel black, black chrome, or Vantablack. In other embodiments, it can also be a non-transmissive sealing sleeve 70, etc.

As shown in FIGS. 4-6, the present application also provides a near-eye display module 100. The near-eye display module 100 includes a micro-display 6 and the optical module 10 as described above. The micro-display 6 is disposed at the entrance window 5 position of the optical module 10, for example, the micro-display 6 and the entrance window 5 are coaxially arranged. The micro-display 6 can provide an image source. The near-eye display module 100 can be applied in head-mounted devices such as smart glasses, sunglasses, sports glasses, prescription glasses, or helmets, or in heads-up displays or other optical or display field devices. The description of the optical module 10 and the micro-display 6 can be found in the above embodiments and will not be repeated here.

In some embodiments, as shown in FIGS. 4-5, the near-eye display module 100 may further include an intermediate layer 62. The intermediate layer 62 is located between the micro-display 6 and the entrance window 5 to bond the micro-display 6 to the entrance window 5. The intermediate layer can be a transparent optical adhesive. The intermediate layer 62 can serve to fix the micro-display 6 and the optical module 1, and it does not cause optical loss. Of course, if the micro-display 6 and the entrance window 5 are pressed together tightly enough, the intermediate layer may be absent. In some embodiments, the intermediate layer can also be air, etc., and the micro-display 6 can be fixed by an external package or a sleeve.

In some embodiments, as shown in FIGS. 4-5, the near-eye display module 100 may further include a backplane 61. The backplane 61 is located on a side of the micro-display 6 away from the entrance window 5 and is electrically connected to the micro-display 6. The backplane 61 can be a drive board such as a circuit board, which can be rigid or flexible. The backplane 61 is used for connecting a driving power source to provide electrical drive for the micro-display 61. The backplane 61 can be larger than or equal to the micro-display 6 (e.g., a light-emitting device). Of course, it is preferable that the size of the backplane 61 matches the overall size to ensure a relatively regular shape or facilitate subsequent packaging.

In some embodiments, as shown in FIGS. 4-6, the near-eye display module 100 may further include a second non-transmissive layer 72. The second non-transmissive layer 72 fills gaps between the micro-display 6, the backplane 61, the intermediate layer 62, and the second reflection window 4. The second non-transmissive layer 72 allows at least a portion of the backplane 61 to be exposed to facilitate connection to an external circuit (e.g., a driver or power source). The second non-transmissive layer 72 can achieve overall pre-positioning and packaging of the optical module 10, the micro-display 6, the backplane 61, and the intermediate layer 62, reducing the probability of component displacement. It can also appropriately encapsulate the micro-display 6 and the intermediate layer 62 to prevent light leakage. The material of the second non-transmissive layer 72 can be the same as that of the first non-transmissive layer 71, for example, it can be black epoxy resin or black silicone rubber, etc. In some embodiments, the first non-transmissive layer 71 and the second non-transmissive layer 72 can be an integrated body. For example, the non-transmissive layer may not be provided initially in the optical module 10, but instead, it may be provided directly during the packaging of the near-eye display module 100, i.e., they can be integrally formed.

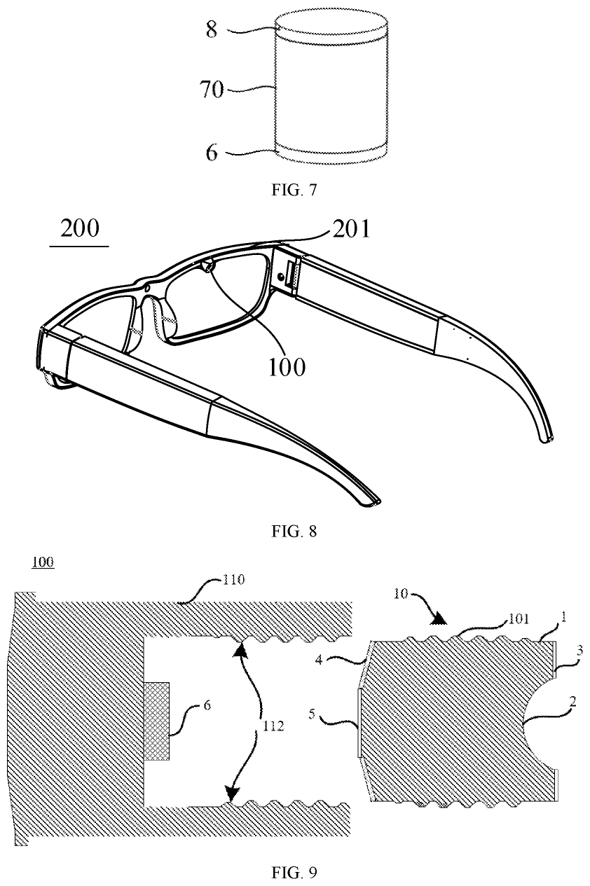

In some embodiments, as shown in FIG. 6, the near-eye display module 100 may further include a protective light-transmitting layer 8. The light-transmitting layer 8 is disposed on the end surface of the exit window 3, and the light-transmitting layer 8 covers the exit window 3 and the first reflection window 2. In some embodiments, the light-transmitting layer 8 can be fixed by means such as adhesive bonding or snap-fitting. The light-transmitting layer 8 can be a light-transmitting or transparent material, which may not alter the original light propagation path. It can protect the exit window 3 and the first reflection window 2, reducing wear and tear, and also preventing dust and other debris from entering and affecting the reflection efficiency of the first reflection window 2. It can be understood that descriptions related to the protective light-transmitting layer, light-transmitting layer, or protective layer herein can be understood similarly or analogously.

In some embodiments, as shown in FIGS. 4-6, the first non-transmissive layer 71 and the second non-transmissive layer 72 can also be understood as an encapsulation layer. In some embodiments, the first non-transmissive layer 71, the second non-transmissive layer 72, or the encapsulation layer can fill the gap between the second reflection window 4 and the backplane 61. For example, when they are black epoxy resin or black silicone rubber, they can achieve filling, allowing at least portions of the exit window 3 and the backplane 61 to be exposed relative to the first non-transmissive layer 71, the second non-transmissive layer 72, or the encapsulation layer, for example, ensuring the wires of the backplane 61 are exposed. The first non-transmissive layer 71, the second non-transmissive layer 72, or the encapsulation layer are configured to fix the second reflection window 4, the micro-display 6, and the backplane 61, enabling overall pre-positioning and packaging of the optical module 10, the micro-display 6, and the backplane 61, reducing the probability of component displacement. The above encapsulation can ensure that the entire near-eye display module is cylindrical or prismatic, etc. Of course, the near-eye display module can also be irregularly shaped (e.g., as described in relevant embodiments below) composed of combinations of plates, cylinders, or other shapes.

In some embodiments, as shown in FIG. 7, the first non-transmissive layer 71, the second non-transmissive layer 72, or the encapsulation layer can also be replaced by a sleeve 70. That is, the annular sidewall 1, the second reflection window 2, the micro-display 6, and the backplane 61 are located within the sleeve 70, and the leads of the backplane 61, the first reflection window 2, and the exit window 3 are exposed relative to the sleeve. In some embodiments, the bottom of the sleeve may be provided with a through hole, so that the leads of the backplane 61 can pass through the through hole to electrically connect to the micro-display 6.

The overall size of the assembly consisting of the first reflection window 2, the second reflection window 4, the entrance window 5, the exit window 3, the sidewall 1, the micro-display 6, and the light-transmitting layer 8 is from 0.5 cubic millimeters to 5 cubic centimeters, for example, 0.5 cubic millimeters, 1 cubic millimeter, 8 cubic millimeters, 1 cubic centimeter, 2 cubic centimeters, 5 cubic centimeters, etc. Its size is relatively small to the naked eye, making it easier to integrate into various other devices, such as glasses or other head-mounted devices, without affecting the original device's appearance or large-area structure, offering good adaptability. In some embodiments, the above overall size may also include the first non-transmissive layer 71, the second non-transmissive layer 72, or the encapsulation layer.

In some embodiments, as shown in the figures, the near-eye display module 100 may further include a first housing 110. The first housing 110 is provided with a first connecting portion 112. The first connecting portion 112 can be a thread, a slider, a protrusion, a spring pin, etc. The optical module 10 is provided with a second connecting portion 101. The second connecting portion 101 can be a thread, a chute, a protrusion, etc., as long as it can mate with the first connecting portion 112. The second connecting portion 101 is integrally formed with the optical module 10. The first connecting portion 112 and the second connecting portion 101 are matched with each other to adjust a distance between the micro-display 6 and the entrance window 5. In some embodiments, the sleeve and the first housing 110 can be understood to have the same or similar function. By the match between the first connecting portion 112 and the second connecting portion 101, such as threaded engagement, chute cooperation, elastic sliding cooperation, or screw drive, the distance between the optical module 10 with the folded optical path and the micro-display 6 can be adjusted, thereby making the overall imaging effect adjustable and meeting different design or wearing requirements.

The first connecting portion 112 may include a first thread, which is integrally formed with the first housing 110. For example, it can be a thread formed by injection molding or cutting the first housing 110. The second connecting portion 101 includes a second thread, which is integrally formed with the sidewall 1 and/or the exit window 3, and the entrance window 5. In some embodiments, the sidewall 1, the exit window 3, and the entrance window 5 as a whole can be an integrally formed material, and the second thread is integrally formed on the sidewall 1. Alternatively, in some embodiments, the sidewall 1 is made separately, and the exit window 3 is made separately, and then the sidewall 1 and the exit window 3 are bonded together. In this case, the second thread can be integrally formed on the sidewall 1. The thread can be formed by, for example, cutting or injection molding. The first thread and the second thread are matched with each other by threading to adjust the distance between the micro-display 6 and the entrance window 5. It can be understood that the embodiment of the present application does not require an additional sleeve structure. The first thread is directly formed on the first housing 110, and the second thread is formed on the corresponding side surface position on the outer periphery of the optical module 10. The first thread and the second thread are matched with each other to achieve distance adjustment. This effectively reduces the number of related components (e.g., sleeves), which is beneficial for forming a smaller-sized optical module, thereby further reducing the weight of the entire near-eye display module 100 and reducing costs associated with sleeve mold opening.

In some embodiments, the second thread does not occupy the entire sidewall 1; it can be located near the middle of the sidewall 1 or positioned from the middle towards the second reflection window 4.

In some embodiments, the first connecting portion 112 includes a first thread integrally formed with the first housing 110. The second connecting portion 101 includes a sleeve (not shown) sleeved on the sidewall 1, and a second thread is provided on a side of the sleeve away from the side surface. The first thread and the second thread are matched with each other by threading to adjust the distance between the micro-display 6 and the entrance window 5. It can be understood that to protect the sidewall 1, a sleeve can be provided on the sidewall 1 and threadedly connected to the first thread of the first housing 110, effectively reducing the risk of damage to the optical module 10.

In some embodiments, as shown in FIG. 11, the near-eye display module 100 further includes a flexible member 130. The flexible member 130 can be made of an elastic material such as plastic or rubber. For example, the flexible member 130 can be annular. The flexible member 130 is sleeved on the second thread and located between the first thread and the second thread. It can be understood that when the optical module 10 is rotated to achieve a preset distance adjustment and no further rotation occurs, the flexible member 130 can be tightly fitted between the first thread and the second thread to ensure no further sliding, which is beneficial for maintaining a fixed distance between the micro-display 6 and the entrance window 5 of the optical module 10, even during user movement while wearing. In some embodiments, the distance from the plane where the flexible member 130 is located to the exit window 3 is greater than the distance from the exit window 3 to a plane tangent to the lowest point of the first reflection window 2, which can ensure the position of the flexible member 130 can be fully located between the first thread and the second thread, to reduce the possibility that the flexible member 130 cannot achieve close contact with the first thread and the second thread due to being too high. In some embodiments, the sidewall 1 may be provided with a groove, the height of the groove being in the middle of the first thread, and the flexible member 130 is assembled in the corresponding groove. In some embodiments, flexible member, elastic member, elastic ring can be understood similarly or analogously.

In some embodiments, the first connecting portion 112 includes a protrusion that can retract relative to the first housing 110. As shown in FIG. 14, the second connecting portion 101 includes a plurality of grooves arranged at intervals. The protrusion and the grooves engage with each other to adjust the distance between the micro-display 6 and the entrance window 5. In some embodiments, a spring may be sleeved on the protrusion. In a natural state, the protrusion can be located in a groove. When distance adjustment is required, the protrusion is pulled to overcome the spring force, causing the protrusion to disengage from the groove. Then the protrusion is placed in the groove at the desired height, and the protrusion is released. The spring force causes the protrusion to engage with the groove. That is, by engaging the protrusion with different grooves, different distance adjustments between the optical module 10 and the micro-display 6 are achieved.

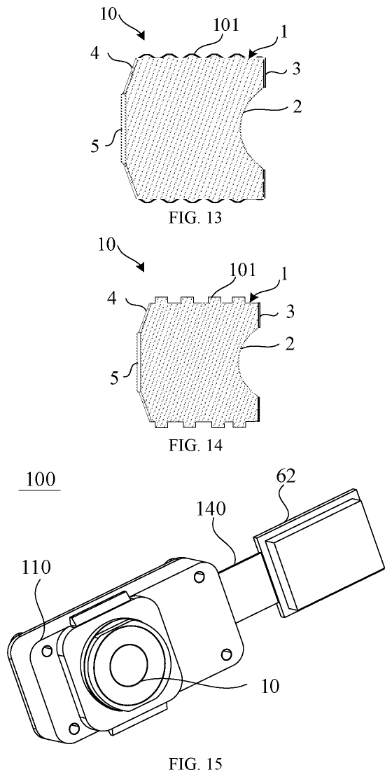

The size of a region enclosed by the first reflection window 2, the exit window 3, the sidewall 1, the second reflection window 4, the entrance window 5, and the second connecting portion 101 is from 1 cubic millimeter to 1 cubic centimeter. In some embodiments, as shown in FIGS. 8-14, the transverse dimension of the first reflection window 2 is greater than or equal to the transverse dimension of the entrance window 5, and the first reflection window 2 and the entrance window 5 are center-aligned. The transverse dimension of the first reflection window 2 is greater than or equal to the transverse dimension of the micro-display 6. That is, it satisfies that all light from the entrance window 5 can reach the first reflection window 2 for reflection. If the transverse dimension of the first reflection window 2 were smaller than the entrance window 5 (or the mounted micro-display 6, e.g., FIG. 4), then light entering from the entrance window 5 and exiting directly from the exit window 3 would partially overlap with light entering from the entrance window 5, being reflected by the first reflection window 2 and the secondary reflection surface, and then exiting directly from the exit window 3, affecting the final imaging. If such an effect is acceptable, then the transverse dimension of the first reflection window 2 being appropriately smaller than the transverse dimension of the micro-display 6 is also acceptable. Its size is relatively small to the naked eye, making it easier to integrate into various other devices, such as glasses, without affecting the original device's appearance or large-area structure, offering good adaptability.

In some embodiments, the first connecting portion 112 and/or the second connecting portion 101 is provided with a non-transmissive layer, which includes any one of coatings or materials such as black epoxy resin, black silicone rubber, carbon black, nickel black, black chrome, or Vantablack. Ensuring that the entire circumferential sidewall 1 is completely covered and light is not allowed to exit from the sidewall 1 reduces the final light loss. In some embodiments, the non-transmissive layer can be an opaque sealing sleeve, etc.

The present application provides a near-eye display module, including: a housing, provided with a first connecting portion; a micro-display, disposed on the housing, the micro-display projecting light; an optical module, spaced apart from the micro-display, where the optical module includes: a first reflective surface, configured to reflect light; a second reflective surface, spaced apart from the first reflective surface at an opposite end thereof, facing the first reflective surface, the second reflective surface being configured to receive light reflected from the first reflective surface; an incident surface, disposed at a center of the second reflective surface and aligned with the first reflective surface, the incident surface being configured to allow light to enter a space formed by the first reflective surface and the second reflective surface; an exit surface, surrounding the first reflective surface, the exit surface being configured to allow light to exit from the space formed by the first reflective surface and the second reflective surface; and a side surface, one end of the side surface connecting the exit surface, and the opposite end of the side surface connecting the second reflective surface, the side surface being provided with a second connecting portion, where the first connecting portion and the second connecting portion are matched with each other to adjust a distance between the micro-display and the incident surface. By means of the first connecting portion and the second connecting portion, the distance between the optical module with the folded optical path and the micro-display can be adjusted, thereby making the overall imaging effect adjustable.

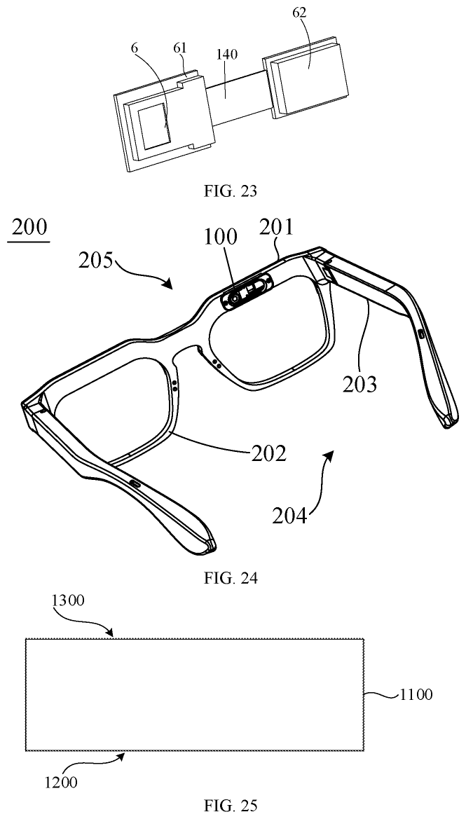

In some embodiments, as shown in FIGS. 15-24, the first housing 110 is provided with a mounting hole 110. The housing 110 can be made of materials such as plastic or metal.

The optical module 10 is at least partially located within the mounting hole 110. The optical module 10 can receive the image generated by the micro-display 6 and project it into the user's eye, for example, viewer side 204 of the near-eye display apparatus 200 shown in FIG. 24. The optical module 10 can be made of light-transmitting materials such as epoxy resin or glass.

The flexible member 130 is elastic and located within the mounting hole 110. The material hardness of the flexible member 130 can be less than the material hardness of the first housing 110 and the material hardness of the optical module 10. The flexible member 130 can be made of materials such as rubber, silicone, flexible plastic, etc. In other embodiments, it could also be, for example, an easily curable adhesive, etc.

In some embodiments, the flexible member 130 is disposed surrounding the optical module 10, and the flexible member 130 is fixedly connected to the optical module 10. The flexible member 130 is clamped between the inner wall of the mounting hole 110 and the optical module 10, and the flexible member 130 is in tight fit with the inner wall of the mounting hole 110. With the match of the flexible member 130, the optical module 10 can be fixed in the mounting hole 110 of the first housing 110. The optical module 10 and the inner wall of the mounting hole 110 are tightly fitted together, causing the flexible member 130 to deform at least partially in the circumferential direction and the axial direction. It can be understood that before being installed between the inner wall of the mounting hole 110 and the optical module 10, the flexible member 130 may have a first thickness in the circumferential direction and the axial direction. When the optical module 10 and the inner wall of the mounting hole 110 are brought close to each other for tight fitting by snapping, screwing, or abutting, the optical module 10 and the inner wall of the mounting hole 110 exert pressure in the circumferential and axial directions, thereby causing the flexible member 130 to be compressed and deformed both axially and circumferentially. Of course, if the flexible member 130 is completely placed within the mounting hole 110, the entire circumference and axial direction of the flexible member 130 can deform. Therefore, after the optical module 10 is installed into the mounting hole 110, the flexible member 130 can have a second thickness in the circumferential and axial directions, and the second thickness is less than the first thickness. This change in thickness leads to a change in deformation, for example, the flexible member 130 is compressed and deformed, etc. This deformation can be irreversible. The flexible member 130 can enhance the tightness and firmness of the optical module 10 installed in the mounting hole 110. Additionally, the flexible member 130 protects the optical module 10, effectively preventing the optical module 10 from being damaged, cracked, etc., due to compression.

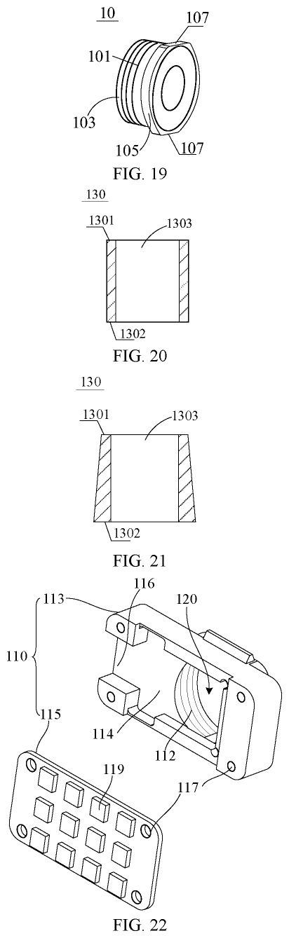

As shown in FIGS. 17 and 19, the optical module 10 includes a base body 103. The flexible member 130 is provided with a through hole 1303. The base body 103 is inserted into the through hole 1303. The cross-sectional shapes of the through hole 1303 and the base body 103 are the same. For example, the cross-sectional shapes of the through hole 1303 and the base body 103 are both circular, rectangular, pentagonal, polygonal, elliptical, etc.

Along its own axial direction, the cross-sectional area of the base body 103 remains constant; along its own axial direction, the cross-sectional area of the through hole 1303 remains constant. After assembling the optical module 10 and the through hole 1303, the axial directions of the optical module 10 and the through hole 1303 are substantially coaxial. In FIG. 17, the direction indicated by arrow a represents the axial direction of the base body 103 and the optical module 10. In the assembled state, the axial directions of the optical module 10 and the through hole 1303 are parallel or coaxial.

The inner wall of the mounting hole 110 is provided with a first connecting portion 112, and the outer wall of the base body 103 is provided with a second connecting portion 101. The first connecting portion 112 corresponds to and is fixedly connected to the second connecting portion 101. The first connecting portion 112 and the second connecting portion 101 are connected to each other and deform the flexible member 130 at least partially in the circumferential and axial directions. Through the match between the first connecting portion and the second connecting portion, the optical module 10 is fixedly connected to the inner wall of the mounting hole 110, and the flexible member 130 is deformed and fixed between the optical module 10 and the inner wall of the mounting hole 110.

In some embodiments, as shown in FIG. 17, the first connecting portion 112 is threadedly connected to the second connecting portion 101. The first connecting portion 112 may include an internal thread 311, and the second connecting portion may include an external thread 211. Due to the threaded connection, the internal thread 311 and the external thread 211 are screwed together and deform the flexible member 130 at least partially in the circumferential and axial directions. Therefore, the internal and external threads compress and deform the flexible member 130. The cross-sectional shapes of the through hole 1303 and the base body 103 are circular or elliptical. In some embodiments, the internal thread 311 can be formed by hot melt tapping, and the external thread 211 can be formed by rolling; in some embodiments, the internal and external threads 211 are formed by material removal methods such as turning, milling, grinding; in some embodiments, the internal and external threads 211 are formed by mold forming or a combination of the above processes.

In other embodiments, the first connecting portion 112 is snap-fitted with the second connecting portion 101. The first connecting portion may further include a first snap-fit structure, and the second connecting portion may further include a second snap-fit structure. One of the first snap-fit structure and the second snap-fit structure is a protrusion, and the other is a recess. The protrusion and the recess are snap-fitted together and deform the flexible member at least partially in the circumferential and axial directions, i.e., the protrusion and the recess snap-fit and deform the flexible member 130.

The flexible member 130 is a tubular structure. The flexible member 130 includes a first end portion 1301 and a second end portion 1302. The first end portion 1301 and the second end portion 1302 are respectively located at two ends of the flexible member 130 in the axial direction. The first end portion 1301 is closer to the light exit side of the optical module 10 than the second end portion 1302. As shown in FIG. 17, the side indicated by arrow a is the light exit side direction of the optical module 10.

As shown in FIG. 20, in some embodiments, along the axial direction of the flexible member 130, and from the first end portion 1301 to the second end portion 1302, the wall thickness of the flexible member 130 remains constant.

As shown in FIG. 21, in other embodiments, along the axial direction of the flexible member 130, and from the first end portion 1301 to the second end portion 1302, the wall thickness of the flexible member 130 gradually increases. Due to the change in wall thickness of the flexible member 130, during the assembly of the first housing 110, the flexible member 130, and the optical module 10, the closer to the second end portion 1302, the tighter the flexible member 130 will be clamped by the mounting hole 110 and the optical module 10, thereby effectively enhancing the fixing effect between the three and effectively preventing loosening.

In some embodiments, the first housing 110 is further provided with a mounting groove 114. The mounting hole 110 is directly opposite the mounting groove 114, and the mounting hole 110 communicates with the mounting groove 114. The mounting groove 114 is used for installing the micro-display 6. The micro-display 6 is at least partially located within the mounting groove 114. The optical module 10 is located on the light exit side of the micro-display 6. In some embodiments, the light generated by the micro-display 6 passes through the optical module 10 and then irradiates into the user's eyes, i.e., viewer side 204 of the near-eye display apparatus 200.

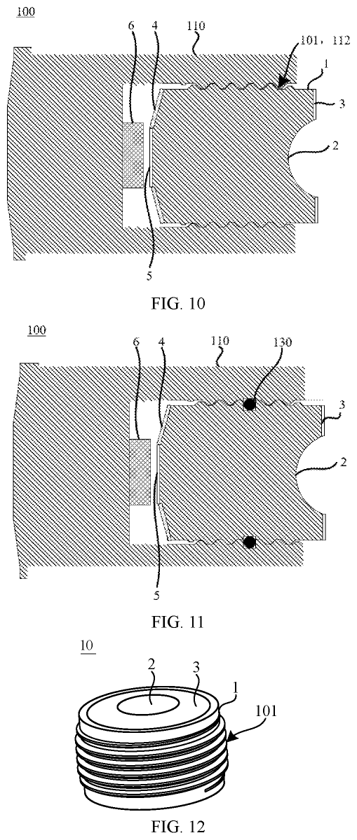

As shown in FIG. 10, in some embodiments, one end of the base body 103 is provided with a flange 105 for limiting. The flange 105 protrudes circumferentially relative to the base body 103. For example, it protrudes entirely around the end of the base body 103. Therefore, when picking up, contacting, or installing the optical module 10, the flange 105 can be directly touched, avoiding contact with the base body 103 and reducing the probability of damage to the base body 103. The flange 105 is located outside the through hole 130. In some embodiments, the side surface of the flange 105 may be non-transmissive. Since the side surface of the flange 105 is non-transmissive, light loss can be reduced, and the light exit efficiency of the optical module 10 can be improved.

The flange 105 abuts against the end wall of the mounting hole 110. For example, the end surface of the flange 105 facing the mounting hole 110 abuts against the end wall of the mounting hole 110 on the side away from the micro-display 6, i.e., abuts against the outer surface of the mounting hole 110, so that there is a gap between the base body 103 and the micro-display 6. Thus, during assembly, because the flange 105 abuts against the end wall of the mounting hole 110, the base body 103 does not contact the micro-display 6, thereby preventing the base body 103 from touching the micro-display 6 and thus protecting the micro-display 6. The end surface of the flexible member 130 may not exceed the end surface of the flange 105. For example, the end surface of the flexible member 130 is flush with the end surface of the flange 105, or the end surface of the flexible member 130 is lower than the end surface of the flange 105. Therefore, it is convenient to insert the base body 103 into the flexible member 130 from the flange 105 end, and it is beneficial to clamp the flange 105 to fixedly assemble the optical module 10 and the flexible member 130 into the mounting hole 110.

In some embodiments, an outer peripheral surface of the flange 105 is provided with an adjusting portion 107. The adjusting portion 107 is configured to drive the optical module 10 to move relative to the first housing 110.

The flange 105 is located outside the through hole 130. When it is necessary to adjust the position of the micro-display 6 relative to the first housing 110, or to disassemble the micro-display 6 module, a user can directly use a tool to act on the flange 105, thereby achieving adjustment or disassembly of the micro-display 6, thus avoiding wear or damage to the optical module 10. The adjusting portion 107 can be a planar structure, a protruding structure, or a recessed structure. The number of adjusting portions 107 can be one or more. For example, the number of adjusting portions 107 may include a plurality arranged at intervals along the flange 105. For example, the adjusting portion 107 can be a planar structure, with two adjusting portions 107 arranged parallel to each other. The adjusting portion 107 may include at least one pair of mutually parallel planes. Of course, other numbers of planar structures arranged circumferentially along the flange 105 are also feasible. A user or during production can use tweezers or a fixture to act on the adjusting portion 107 to adjust the position of the optical module 10.

As shown in FIG. 18, the first housing 110 is provided with a sliding portion 150. The sliding portion 150 is configured to match with an external mating portion to drive the first housing 110 to move. For example, the mating portion is disposed on a wearing article such as an eyeglass frame or a helmet. Through the match between the sliding portion 150 and the mating portion, the first housing 110 can move relative to the wearing article, thereby adjusting the position of the first housing 110 on the wearing article. In some embodiments, the sliding portion 150 protrudes toward the side away from the flexible member 130. There are two sliding portions 150. The flexible member 130 is configured to be installed between the two sliding portions 150. Correspondingly, to match with the sliding portion 150, the mating portion includes a chute structure.

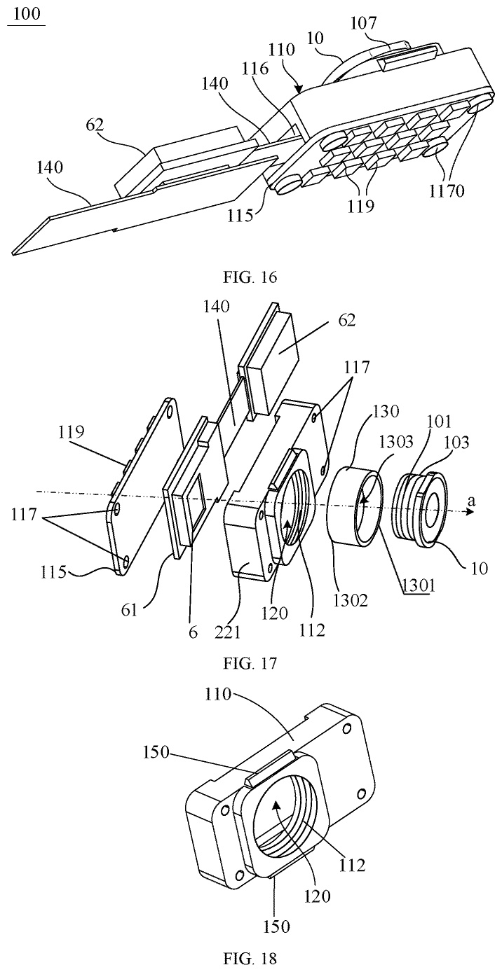

In some embodiments, as shown in FIGS. 16, 17, and 22, the first housing 110 may include a front cover 113 and a rear cover 115. The front cover 113 and the rear cover 115 form a mounting groove 114 therebetween. The front cover 113 is provided with a mounting hole 120. The mounting groove 114 and the mounting hole 120 are in communication. The micro-display 6 is at least partially located within the mounting groove 114. In other embodiments, the rear cover 115 and the backplane can also have the same or similar functions.

During assembly, the rear cover 115 is bonded to the micro-display 6, thereby serving the purpose of dissipating heat from the micro-display 6. In some embodiments, the rear cover 115 may also be provided with a plurality of heat dissipation structures 119, which may be arranged in an array. In some embodiments, the heat dissipation structures 119 protrude from the side of the rear cover 115 facing away from the mounting groove 114. In other embodiments, the heat dissipation structures 119 may be recessed into the rear cover. By providing the heat dissipation structures 119 on the rear cover 115, the contact area between the first housing 110 and air can be increased, thereby improving heat dissipation efficiency. Arranging the heat dissipation structures 119 in an array can make the heat dissipation of the rear cover 115 more uniform, thereby avoiding local overheating. The rear cover 115 can also be made of materials with excellent thermal conductivity, such as metals like copper or aluminum.

In some embodiments, the first housing 110 further includes a fastener 1170. The front cover 113 and the rear cover 115 are respectively provided with fastening holes 117. The fastener 1170 passes through the fastening holes 117 to fix the front cover 113 and the rear cover 115. The fastener 1170 includes screws, etc. With the match of the fastener 1170 and the fastening holes 117, the fixed connection between the front cover 113 and the rear cover 115 is achieved. After installing the micro-display 6 in the mounting groove 114, the front cover 113 and the rear cover 115 are fixedly connected, thereby limiting the movement space of the micro-display 6 and fixing it on the first housing 110.

As shown in FIGS. 17, 22, and 23, the near-eye display module 100 includes a micro-display 6, electrical wires 140, and a circuit board 62. The micro-display 6 is installed in the mounting groove 114 and is thermally coupled with the rear cover 115. The circuit board 62 is located outside the mounting groove 114. One side of the mounting groove 114 communicates with a mounting notch 116. The micro-display 6 is electrically connected to the circuit board 62 via the electrical wires 140 passing through the mounting notch 116.

The micro-display 6 is located in the mounting groove 114, and the electrical wires 140 may be partially exposed outside the mounting groove 114. The circuit board 62 may be located outside the mounting groove 114. In other embodiments, the circuit board 62 may also be located or partially located within the mounting groove 114, while the electrical wires 140 are at least partially exposed, allowing the electrical wires 140 to be electrically connected to electrical components such as a power supply or a main control board.

In some embodiments, the micro-display 6 is electrically connected to the electrical wires 140. One side of the mounting groove 114 communicates with the mounting notch 116. The mounting notch 116 is used to accommodate the electrical wires 140. The electrical wires 140 can be made of a flexible material. The electrical wires 140 are electrically connected to the circuit board 62, transmitting electrical energy from the circuit board 62 to the micro-display 6, thereby enabling the micro-display 6 to operate normally. The circuit board 62 includes a power supply circuit board 62 and a power source. In some embodiments, the circuit board 420 may be a driver board for driving the micro-display 6. The electrical wires 140, the power supply circuit board 62, and the power source are electrically connected in sequence. The power source may include a rechargeable battery or a disposable battery, etc. The power source or battery may be disposed in the temple 203 of the near-eye display apparatus 200.

As shown in FIG. 24, in some embodiments, the present application also proposes a near-eye display apparatus 200, including a second housing 201 and the near-eye display module 100 described above. The second housing 202 includes an environment side 205 and a human eye side 204. The light exit side of the near-eye display module 100 faces viewer side 204. The near-eye display module 100 is disposed on the second housing 201. The second housing 201 can be, for example, a main housing of a device such as ordinary glasses, smart glasses, a helmet, etc. In some embodiments, the near-eye display apparatus 200 may further include a temple 203, an upper frame 201, and a lower frame 202. Electrical components such as circuit boards and batteries may be located on the temple 203. In other embodiments, the near-eye display module 100 may also be fixed onto a lens for the same near-eye display function. In some embodiments, the second housing 201 may be an eyeglass frame. Other components of the near-eye display apparatus 200, such as communication units, housing units, etc., will not be described here. In other embodiments, the near-eye display module 100 may be detachably fixed on the second housing 201.

The present application also provides a method for manufacturing the near-eye display module 10, for manufacturing the near-eye display module 10 as described in the above embodiments, where the method includes: providing a base body 1100 to be processed, including a first surface 1200 and a second surface 1300.

As shown in FIG. 25, the material of the base body 1100 can be a transparent or light-transmitting hard machinable material, such as PMMA (polymethyl methacrylate), PC (polycarbonate) plastic, resin, etc. The base body 1100 can be cylindrical, prismatic, truncated cone-shaped, or other regular shapes, and of course, it can also be irregular, as long as it is convenient for positioning and processing. The material of the base body 1100 may include any one of polymethyl methacrylate, polycarbonate, plastic, or resin. The first surface 1200 and the second surface 1300 can be two opposite surfaces.

Cutting the first surface 1200 of the base body 1100 to form a first configuration surface 1220: where the first configuration surface 1220 includes an exit window 3 and a first reflection window 2, the exit window 3 surrounding the first reflection window 2.

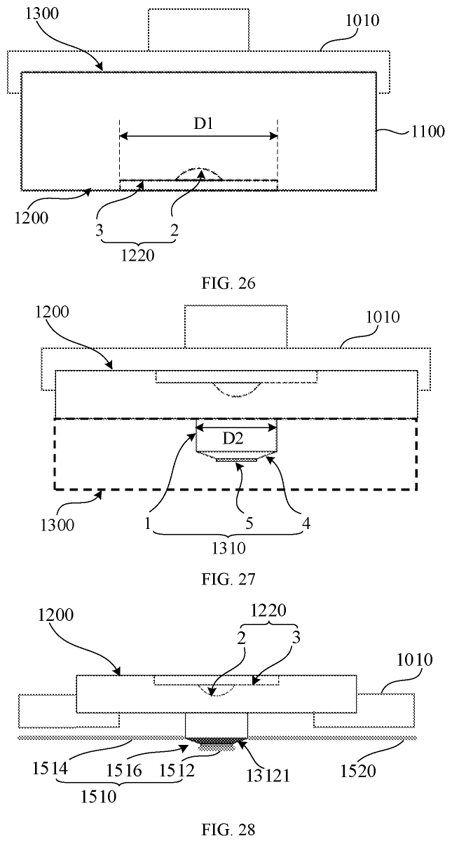

In some embodiments, as shown in FIG. 26, the base body 1100 to be processed can be mounted on a positioning member 1010. The positioning member can be a fixture, jig, or other fixing device to position or fix the base body 1100. Of course, positioning or fixing methods using a slot+plate can also be used. The first surface 1200 of the base body 1100 to be processed is cut to form a first configuration surface 1220. The first configuration surface 1220 can be a recessed area formed by cutting away excess material from the center of the base body 1100. The positioning member 1010 can position or clamp or fix surfaces other than the first surface 1200, such as the surface opposite the first surface 1200 and/or its side surfaces. In some embodiments, the formed first configuration surface 1220 may include the exit window 3 and the first reflection window 2. The first reflection window 2 is located at the center of the exit window 3, and the exit window 3 surrounds the first reflection window 2. The exit window 3 can be horizontal, and the first reflection window 2 can be spherical, aspherical, free-form, etc. The curved surface of the first reflection window 2 curves away from the first surface 1200. Taking the flat first surface 1200 of a cylindrical base body 1100 as an example, the distance from the exit window 3 to the plane of the first surface 1200 is less than the distance from the first reflection window 2 to the plane of the first surface 1200. In FIG. 25, the first reflection window 2 protrudes toward the direction of the positioning member 1010 used for the initial positioning. During cutting, a groove with uniform height can be cut first (this process can always use a fixed cutting position) to form a flat exit window 3. Then, a spherical or aspherical groove can be further cut at the center of the exit window 3 to form the first reflection window 2. This process can adjust the relative distance between cutting tools or use custom blades.

In other embodiments, the exit window 3 can also be spherical, aspherical, free-form, etc. The exit window 3 and the first reflection window 2 together form a continuous surface. In optical design, they can be designed by the same function, for example, generated using Zernike polynomials. In this embodiment, the first configuration surface 1220 can be cut into a continuous surface rather than a plane, such as one of spherical, aspherical, or free-form surfaces. It can be designed by the same function, for example, generated using Zernike polynomials.

In some implementations, during cutting, for example, the base body 1100 to be processed in FIG. 4 can also be cut to form a recessed spherical or aspherical first reflection window 2. At this time, the periphery of the first reflection window 2 is the exit window 3. That is, the exit window 3 does not need to be cut recessed relative to the first surface 1200; the first surface 1200 can be directly used as the exit window 3.

Cutting the second surface 1300 of the base body 1100 to form a second configuration surface 1310; where the second configuration surface 1310 includes an entrance window 5 and a second reflection window 4, the second reflection window 4 surrounding the entrance window 5.

As shown in FIG. 27, the base body 1100 to be processed is mounted on a positioning member 1010, and the second surface 1300 of the base body 1100 to be processed is cut to form a second configuration surface 1310. The second configuration surface 1310 can be a central raised surface formed by cutting away excess portions from the periphery of the base body 1100. The first surface 1200 and the second surface may be two surfaces disposed opposite each other. In some embodiments, the cutting removal position for the first surface 1200 is the center, while the cutting removal position for the second surface 1300 is the corresponding periphery. Additionally, the projection area of the cut second configuration surface 1310 onto the first configuration surface 1220 can be less than or equal to the area of the first configuration surface 1220. In this step, the base body 1100 mounted on the positioning member 1010 may be in a different position than when cutting the first configuration surface. It can be understood that the positioning, clamping, or fixing of the base body 1100 to be processed should be on surfaces other than the second surface 1300, for example, the first surface 1200. That is, after cutting the first surface 1200 to form the first configuration surface 1220, the base body 1100 can be turned over to process the other side. Of course, if it can be ensured that clamping on the main side does not affect the cutting of the two opposite surfaces, that is also possible. In FIG. 26, for illustration, the dotted lines may represent the cut portions, retaining the solid line portions within the dotted frame.

In some embodiments, the second reflection window 4 may include one of a plane, spherical surface, aspherical surface, or free-form surface. The entrance window 5 may include one of a plane, spherical surface, aspherical surface, or free-form surface. The second reflection window 4 and the entrance window 5 can be cut into a continuous curved surface (e.g., one of spherical, aspherical, or free-form) rather than a plane. They can be designed by the same function, for example, using Zernike polynomials. In some embodiments, the entrance window 5 and the first reflection window 2 are the same and have the same outer contour, and which can be designed by the same function, for example, both are free-form surfaces, etc. In other embodiments, the exit window 3, the first reflection window 2, the second reflection window 4, and the entrance window 5 together form the same continuous surface, for example, designed by the same function.

Disposing a reflective layer on the first reflection window 2 and the second reflection window 4.

A metal reflective layer or a metal alloy reflective layer can be disposed using mask coating, sputter coating, ion plating, etc.

Mounting the micro-display 6 on the entrance window 5, the micro-display 6 is used to emit light, and the light enters the first reflection window 2 from the entrance window 5, is reflected by the first reflection window 2 to the second reflection window 4, and then exits through the exit window 3 to form a projected image.

Cutting the base body 1100 along the edge of the exit window 3 and/or the second reflection window 4 to form an annular sidewall 1, the size of the cut exit window 3 being the same as the size of the second reflection window 4.

Encapsulating the cut annular sidewall 1 to expose the exit window 3.

In the above steps, the sequence is not strictly limited to the order described. The assembly of the micro-display 6 can be performed after encapsulation or after cutting. The cutting process on the second surface 1300 of the base body 1100 can also be performed before the cutting on the first surface 1200 of the base body 1100.

In some embodiments, cutting the first surface 1200 of the base body 1100 to form the first configuration surface 1220 further includes:

Providing a positioning member 1010 to fix the second surface 1300;

Cutting the center of the first surface 1200 to form the exit window 3 lower than the first surface 1200, and cutting the center of the exit window 3 to form the first reflection window 2 lower than the exit window 3, the first reflection window 2 including one of a spherical surface, an aspherical surface, or a free-form surface.

It can be understood that when cutting the first surface 1200 of the base body 1100 to be processed to form the first configuration surface 1220 including the exit window 3 and the first reflection window 2, both the exit window 3 and the first reflection window 2 can be recessed relative to the first surface 1200. At this time, when cutting the opposite second surface 1300, a positioning or fixing member (e.g., a clamp) clamping the first surface 1200 (as shown in FIG. 26) will not contaminate or damage the exit window 3 and the first reflection window 2. On the other hand, if the recessed exit window 3 is cut first, and then the first reflection window 2 is further cut deeper, it is more convenient to center and position the first reflection window 2 during processing, improving the accuracy of alignment for cutting the first reflection window 2 and reducing deviations caused by inaccurate positioning.

In some embodiments, cutting the second surface 1300 of the base body 1100 to form the second configuration surface 1310 includes:

Providing a positioning member 1010 to fix the first surface 1200, where there is a gap between the surface of the positioning member 1010 and the first reflection window 2: i.e., the positioning member 1010 does not directly contact the first reflection window 2 and the first reflection window 2. This ensures that the contact surface of the positioning member does not contaminate or damage the exit window and the first reflection mirror.

Cutting the periphery of the second surface 1300 to form the entrance window 1312, the second reflection window 4, and at least a portion of the sidewall 1, where at least a portion of the sidewall 1 is perpendicular to the second surface 1300, the entrance window 1312 is parallel to the exit window 3, the second reflection window 4 is lower than the entrance window 5, and the second reflection window 4 includes one of an inclined surface, a spherical surface, an aspherical surface, or a free-form surface.

It can be understood that the cutting position on the second surface 1300 is complementary to the cutting position on the first surface 1200. Cutting the periphery of the second surface 1300 while retaining the central area results in a relatively protruding second configuration surface 13 (e.g., a protruding cylinder or prism, etc.), specifically including the sidewall 1, the entrance window 5, and the second reflection window 4. The formed entrance window 5 is parallel to the exit window 1212, and the second reflection window 4 is disposed surrounding the entrance window 5. The maximum transverse dimension of the entrance window 5 is smaller than the maximum dimension enclosed by the sidewall 1. The entrance window 5 and the sidewall 1 are spaced apart. The second reflection window 4 is formed between the sidewall 1 and the entrance window 5. As shown in FIG. 26, the second reflection window 4 can be an inclined surface relative to the entrance window 5. In this case, the outer contours of the entrance window 5 and the second reflection window 4 may be an inverted trapezoid. Of course, the second reflection window 4 can also be an arc or curved surface design, with its curved surface facing the same direction as the first reflection window 2. In other embodiments, the curvatures of the two may be different, as long as they can further reflect the light reflected from the first reflection window 2 (via the reflection window with a metal reflective layer) to the exit window 3. The sidewall 1 can be perpendicular to the exit window. In some embodiments, during cutting, the maximum transverse dimension D1 of the cut exit window 3 can be greater than or equal to the maximum transverse dimension D2 of the sidewall 1 to ensure that during subsequent cutting steps, the mathematical parameters among the entrance window 5, the second reflection window 4, and the exit window 3 can match, reducing related production processes. During the cutting process, for example, a cylinder or polyhedral prism can be cut first. Then, based on the size of the entrance window 5 and the inclination or curvature of the second reflection window 4, the excess part is cut away to form a protruding cylinder. After cutting, the second surface 1300 may be completely removed or only the peripheral portion (e.g., the part convenient for clamp clamping) may remain.

In some embodiments, the projected image of the micro-display 6 covers at least an 8° field of view of the wearer; the magnification of the projected image is not less than 2.5; the micro-display has a resolution of not less than 2 arcminutes per pixel for the wearer's field of view; the pixel-to-pixel pitch of the micro-display does not exceed 4 micrometers. The description of these parameters can be found in the corresponding apparatus embodiments and will not be repeated here.

In some embodiments, disposing the reflective layer on the first reflection window 2 and the second reflection window 4 further includes:
Providing a first baffle 1510, the first baffle 1510 including a first shielding area 1512, 1514 and a first hollow area 1516, the first shielding area 1512, 1514 not allowing metal particles to pass through, the first hollow area 1516 allowing metal particles to pass through;
Shielding the entrance window 5 with the first shielding area, the first hollow area corresponding to the second reflection window 4, and evaporating a metal reflective layer on the second reflection window 4 corresponding to the first hollow area;
Providing a second baffle 1520, the structure of the first baffle 1510 being different from the structure of the second baffle 1520, the second baffle 1520 including a second shielding area 1524 and a second hollow area 1522, the second shielding area 1524 not allowing metal particles to pass through, the second hollow area 1522 allowing metal particles to pass through; since the entrance window 5 and the first reflection window 2 are aligned, and the exit window 3 and the second reflection window 4 are aligned, different first baffles 1510 and second baffles 1520 can be used.

Shielding the exit window 3 with the second shielding area, the second hollow area corresponding to the first reflection window 2, and evaporating a metal reflective layer on the first reflection window 2 corresponding to the second hollow area.

In some embodiments, mounting the micro-display 6 on the entrance window 5 further includes coating an adhesive on the surface of the micro-display 6 and/or the entrance window 5, and bonding the micro-display 6 and the entrance window 5 using a positioning member.

In some embodiments, cutting the base body 1100 along the edge of the exit window 3 and/or the second reflection window 4 further includes: using laser cutting along the vertical direction of the edge of the exit window 3 and/or the second reflection window 4 to obtain a columnar base body 1100 with a complete sidewall 1.

In some embodiments, encapsulating the cut base body 1100 to expose the exit window 3 further includes: encapsulating the circumference of the sidewall 1 and the circumference of the micro-display 6 with a non-transmissive encapsulation layer 71 to expose the exit window 3, and fixing the second reflection window 4, the micro-display 6, and the backplane 61 using the encapsulation layer 71. In some embodiments, the non-transmissive encapsulation layer 71 includes a black epoxy resin coating, a black silicone rubber coating, or the non-transmissive encapsulation layer 71 includes a columnar non-transmissive sealing sleeve.

In some embodiments, the manufacturing method further includes: providing a transparent protective layer 8; covering the transparent protective layer 8 on the exit window 3, the first reflection window 2, and/or the encapsulation layer 71, and the size of the transparent protective layer 8 being equal to the size of the exit window 3.

As shown in FIG. 28, performing a coating process on the second reflection window 4 to form a second reflective layer 13121. In some embodiments, the base body 1100 that has been cut to have the first reflection window 2 and the second reflection window 4 can be placed into a coating positioning member or fixture, etc. FIG. 27 illustrates an example where coating is performed first on the second reflection window 4 of the second configuration surface 1310. Since the base body 1100 with the sidewall 1, the entrance window 5, and the second reflection window 4 has already been cut in the previous step, performing coating directly now can reduce the need to change fixtures, reducing manufacturing steps. Of course, coating the first reflection window 2 of the first configuration surface 1220 first is also possible, and the order can be adjusted according to the actual production line. In the specific coating step, after positioning and fixing the base body 1100, the first baffle 1510 is placed at the position corresponding to the second configuration surface 1310. In some embodiments, a positioning member (e.g., a clamp) can be used to fix the baffle 1510. The baffle 1510 can be a mask, such as a metal mask, etc. Of course, other baffles 1510 with shielding effect or made of other materials are also feasible. In some embodiments, the baffle 1510 has a shielding area and a hollow area (not shown). The shielding area covers areas of the second configuration surface 1310 other than the second reflection window 4. That is, the entrance window 5 and the sidewall 1 are shielded, and the hollow area corresponds to the second reflection window 4 allows metal particles etc. to pass through. For example, evaporation can be used to evaporate a layer of metal on the second reflection window to form the second reflective layer 13121. This metal can be aluminum, silver, or a mixture of aluminum and silver, etc. Of course, other methods such as sputter coating or ion plating are also feasible, and care must be taken to avoid coating the entrance window 5 and the sidewall 1.

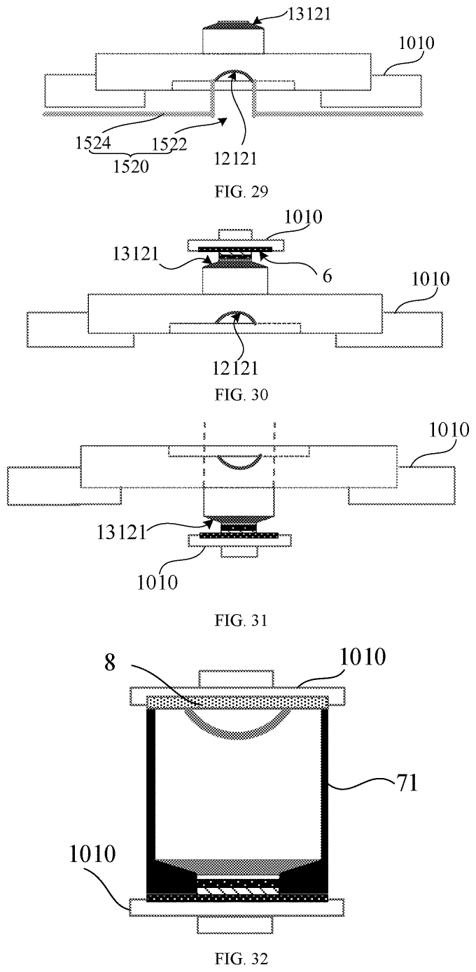

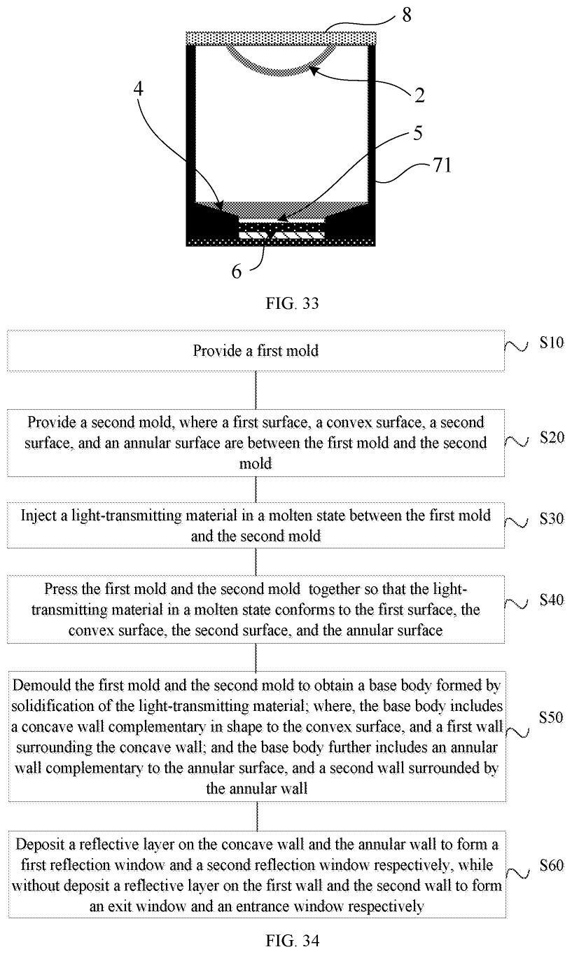

As shown in FIG. 29, performing a coating process on the first reflection window 2 to form a first reflective layer 12121. The specific coating method can be the same as the above steps, but it must still be ensured that only the first reflection window 2 is coated, while the exit window 3 is not coated (for example, also using a metal mask for corresponding shielding). That is, the shielding area 1524 of the second baffle 1520 shields the exit window 3, while the hollow area 1522 of the second baffle 1520 corresponds to the first reflection window 2, allowing metal particles etc. to pass through, thereby forming a metal reflective layer.

In some embodiments, the position of the first baffle 1510 can be as close as possible to the non-coated surface. When coating the second reflection window 4, as shown in FIG. 28, since the sidewall 1, the entrance window 5, and the second reflection window 4 are not on the same plane, the shielding area 1512 of the baffle 1510 shielding the entrance window 5 and the shielding area 1514 of the baffle 1510 shielding the sidewall 1 are also not on the same plane. That is, the shielding areas of the baffle 1510 in each region need to be close to their respective areas to be shielded. This can reduce the chance of metal particles entering the non-coated surfaces (sidewall 1 and entrance window 5) during coating. Of course, if the coating process is precisely controlled, a baffle (metal mask, etc.) 15 with a common plane can also be used for shielding. When coating the first reflection window 2, it may include vertical and horizontal baffles 1512, 1514. The vertical and horizontal baffles 1510 constitute shielding areas, and two parallel vertical shielding areas 1512 form a hollow area, whose size can be exactly the same as the maximum transverse dimension of the second reflection window 1212, thereby allowing only the first reflection window 2 to be coated.

As shown in FIG. 30, the micro-display 6 is mounted on the entrance window 5 of the second configuration surface 1310 so that the micro-display 6 is fixed on the base body 1100. It can be understood that an adhesive can be coated on the micro-display 6 in advance, and then a positioning member 1010 is used to clamp and bond the micro-display 6 to the entrance window 5. Alternatively, the adhesive can be coated on the entrance window 5 first, and then the micro-display 6 is clamped and bonded to the entrance window 5. In some embodiments, other fixing methods can also be used, such as mechanical connection, welding, etc. The size of the micro-display 6 can be the same as the entrance window 5. Of course, the entrance window 5 can also be slightly larger than the micro-display 6, as long as it ensures that all light from the micro-display 6 can enter through the entrance window 5.

As shown in FIG. 31, the base body 1100 to be processed is mounted on a work fixture or positioning member 1010, and cutting is performed along the edge of the exit window 3 of the first configuration surface 1220. The cutting position on the exit window 3 can be determined according to the maximum transverse dimension D2 of the sidewall 1 of the second configuration surface 1310 (in conjunction with FIG. 27), for example, ensuring that the sidewall 1 is not excessively cut or damaged. The cutting method can be mechanical or laser cutting, etc. After cutting, a main body with a reflective layer and a micro-display, which has not yet been encapsulated, is obtained.

As shown in FIG. 32, the optical main body is encapsulated, exposing the first configuration surface 1220. In some embodiments, the sidewall of the base body 1100 and the second reflection window 4 are encapsulated. A black or non-transmissive sealing sleeve 71 can be used for encapsulation, ensuring that the exit window 3 of the first configuration surface 1220 is exposed. Of course, processes such as injection molding can also be used. The above base body 1100 is placed into a mold and black or non-transmissive glue is injected for encapsulation, ensuring that the first configuration surface 1220 is exposed.

In some embodiments, as shown in FIG. 32, to further protect the exit window 3, an optical protective layer 8 may be added on the first configuration surface 1220. Finally, the packaged product obtained is the near-eye display module 100 of the above embodiment. In the above steps, the cutting process may include one or more of turning, drilling, boring, milling, planing, broaching, grinding, lapping, superfinishing, polishing, etc. The black filler or sealing sleeve used for encapsulation is black epoxy resin or black silicone rubber. It can be understood that the thickness of the black filler or sealing sleeve can be as small as possible and must not allow light to exit. In some embodiments, the black filler or sealing sleeve can also be formed by a method similar to depositing a non-transmissive film. In other embodiments, if other devices assembled with this display device have non-transmissive or sealing sleeves, etc., the encapsulation can be omitted and directly combined with other devices. The cutting process for cutting out the sidewall 1 can be laser cutting or mechanical cutting, etc.

The present application provides a near-eye display module, including: a first reflection window, provided with a first reflective layer, and configured to reflect light;

a second reflection window, located at an opposite end of the first reflection window, the second reflection window being provided with a second reflective layer and configured to receive light reflected from the first reflection window and further reflect it; an entrance window, surrounded by the second reflection window and coaxially arranged with the first reflection window; an exit window, surrounding the first reflection window, the exit window having the same size as the second reflection window; an annular sidewall, one end connected to the second reflection window, the other end connected to the exit window; and a micro-display, located at the entrance window, light emitted by the micro-display entering the first reflection window from the entrance window, being reflected by the first reflection window to the second reflection window, and then exiting through the exit window to form a projected image. The projected image of the micro-display covers at least an 8° field of view of the wearer. The magnification of the projected image is not less than 2.5. The micro-display has a resolution of not less than 2 arcminutes per pixel for the wearer's field of view. The pixel-to-pixel pitch of the micro-display does not exceed 5 micrometers. The first reflection window and the second reflection window include any one of an inclined surface, a spherical surface, an aspherical surface, or a free-form surface; the first reflective layer and the second reflective layer include a metal or metal alloy reflective material. The area enclosed by the first reflection window, the second reflection window, the entrance window, the exit window, and an annular sidewall is a solid light-transmitting medium, the first reflective layer is located on a side of the first reflection window away from the solid light-transmitting medium, the second reflective layer is located on a side of the second reflection window away from the solid light-transmitting medium, and the solid light-transmitting medium includes any one of polymethyl methacrylate, polycarbonate, plastic, and resin.

The first reflection window, the exit window, the second reflection window, and the annular sidewall are solid, the area enclosed by the first reflection window, the second reflection window, the entrance window, the exit window, and the annular sidewall is a hollow region, the first reflective layer is located on a side of the first reflection window facing the hollow region, the second reflective layer is located on a side of the second reflection window facing or away from the hollow region, and the first reflection window, the second reflection window, the entrance window, the exit window, and the annular sidewall are solid and include any one of polymethyl methacrylate, polycarbonate, plastic, and resin. The near-eye display module further includes an intermediate layer disposed between the entrance window and the micro-display, a thickness of the intermediate layer being less than a distance from the entrance window to the first reflection window. The micro-display further includes a backplane located on a side of the micro-display away from the entrance window and electrically connected to the micro-display, the backplane being used for connecting to a driving power source. The near-eye display module further includes an encapsulation layer including a non-transmissive material, the encapsulation layer wrapping the annular sidewall, the encapsulation layer also filling gaps between the second reflection window, the micro-display, and/or the backplane, and allowing at least portions of the exit window and the backplane to be exposed relative to the encapsulation layer, the encapsulation layer being configured to fix the second reflection window, the micro-display, and the backplane. In a direction from the micro-display to the exit window, an outer contour size of the encapsulation layer is the same, and along a direction perpendicular to the sidewall, a thickness of the encapsulation layer on the annular sidewall is less than a thickness of the encapsulation layer on the micro-display. The near-eye display module further includes an encapsulation layer including a non-transmissive sleeve, the annular sidewall, the second reflection window, the micro-display, and the backplane are located within the sleeve, and leads of the backplane and the exit window are exposed relative to the sleeve.

It also includes a transparent protective layer, the transparent protective layer covering the first reflection window, the exit window, and/or the encapsulation layer, and the size of the transparent protective layer is equal to the size of the exit window. The overall size of the structure composed of the first reflection window, the second reflection window, the entrance window, the exit window, the annular sidewall, the micro-display, and the transparent protective layer is from 0.5 cubic millimeters to 5 cubic centimeters.

The present application provides a method for manufacturing a near-eye display module, including: providing a lens body to be processed, including a first surface and a second surface;

Cutting the first surface of the lens body to form a first configuration surface, where the first configuration surface includes an exit window and a first reflection window, the exit window surrounding the first reflection window; cutting the second surface of the lens body to form a second configuration surface; where the second configuration surface includes an entrance window and a second reflection window, the second reflection window surrounding the entrance window, and the entrance window being coaxial with the first reflection window; disposing a reflective layer on the first reflection window and the second reflection window; mounting a micro-display on the entrance window, the micro-display being used to emit light, the light entering the first reflection window from the entrance window, being reflected by the first reflection window to the second reflection window, and then exiting through the exit window to form a projected image; cutting the lens body along an edge of the exit window and/or the second reflection window to form an annular sidewall, the size of the cut exit window being the same as the size of the second reflection window; and encapsulating the cut annular sidewall to expose the exit window. The cutting of the first surface of the lens body to form the first configuration surface further includes: providing a positioning member to fix the second surface; cutting a center of the first surface to form the exit window lower than the first surface, and cutting a center of the exit window to form the first reflection window lower than the exit window, the first reflection window including any one of a spherical surface, an aspherical surface, or a free-form surface.

The cutting of the second surface of the lens body to form the second configuration surface includes: providing a positioning member to fix the first surface, there being a gap between the surface of the positioning member and the first reflection window; cutting a periphery of the second surface to form the entrance window, the second reflection window, and at least a portion of the sidewall, where at least a portion of the sidewall is perpendicular to the second surface, the entrance window is parallel to the exit window, the second reflection window is lower than the entrance window, and the second reflection window includes one of an inclined surface, a spherical surface, an aspherical surface, or a free-form surface. The projected image of the micro-display covers at least an 8° field of view of the wearer; the magnification of the projected image is not less than 2.5; the micro-display has a resolution of not less than 2 arcminutes per pixel for the wearer's field of view; the pixel-to-pixel pitch of the micro-display does not exceed 4 micrometers.

The disposing of the reflective layer on the first reflection window and the second reflection window further includes: providing a first baffle, the first baffle including a first shielding area and a first hollow area, the first shielding area not allowing metal particles to pass through, the first hollow area allowing metal particles to pass through; shielding the entrance window with the first shielding area, the first hollow area corresponding to the second reflection window, and evaporating a metal reflective layer on the second reflection window corresponding to the first hollow area; providing a second baffle, the structure of the first baffle being different from the structure of the second baffle, the first baffle including a second shielding area and a second hollow area, the second shielding area not allowing metal particles to pass through, the second hollow area allowing metal particles to pass through; shielding the exit window with the second shielding area, the second hollow area corresponding to the first reflection window, and evaporating a metal reflective layer on the first reflection window corresponding to the second hollow area.

The mounting of the micro-display on the entrance window further includes coating an adhesive on the surface of the micro-display and/or the entrance window, and bonding the micro-display and the entrance window using a positioning member.

The cutting of the lens body along the edge of the exit window and/or the second reflection window further includes: using laser cutting along a vertical direction of the edge of the exit window and/or the second reflection window to obtain a columnar lens body with a complete sidewall. The encapsulating of the cut lens body to expose the exit window further includes: encapsulating a circumference of the sidewall and a circumference of the micro-display with a non-transmissive encapsulation layer to expose the exit window, and fixing the second reflection window, the micro-display, and the backplane using the encapsulation layer.

The method for manufacturing a near-eye display module further includes: providing a transparent protective layer; covering the transparent protective layer on the exit window, the first reflection window, and/or the encapsulation layer, and the size of the transparent protective layer being equal to the size of the exit window. The lens body includes any one of polymethyl methacrylate, polycarbonate, plastic, and resin, and the non-transmissive encapsulation layer includes black epoxy resin, black silicone rubber, or the non-transmissive encapsulation layer includes a columnar non-transmissive sealing sleeve.

The method for manufacturing a near-eye display module according to the embodiments of the present application can encapsulate and manufacture the optical module and the micro-display, featuring a streamlined process flow, low cost, and reduced risk of damaging optical components during manufacturing. The final near-eye display module has a small size and high optical efficiency, presenting good application prospects.

As shown in FIGS. 34-47, the present application also provides a method for manufacturing a near-eye display module, for manufacturing the near-eye display module 10 as described in the above embodiments, where the method includes:
S10, providing a first mold 20;
S20, providing a second mold 30, where a first surface 22, a convex surface 21, a second surface 31, and an annular surface 32 are between the first mold 20 and the second mold 30;

In some embodiments, the first mold 20 may be simultaneously provided with the first surface 22, the convex surface 21, the second surface 31, and the annular surface 32, while the mold 30 may not be provided. In other embodiments, the first mold 20 may be provided with a part of the first surface 22, the convex surface 21, the second surface 31, and the annular surface 32, while the second mold 30 may be provided with another part of the first surface 22, the convex surface 21, the second surface 31, and the annular surface 32.

The first mold 20 may include a first surface 22 and a convex surface 21. The first surface 22 and the convex surface 21 may each include a plurality. The arrangement of the convex surface 21 and the first surface 22 may be alternating, with the convex surface 21 located at the center of the first surface. Of course, there could also be more first surfaces 22 between two convex surfaces 21, meaning the spacing between adjacent convex surfaces 21 can be designed as needed. The convex surface 21 protrudes relative to the first surface 22. In some embodiments, the first surface 22 can be a plane, and the convex surface 21 can be a spherical surface, an aspherical surface, or a free-form surface, etc. The first surface 22 and the convex surface 21 are respectively two different types of surfaces. In other embodiments, the first surface 22 can be a spherical surface, an aspherical surface, or a free-form surface, etc., and the convex surface 21 can be a spherical surface, an aspherical surface, or a free-form surface, etc. The first surface 22 and the convex surface 21 together form a continuous surface. The first surface 22 and the convex surface 21 can be designed by the same function in optical design, for example, generated using Zernike polynomials.

The second surface 31 and the annular surface 32 may each include a plurality. The annular surface 32 surrounds the second surface 31. The annular surface 32 may be non-coplanar with the second surface 31. The first mold 20 and/or the second mold 30 is further provided with a first sidewall 33 to form a cavity 40 on the first mold 20 and/or the second mold 30. In some embodiments, the second surface 31 can be a plane, and the annular surface 32 can be a plane, a spherical surface, an aspherical surface, or a free-form surface, etc. The second surface 31 and the annular surface 32 are respectively two different types of surfaces. In other embodiments, the second surface 31 can be a spherical surface, an aspherical surface, or a free-form surface, etc., and the annular surface 32 can be a spherical surface, an aspherical surface, or a free-form surface, etc. The second surface 31 and the annular surface 32 together form a continuous surface. The second surface 31 and the annular surface 32 can be designed by the same function in optical design, for example, generated using Zernike polynomials.

In other embodiments, the first surface 22 and the second surface 31 can be the same type of surface, for example, both being planes, or both being one of spherical, aspherical, or free-form surfaces. The outline shapes of the first surface 22 and the second surface 31 can be the same, for example, polygonal, circular, or elliptical, etc. The first surface 22 and the second surface 31 can be designed by the same function, for example, generated using Zernike polynomials. In other embodiments, the first surface 22, the convex surface 21, the second surface 31, and the annular surface 32 can be surfaces designed by the same function, for example, generated using Zernike polynomials.

The second surface 31 may be at the center of the annular surface 32, and there may be gaps between two adjacent annular surfaces 32, thereby facilitating subsequent cutting after molding. In some embodiments, the first sidewall 33 may be disposed around the first mold 20 to form the cavity 40. In some embodiments, the first sidewall 33 may be disposed around the second mold 30 to form the cavity 40. In some embodiments, the first sidewall 33 may be disposed around both the first mold 20 and the second mold 30, forming small cavities on each mold, and multiple small cavities can be combined to form one large complete cavity 40. The first sidewall 33 may be perpendicular to the first surface 22 and the second surface 31. In some embodiments, the cavity 40 may be one large cavity, and the related surfaces mentioned above are provided inside the corresponding cavity 40 or in the area corresponding to the vertical projection of the cavity 40. In some embodiments, the formed cavity 40 may be a plurality of small cavities arranged in an array.

S30, injecting a light-transmitting material in a molten state between the first mold 20 and the second mold 30;

In some embodiments, there may be a gap between the first mold 20 and the second mold 30, or one or both of the first mold 20 and the second mold 30 may be provided with an injection hole. The light-transmitting material in a molten state is injected through the gap or the injection hole. The light-transmitting material in a molten state can be a transparent molten material, for example, it can be any one of polymethyl methacrylate, polycarbonate, plastic, resin, or glass.

In some embodiments, before injecting the light-transmitting material in a molten state between the first mold 20 and the second mold 30, the method may further include: aligning the first mold 20 and the second mold 30 so that the convex surface 21 and the second surface 31 are coaxially aligned, and the first surface 22 and the second surface 31 are parallel;

A clamp 1011 or a positioning jig 1010, etc., can be used to align the first mold 20 and the second mold 30, ensuring that the convex surface 21 and the second surface 31 are coaxially aligned. The first surface 22 and the second surface 31 can both be flat surfaces, and after the molds are aligned, they are parallel to each other. The transverse dimension of the second surface 31 may be greater than or equal to the transverse dimension of the convex surface 21.

S40, pressing the first mold 20 and the second mold 30 together so that the light-transmitting material in a molten state conforms to the first surface 22, the convex surface 21, the second surface 31, and the annular surface 32;

A clamp or the like can be used to hold the first mold 20 and the second mold 30. One of them can be positioned and fixed, and the other can be pressed toward the fixed one. For example, the mold with the cavity 40 can be fixed, and then the other mold can be pressed using a pressure mechanism. In some embodiments, both molds can be controlled to move toward each other simultaneously for pressing. Pressing ensures that the molten material fully conforms to the first surface 22, the convex surface 21, the second surface 31, and the annular surface 32. This process may allow excess molten material to overflow.

In some embodiments, it also includes controlling the distance between the first surface 22 and the second surface 31 during pressing. If the preset distance is reached, pressing stops; if not, control is exercised to reach the preset distance. By controlling the distance formed by pressing, the resulting molded base body 50 meets the required design dimensions. In some embodiments, if there are multiple cavities 40 in an array, the final product will be a base body 50 in an array. Therefore, to facilitate subsequent batch operations, such as batch transfer, clamping, etc., it is necessary to ensure that there is a connecting structure between adjacent two main bodies. That is, the pressing process also needs to control the thickness of the connecting structure. If it is too thin, the overall structural strength is insufficient; if it is too thick, subsequent cutting is difficult. In some embodiments, the pressing process also includes controlling the gap height between two adjacent cavities 40, i.e., the connecting structure of the final molded adjacent two main bodies 50. The gap height can be 100 micrometers, 300 micrometers, 400 micrometers, or 500 micrometers, etc.

S50, demolding the first mold 20 and the second mold 30 to obtain a base body 50 or main body formed by solidification of the light-transmitting material, where, the base body includes a concave wall complementary in shape to the convex surface, and a first wall surrounding the concave wall; and the base body further includes an annular wall complementary to the annular surface, and a second wall surrounded by the annular wall;

In the embodiments of the present application, some embodiments use “main body” to describe the optical module, while other embodiments use “base body”. The base body 50 and the main body can be understood similarly or analogously. The base body includes a concave wall 51 complementary in shape to the convex surface 21, a first wall 52 surrounding the concave wall 51. The base body 50 further includes an annular wall 54 complementary to the annular surface 32, and a second wall 53 surrounded by the annular wall 54. Positionally, the first end of the base body 50 or main body includes the first wall 52 and the concave wall 51 lower than the first wall 52. The second end of the base body 50 opposite the first end includes the second wall 53 and the annular wall 54. The second wall 53 is parallel to the first wall 52. The annular wall 54 surrounds the second wall 53. The base body 50 further includes a second sidewall 55 connecting the first wall 52 and the annular wall 54. The outer contour shape of the annular wall 54 can be polygonal, circular, elliptical, or a closed contour combining straight edges and curved edges, etc. The formed first wall 52 and second wall 53 can be planes, respectively, and the concave wall 51 and the annular wall 54 can be spherical surfaces, aspherical surfaces, or free-form surfaces, respectively. In some embodiments, the first wall 52 and the concave wall 51 are two different types of surfaces, respectively, and the second wall 53 and the annular wall 54 are two different types of surfaces, respectively. In other embodiments, the first wall 52 and the concave wall 51 are the same type of surface, and the second wall 53 and the annular wall 54 are the same type of surface, for example, they can all be planes, spherical surfaces, aspherical surfaces, or free-form surfaces. In other embodiments, the first wall 52, the concave wall 51, the second wall 53, and the annular wall 54 are the same type of surface, and in optical design, they can be designed by the same function, for example, generated using Zernike polynomials.

In other embodiments, the concave wall 51 and the second wall 53 can be the same type of surface, for example, both being planes, or both being one of spherical, aspherical, or free-form surfaces. The concave wall 51 and the second wall 53 can be designed by the same function, for example, generated using Zernike polynomials. The outline shapes of the concave wall 51 and the second wall 53 can be the same, for example, polygonal, circular, or elliptical, etc.

After the light-transmitting material in a molten state has fully cooled, a clamp 1011 or the like can be used to hold the molds and separate them. The molded base body 50 can be multiple separate pieces, or it can be a connected array. The shape of the base body 50 can be columnar, frustum-shaped, etc. The base body 50 and the base body 103 of the optical module 10 in the above embodiments can be understood to have the same or similar function.

S60, depositing a reflective layer on the concave wall and the annular wall to form a first reflection window and a second reflection window respectively, while without depositing a reflective layer on the first wall and the second wall to form an exit window and an entrance window respectively;

In some embodiments, as shown in FIGS. 43-44, after obtaining the base body 50 formed by solidification of the light-transmitting material, it further includes depositing a reflective layer 541 on the concave wall 51 to form the first reflection window 2 described in the optical module embodiment, and depositing a reflective layer 541 on the annular wall 54 to form the second reflection window 4 described in the optical module embodiment. Physical vapor deposition or chemical vapor deposition can be used, such as mask coating, sputter coating, or ion plating, to deposit a reflective layer 541 with metal or metal alloy on the concave wall 51 and the annular wall 54. The reflective layer is deposited to form the exit window 3 and the entrance window 5 respectively, thereby forming the optical module 10 as described in the above embodiments.

In some embodiments, before demolding the first mold 20 and the second mold 30, it also includes determining whether the temperature of the injected light-transmitting material in a molten state has dropped below the corresponding solidification point. If yes, demolding can proceed; if not, cooling must continue, for example, using air cooling, water cooling, or natural heat dissipation.

In the method for manufacturing a near-eye display module provided by the present application, each mold is provided with corresponding convex surfaces 21 and first surfaces 22, second surfaces 31, and annular surfaces 32. The two molds are then aligned, ensuring that in the cavity 40, the convex surface 21 and the second surface 31 are coaxially arranged, and the first surface 22 and the second surface 31 are parallel. The light-transmitting material in a molten state is injected, and the molds are pressed together, ultimately allowing the molten material to fully conform to the convex surface 21, the second surface 31, the first surface 22, and the second surface 31. After solidification, the molds are demolded to form the base body 50 of the required design. The above method does not require cutting various surfaces of the raw material to form the required designed surfaces, reducing material loss and lowering costs. Additionally, since no cutting processes are required, it is less likely to cause optical effects on the base body 50.

It can be understood that the dimensional relationships of the components in the drawings of the various embodiments of the present application are not strictly as shown in the figures. The drawings are reference examples illustrating the positional relationships of the components. For dimensions or other related relationships, please refer to the relevant text descriptions in the present application.

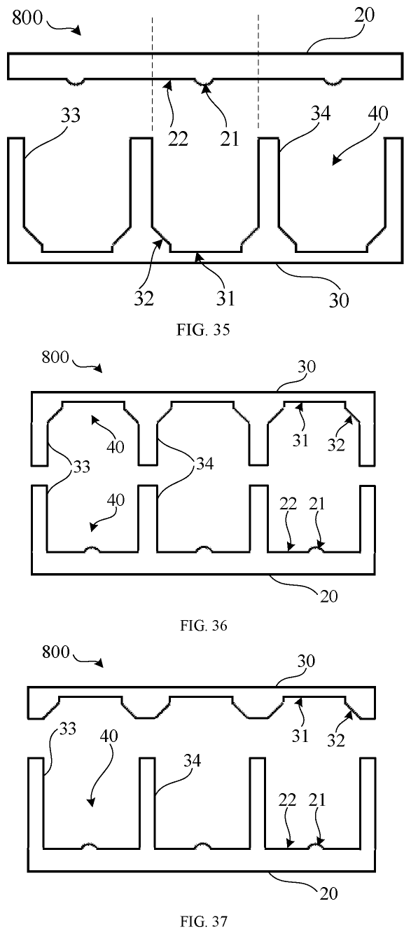

In some embodiments, as shown in FIGS. 35-37, the first mold 20 may include a plurality of first surfaces 22 arranged in an array and a plurality of convex surfaces 21 arranged in an array. The second mold 30 may include a plurality of second surfaces 31 arranged in an array and a plurality of annular surfaces 32 arranged in an array. In some embodiments, each convex surface 21 has the same size, each first surface 22 has the same size, each second surface 31 has the same size, and each annular surface 32 has the same size. In other embodiments, the sizes of each convex surface 21, first surface 22, second surface 31, and annular surface 32 may also be different. For example, the sizes of the convex surface 21, first surface 22, second surface 31, and annular surface 32 may gradually increase or decrease along a first direction. In some embodiments, the convex surface 21 and the annular surface 32 include any one or a combination of an inclined surface, a spherical surface, an aspherical surface, or a free-form surface. The convex surface 21 and the annular surface 32 can be the same surface type or contour. The shape of the concave wall 51 is complementary to the shape of the convex surface 21, and the shape of the annular wall 54 is complementary to the shape of the annular surface 32. It can be understood that complementary means opposite or matching shapes, i.e., if one is a convex surface, the other is a concave surface; if one surface is a plane, the other is also a plane. The shape of the first surface 22 is the same as the shape of the first wall 52, and the shape of the second surface 31 is the same as the shape of the second wall 53. The outer contour shapes of the annular surface 32 and the first surface 22 can be the same, and the outer contour shapes of the convex surface 21 and the second surface 31 can be the same. For example, they can all be polygonal, circular, elliptical, or closed contours combining straight edges and curved edges, etc. Regarding the types and shapes of each surface, reference can be made to the relevant descriptions in the above embodiments, which will not be repeated here.

In some embodiments, the size of the cavity 40 may be between 0.4 cubic millimeters and 4 cubic centimeters, for example, 0.4 cubic millimeters, 1 cubic millimeter, 8 cubic millimeters, 1 cubic centimeter, 2 cubic centimeters, 4 cubic centimeters, etc. The space is small, so the size of the final single base body 50 is relatively small to the naked eye, making it easier to integrate into various other devices, such as glasses or other head-mounted devices, without affecting the original device's appearance or large-area structure, offering good adaptability.

In some embodiments, as shown in FIGS. 35-37, the first mold 20 and/or the second mold 30 is further provided with a third sidewall 34. The third sidewall 34 is parallel to the first sidewall 33. The third sidewall 34 divides the cavity 40 into cavities 40 arranged in an array. The plurality of third sidewalls 34 can be part of the first mold 20, or part of the second mold 30, of course, they can also be separate components disposed on the first mold 20 or the second mold 30. The height of the third sidewall 34 is the same as the height of the first sidewall 33. The third sidewall 34 can be disposed on the first mold 20 and/or the second mold 30 and located between the first sidewalls 33. The plurality of third sidewalls 34 are spaced apart to partition the cavity 40. For example, the first sidewall 33 and the third sidewall 34 can be provided in both molds simultaneously to form cavities on both molds. This can reduce the depth of the molten material entering the cavity 40 and conforming to the designed surfaces. In some embodiments, the third sidewall 34 can block the light-transmitting material in a molten state from entering, so that after solidification, the molten material has gaps 57 between the cavities 40 arranged in an array (FIG. 40). When forming an optical module array as shown in FIG. 41 or 7, this enables quick identification of cutting positions, facilitating subsequent cutting of the optical module array. Additionally, these gaps 57 are beneficial for clamping or positioning by fixtures.

In some embodiments, as shown in FIGS. 40, 43-44, depositing the reflective layer on the concave wall 51 and the annular wall 54 includes: providing a first baffle 1530, the first baffle 1530 including a first sub-baffle 1532 and a second sub-baffle 1534, with a gap between the first sub-baffle 1532 and the second sub-baffle 1534, the first sub-baffle 1532 and the second sub-baffle 1534 having different heights and sizes; It can be understood that the first sub-baffle 1532 and the second sub-baffle 1534 are not collinear but are close to their respective areas to be shielded, thereby reducing the probability of reflective material entering the sidewall of the base body 50 when depositing the reflective layer 541 on the annular wall 54.

The first sub-baffle 1532 shields the gap 57 between two adjacent main bodies 50. The clamp 1011 can clamp the gap 57, making the entire array more stable. The size of the second sub-baffle 1534 can be the same as the second wall 53, thereby shielding the second wall 53. The size of the transverse gap between the first sub-baffle 1532 and the second sub-baffle 1534 corresponds to the width of the annular wall 54, i.e., the gap distance equals the distance between two adjacent second walls 53. The metal or metal alloy reflective layer 541 is evaporated onto the annular wall 54 through the gap.

A second baffle 1540 is provided. The structure of the first baffle 1530 is different from the structure of the second baffle 1540. The second baffle 1540 includes a third sub-baffle 1542 and a fourth sub-baffle 1544, with a gap between the third sub-baffle 1542 and the fourth sub-baffle 1544. The third sub-baffle 1542 and the fourth sub-baffle 1544 have the same height.

The size of the third sub-baffle 1542 can be greater than or equal to the first wall 52, thereby shielding the first wall 52. The fourth sub-baffle 1544 spans across two adjacent first walls 52. The gap between the third sub-baffle 1542 and the fourth sub-baffle 1544, or the gap between the fourth sub-baffle 1544 and the fourth sub-baffle 1544, corresponds to the width of the concave wall 51, i.e., the gap distance equals the width of the concave wall 51. The metal or metal alloy reflective layer 541, such as silver, aluminum, aluminum-magnesium alloy, etc., is evaporated onto the concave wall 51 through the gap.

In some embodiments, as shown in FIG. 45, after depositing the reflective layer on the concave wall 51 and the annular wall 54, the method further includes: mounting the micro-display 6 on each second wall 53, the micro-display 6 and the second wall 53 being in close contact, and the transverse dimension of the micro-display 6 being less than or equal to the transverse dimension of the second wall 53. The micro-display 6 can be as described in the above embodiments. The clamp 1011 can be used to fix the base body 50. Optical glue 63 can be coated on the surface of the second wall 53 or the micro-display 6, and then the clamp 1011 is used to clamp the micro-display 6 and bond it to the second wall 53.

In other embodiments, the mounting of the micro-display 6 can also be performed before coating.

The micro-display 6 further includes a backplane 61. The backplane 61 is located on the side of the micro-display 6 away from the second wall 53 and is electrically connected to the micro-display 6. The backplane 61 is used for connecting a driving power source. The backplane 61 can be a drive board such as a circuit board, which can be rigid or flexible. The backplane 61 is used for connecting a driving power source to provide electrical drive for the micro-display 6. The backplane 61 can be larger than or equal to the micro-display 6. In some embodiments, the backplane 61 can also be a part of the micro-display 6.

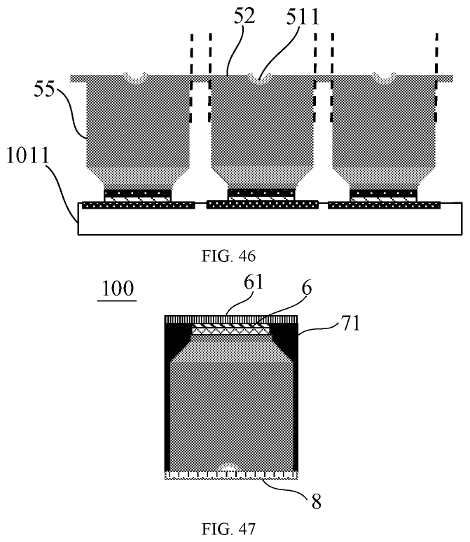

In some embodiments, as shown in FIG. 46, after mounting the micro-display 6 on each second wall 53, the method further includes: cutting the connecting structure between two adjacent main bodies 50 in a direction perpendicular to the first wall 52 to separate them into individual main bodies 50. The clamp 1011 can be used to fix the side where the micro-display 6 is mounted, and cutting is performed along the edge of the first wall 52 on the base body 50 to be processed, ensuring that the sidewall 55 is not excessively cut or damaged. The cutting method can be mechanical or laser cutting, etc.

In some embodiments, as shown in FIG. 47, after cutting the connecting structure between two adjacent main bodies 50 to separate them into individual main bodies 50, the method further includes: encapsulating a single base body 50 with an encapsulation material 71 to expose the first wall 52, where the encapsulation material is non-transmissive and can be black epoxy resin, black silicone rubber, carbon black, nickel black, black chrome, Vantablack, or other coatings or materials. In some embodiments, the sidewall 55 and the annular wall 54 of the base body 50 are encapsulated. A black or non-transmissive sealing sleeve 80 can be used for encapsulation, ensuring that the first wall 52 is exposed. Of course, processes such as injection molding can also be used. The above base body 50 is placed into a mold and black or non-transmissive glue is injected for encapsulation, ensuring that the first wall 52 is exposed. In some embodiments, at least a portion of the backplane 61 is exposed relative to the encapsulation material 80, thereby facilitating electrical connection with external electrical components (such as batteries or driver boards).

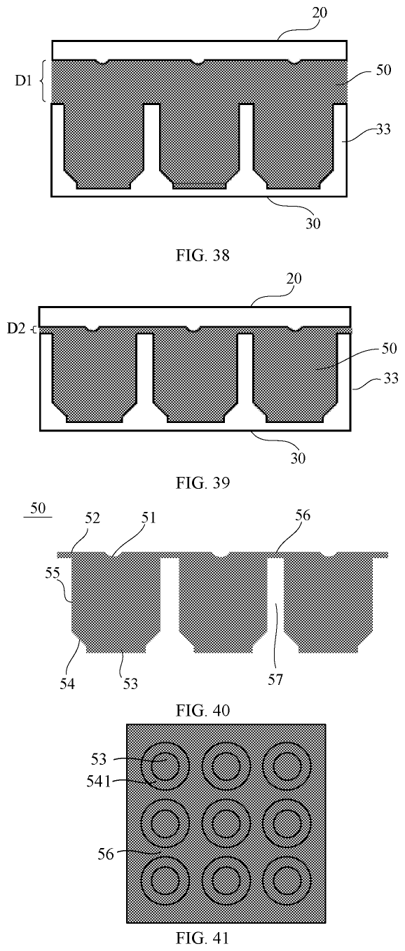

In some embodiments, as shown in FIGS. 38-40, pressing the first mold 20 and the second mold 30 together further includes: determining the distance D2 between the first surface 22 and the second surface 31 during pressing meets a preset value, if the distance D2 meets the preset value, stop pressing; otherwise, press to the preset value. A distance D2 facilitates the formation of the connecting structure 56 between two adjacent main bodies 50. The thickness of the distance D2 can be between 100 and 500 micrometers.

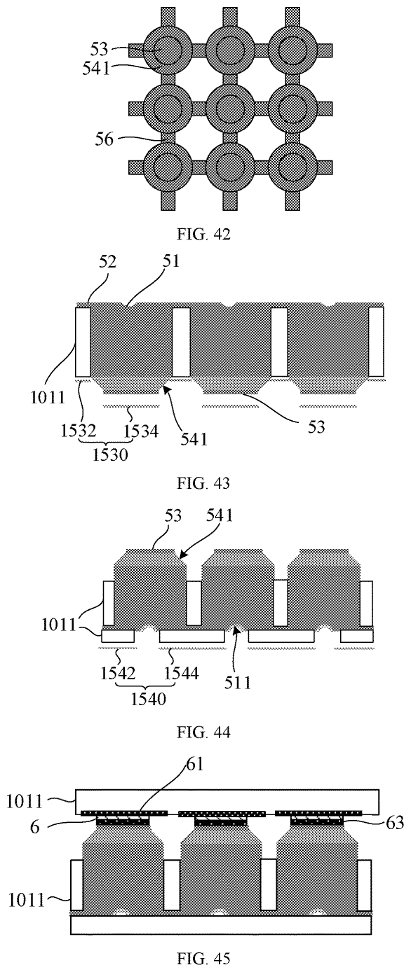

In some embodiments, as shown in FIGS. 41-42, the connecting layer 56 is fixed along the entire circumference of each optical module 10, thereby making the entire array more stable. In some embodiments, the connecting layer 56 is arranged at intervals along the circumference of each optical module 10, which can reduce the amount of injected light-transmitting material and lower costs. It can be understood that the connecting layer 56 is formed by the distance D2 in the above embodiment, and the thickness of the connecting layer 11 can be between 100 and 500 micrometers. This ensures the overall structural strength of the optical module array without making subsequent mechanical cutting difficult.

In some embodiments, as shown in FIGS. 38-39, the position of distance D2 is not flush with the second surface 31. It can be understood that since the annular surface 32 is on the outside of the second surface 31 and is not a regular vertical surface, to ensure that the annular surface 32 can still maintain the intended design of any one or combination of an inclined surface, spherical surface, aspherical surface, or free-form surface during the pressing process, i.e., to reduce the possibility of the annular surface 32 deforming during the formation of the annular wall 54 due to being too close to the gap D2 during the warm glue process, it is necessary to ensure that the gap opening is as far away from the annular surface 32 as possible. That is, ensure that the cross-section perpendicular to the line connecting the gaps is not flush with the annular surface 32, for example, higher or lower than the position of gap D1 or D2, which is conducive to maintaining the reference surface formation of the annular surface.

In some embodiments, the gap D2 may also be absent. In this case, the demolded base body 50 exists as individual units rather than an array connected by the connecting structure 56. This facilitates flexible selection of individual main bodies 10 in subsequent processes.

In some embodiments, as shown in FIG. 47, the method also includes providing a light-transmitting layer 8, the size of the light-transmitting layer being greater than or equal to the size of the exit window 3; covering the light-transmitting layer 8 on the first reflection window 2 and the exit window 3; the light-transmitting layer 8 can be PMMA (polymethyl methacrylate), PC (polycarbonate) plastic, resin glass, etc. The light-transmitting layer 8 can serve to protect or shield the optical module 10.

It can be understood that covering the light-transmitting layer 8 on the exit window 3 corresponding to the first wall 52 and the first reflection window 2 corresponding to the concave wall 51, and the size of the light-transmitting layer 8 is greater than or equal to the size of the first wall 52. Optical glue can be used to bond the light-transmitting layer 8 and the first wall 52. The light-transmitting layer 8 may not alter the original light propagation path, can protect the first wall 52 and the concave wall 51, reduce wear and tear, and also prevent dust and other debris from entering and affecting the optical efficiency. In some embodiments, the size of the light-transmitting layer 8 can be the same as the size enclosed by the non-transmissive encapsulation material, so that the overall structure is more regular, facilitating subsequent assembly.

As shown in FIG. 47, the present application also provides an embodiment of a near-eye display module 100 manufactured by the manufacturing method of the above embodiment. The near-eye display module as a whole can be cylindrical or prismatic. The overall size can be from 0.5 cubic millimeters to 5 cubic centimeters, for example, 0.5 cubic millimeters, 1 cubic millimeter, 8 cubic millimeters, 1 cubic centimeter, 2 cubic centimeters, 5 cubic centimeters, etc. Its size is relatively small to the naked eye, making it easier to integrate into various other devices without affecting the original device's appearance or large-area structure. For example, the near-eye display module can be used in prescription glasses, reading glasses, sunglasses, goggles, smart glasses, or other head-mounted devices, etc., offering good adaptability.

A method for manufacturing a near-eye display module, including: providing a first mold, the first mold including a first surface and a convex surface, the convex surface protruding relative to the first surface; providing a second mold, the second mold including a second surface and an annular surface, the annular surface surrounding the second surface and being non-coplanar with the second surface, where the first mold and/or the second mold is further provided with a first sidewall to form a cavity on the first mold and/or the second mold, the first sidewall being perpendicular to the first surface and the second surface; aligning the first mold and the second mold so that the convex surface and the second surface are coaxially aligned, and the first surface and the second surface are parallel; injecting a light-transmitting material in a molten state between the first mold and the second mold; pressing the first mold and the second mold together so that the light-transmitting material in a molten state conforms to the first surface, the convex surface, the second surface, and the annular surface; demolding the first mold and the second mold to obtain a lens body formed by solidification of the light-transmitting material, where a first end of the lens body includes a wall complementary in shape to the convex surface, and a second end of the lens body includes a wall complementary in shape to the annular surface.

In some embodiments, the first mold includes a plurality of first surfaces arranged in an array and a plurality of convex surfaces arranged in an array, the second mold includes a plurality of second surfaces arranged in an array and a plurality of annular surfaces arranged in an array, the convex surfaces and the annular surfaces include any one or a combination of an inclined surface, a spherical surface, an aspherical surface, or a free-form surface, the first end of the lens body includes a first wall and a concave wall lower than the first wall, the second end of the lens body opposite the first end includes a second wall and an annular wall, the second wall is parallel to the first wall, the annular wall surrounds the second wall, the lens body further includes a second sidewall connecting the first wall and the annular wall. The shape of the first surface is the same as the shape of the first wall, and the shape of the second surface is the same as the shape of the second wall. The first mold and/or the second mold is further provided with a third sidewall, the third sidewall being parallel to the first sidewall, and the third sidewall dividing the cavity into cavities arranged in an array.

After obtaining the lens body formed by solidification of the light-transmitting material, the method further includes depositing a reflective layer on the concave wall and the annular wall. In some embodiments, after depositing the reflective layer on the concave wall and the annular wall, it further includes: mounting a micro-display on each second wall, the micro-display and the second wall being in close contact, and the transverse dimension of the micro-display being less than or equal to the transverse dimension of the second wall. In some embodiments, after mounting the micro-display on each second wall, it further includes: cutting a connecting structure between two adjacent lens bodies in a direction perpendicular to the first wall to separate them into individual lens bodies.

After cutting the connecting structure between two adjacent lens bodies to separate them into individual lens bodies, the method further includes: encapsulating a single lens body with an encapsulation material to expose the first wall, where the encapsulation material is non-transmissive. In some embodiments, before demolding the first mold and the second mold, it further includes determining whether the temperature of the light-transmitting material is below a solidification point; if the temperature of the light-transmitting material is below the solidification point, demolding the first mold and the second mold; if the temperature of the light-transmitting material is not below the solidification point, controlling the temperature of the light-transmitting material to reach below the solidification point. In some embodiments, pressing the first mold and the second mold together further includes: determining whether the distance between the first surface and the second surface during pressing meets a preset value; if the distance meets a preset value, stopping pressing; otherwise, pressing to the preset distance. In some embodiments, depositing the reflective layer on the concave wall and the annular wall includes: providing a first baffle, the first baffle including a first sub-baffle and a second sub-baffle, with a gap between the first sub-baffle and the second sub-baffle, the first sub-baffle and the second sub-baffle having different heights and sizes; shielding a gap between two adjacent lens bodies with the first sub-baffle, shielding the second wall with the second sub-baffle, the gap corresponding to the annular wall, the distance of the gap being equal to the distance between two adjacent second walls, and evaporating a metal or metal alloy reflective layer onto the annular wall through the gap; providing a second baffle, the structure of the first baffle being different from the structure of the second baffle, the first baffle including a third sub-baffle and a fourth sub-baffle, with a gap between the third sub-baffle and the fourth sub-baffle, the third sub-baffle and the fourth sub-baffle having the same height; shielding the first wall with the third sub-baffle, the fourth sub-baffle spanning across two adjacent first walls, the gap corresponding to the concave wall, the distance of the gap being equal to the width of the concave wall, and evaporating a metal or metal alloy reflective layer onto the concave wall through the gap.

The method further includes: providing a transparent protective layer; covering the transparent protective layer on the first wall and the concave wall, and the size of the transparent protective layer being greater than or equal to the size of the first wall. The method for manufacturing a near-eye display module according to the embodiments of the present application can encapsulate and manufacture the optical module and the micro-display, featuring a streamlined process flow, reduced raw material cutting, lower preparation cost, and reduced risk of damaging optical components due to cutting. The final near-eye display module has a small size and high optical efficiency, presenting good application prospects.

The present application also provides a method for manufacturing a near-eye display module 100′, for manufacturing the near-eye display module 10 as described in the above embodiments, where the method includes:

Step S11: providing an injection mold, the injection mold including an injection cavity, an inner surface of the injection cavity at least including a first injection surface, a second injection surface, a third injection surface, and a fourth injection surface, the first injection surface and the second injection surface being disposed opposite to each other, the second injection surface and the fourth injection surface being located on the same side, and the third injection surface being located on a side of the first injection surface.

In some embodiments, as shown in FIGS. 49-56, the injection mold can be arranged in an m×n array, where m and n can be, but are not limited to, 1, 2, 3, 4, or other numbers. In some embodiments, taking m=1 and n=3 as an example, the injection mold can be a 1×3 array. In some embodiments, the injection mold 20′ includes an injection cavity, an inner surface of the injection cavity at least including a first injection surface 220′, a second injection surface 210′, a third injection surface 230′, and a fourth injection surface 211′. The first injection surface 220′ and the second injection surface 210′ are disposed opposite to each other. The second injection surface 210′ and the fourth injection surface 211′ are located on the same side. The third injection surface 230′ is located on a side of the first injection surface 220. The injection mold 20′ includes a top wall 21′, a bottom wall 22′, and a side wall 23′. The top wall 21′ and the bottom wall 22′ can be mutually parallel walls. The side wall 23′ can be perpendicular to the top wall 21′ and/or the bottom wall 22′. For example, the side wall 23′ is perpendicular to the top wall 21′, and the side wall 23′ can also be perpendicular to the bottom wall 22′. Alternatively, at least a portion of the side wall 23′ can be perpendicular to the bottom wall 22′. In other embodiments, the side wall 23′ may also include the outermost circumferential side wall, or the side wall 23′ includes the outermost circumferential side wall and a plurality of side walls spaced in between. The first injection surface 220′ is located on the bottom wall 22′, the second injection surface 210′ and the fourth injection surface 211′ are located on the top wall 21′, and the third injection surface 230′ is located on the side wall 23′. The fourth injection surface 211′ is disposed on the periphery of the second injection surface 210′. The fourth injection surface 211′ is parallel to the first injection surface 220′. In some embodiments, the first injection surface 220′ may be provided with a positioning mechanism 221′. The positioning mechanism 221′ may include at least two positioning posts or positioning holes or positioning steps, etc. The display element 30′ is placed on the at least two positioning mechanisms 221′ to fix or pre-fix the display element 30′. In other embodiments, the positioning mechanism 221′ may also be a positioning hole (not shown). The display element 30′ may be provided with a positioning post 2210. The positioning hole and the positioning post are matched with each other to achieve pre-fixing of the display element 30′ on the second injection surface 220′. Here, pre-fixing may mean that the display element 30′ is supported, positioned, or fixed by the positioning posts 2210. Of course, the number of positioning posts 2210 or positioning holes may also be 3, 4, or other numbers, as long as they can position or pre-fix the display element. In other embodiments, the positioning mechanism may also be understood as using snap-fitting, bonding, bolts, or similar methods that can position or pre-fix. The lateral distance between the side surfaces of the step portions of the two positioning posts 2210 may be less than or equal to the minimum lateral distance between the third injection surfaces 230′, making it convenient to directly place the display element 30′ on the positioning posts 2210 from above. Of course, in other embodiments, the lateral distance between the side surfaces of the step portions of the two positioning posts 2210 may also be greater than the minimum lateral distance between the third injection surfaces 230′. In this case, the display element 30′ can be placed on the positioning posts 2210 from the side rather than from above. The vertical height of the positioning posts 2210 may be lower than the third injection surface 230′, and there is a gap between the positioning posts 2210 and the side wall 23′, ensuring that the display element 30 can be placed on the positioning posts 2210. The top wall 21′ protrudes toward the first injection surface 220′ to form a first protrusion 200′. At least a portion of the surface of the first protrusion 200′ forms the second injection surface 210′. The second injection surface 210′ may include any one of an inclined surface, a spherical surface, an aspherical surface, or a free-form surface. The fourth injection surface 211′ is arranged surrounding the contour of the first protrusion 200′. The side wall 23′ protrudes laterally to form a second protrusion 201′. It can be understood that the lateral direction here may be, for example, the direction of the line connecting two adjacent cavities in FIG. 49. At least a portion of the surface of the second protrusion 201′ forms the third injection surface 230′. The third injection surface 230′ may face the second injection surface 210′ and the fourth injection surface 211′. For example, the third injection surface 230′ may be inclined relative to the fourth injection surface 211′. Of course, the third injection surface 230′ may include any one of an inclined surface, a spherical surface, an aspherical surface, or a free-form surface. If the third injection surface 230′ is non-planar, the third injection surface 230′ may not be inclined relative to the fourth injection surface 211′. In some embodiments, the transverse dimension of the second injection surface 210′ may be greater than or equal to the transverse dimension of the first injection surface 220′. The first injection surface 220′ and the second injection surface 210′ may be center-aligned. The maximum transverse dimension of the third injection surface 230′ may be equal to the transverse dimension of the fourth injection surface 211′. The side wall 23′ is provided on opposite sides with an inlet runner 231′ and an outlet runner 232′ communicating the exterior with the injection cavity, for performing injection into the injection cavity. The vertical heights of the inlet runner 231′ and the outlet runner 232″ may both be higher than the third injection surface 230′. The position of the inlet runner 231′ may be horizontally flush with the position of the outlet runner 232′, as shown in FIG. 49. In other embodiments, the inlet runner 231′ may also be provided on the top wall 21′ and/or the bottom wall 22′, and the outlet runner 232′ may correspondingly be provided on the top wall 21′ and/or the bottom wall 22′. For example, the top wall 21′ is provided with the inlet runner 231′, and the bottom wall 22′ is provided with the outlet runner 232′. The number of inlet runners 231′ and outlet runners 232′ can be selected according to the actual injection array size, as long as uniform injection can be achieved.

In some embodiments, the first injection surface 220′ and the fourth injection surface 211′ can be planes, respectively. The second injection surface 210′ and the third injection surface 230′ can be spherical surfaces, aspherical surfaces, or free-form surfaces, etc. The first injection surface 220′ and the third injection surface 230′ are two different types of surfaces, respectively, and the fourth injection surface 211′ and the second injection surface 210′ are two different types of surfaces, respectively.

In other embodiments, the first injection surface 220′ and the second injection surface 210′ are the same type of surface. For example, they can both be spherical surfaces, aspherical surfaces, or free-form surfaces, etc. The outline shapes of the first injection surface 220′ and the second injection surface 210′ can be the same, for example, polygonal, circular, or elliptical, etc. The second injection surface 210′ and the fourth injection surface 211′ can be the same type of surface. For example, they can both be spherical surfaces, aspherical surfaces, or free-form surfaces, etc., such as generated using Zernike polynomials. In other embodiments, the first injection surface 220′, the second injection surface 210′, the third injection surface 230′, and the fourth injection surface 211′ are the same type of surface. In optical design, they can be designed by the same function, for example, generated using Zernike polynomials.

In some embodiments, the positioning mechanism 221′ provided on the first injection surface 220′ can surround the first injection surface 220′. The positioning mechanism 221′ can be configured to fix or pre-fix the display element 30′.

In some embodiments, the injection cavity includes a plurality arranged in an array. The inlet runner 231′ of a centrally located injection cavity communicates with the outlet runner 232 of an adjacent injection cavity. It can be understood that in two adjacent injection cavities, the inlet runner 231′ of one injection cavity communicates with the outlet runner 232′ of the other injection cavity. Here, the outlet runner 232′ can be relative to the inlet runner 231′ within a single array. In some embodiments, the outlet runner 232′ can be the inlet runner 231′ of another adjacent cavity.

In some embodiments, the cavity formed by the injection mold can be cylindrical, prismatic, frustoconical, or other regular shapes. For example, it can be an array of cavities, where the sizes of the cavities in the array can be the same. Of course, the sizes of the cavities in the array can also be different, for example, having regularly arranged sizes, such as the sizes of the array cavities arranged laterally increasing sequentially, or sizes alternating at intervals. In cavities of different sizes, the spacing of the corresponding positioning posts 2210 can also be different, so that display elements of different sizes can be placed in the subsequent step, for example, step 12, and injection molding can be performed at once to form modules of different sizes.

Step S12: placing the display element on the first injection surface.

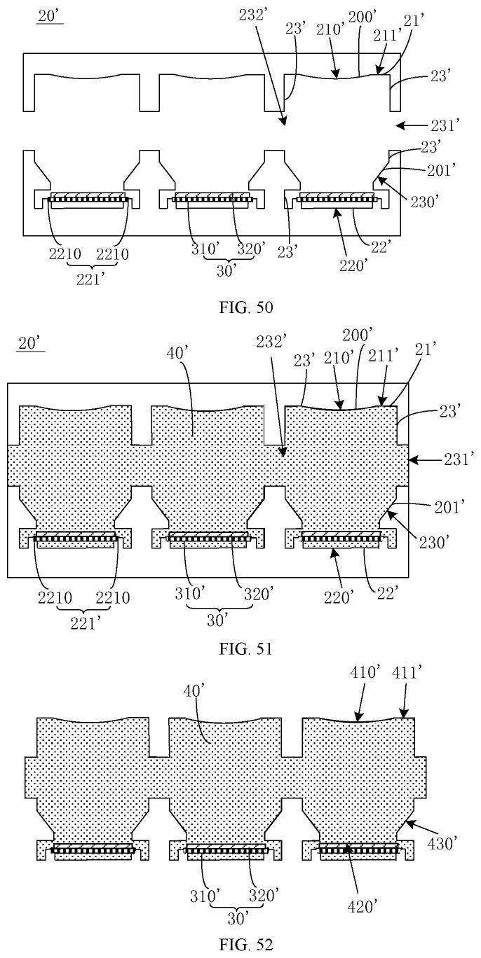

In some embodiments, the display element 30′ can be placed on the first injection surface 220′ first. For example, by setting the size of the first injection surface 220′ to be exactly compatible with the display element 30′, placing the display element 30′ can position it, thereby reducing the probability of it shaking. In other embodiments, methods such as bonding, welding, or snap-fitting can be used to position and place the display element 30′ on the first injection surface 220′. In some embodiments, the positioning mechanism 221′ may include positioning posts, positioning holes, or positioning steps, etc. Taking the positioning mechanism 221′ as positioning posts as an example, the display element 30′ is placed on at least two positioning posts 2210. In other embodiments, the positioning posts 2210 may also be provided with step portions, and the display element 30′ is placed between at least two step portions to pre-place or fix the display element 30′. For example, a clamp or the like can be used to clamp the display element 30′ onto the positioning posts 2210. In some embodiments, the display element 30′ may further include a backplane 310′ and a micro-display screen 320′. The backplane 310′ may be a substrate or a circuit board. In some embodiments, the backplane 310′ and the micro-display screen 320′ may be a packaged integral module, rather than mutually independent backplane 310′ and micro-display screen 320′. The micro-display screen 320′ may be a light-emitting element, and the circuit board and the light-emitting element are electrically connected. The backplane 310′ is placed on the first injection surface 220′, and the micro-display screen 320′ is placed on the backplane 310′, as shown in FIG. 50. It can be understood that the positioning mechanism 221′ is used to fix the backplane 310′ and the micro-display screen 320′. The backplane 310′ can be connected to an external circuit for image signal input and energy supply. The micro-display screen 320′ can provide the displayed image content. The micro-display screen 320′ can be understood the same as or similar to the micro-display 6. For a description of this component, refer to the above embodiments and will not be repeated here.

Step S13: performing injection into the injection cavity to form a main body (base body) within the injection cavity, the main body including a light incident surface corresponding to the display element, a first reflective surface corresponding to the second injection surface, a second reflective surface corresponding to the third injection surface, and a light exit surface corresponding to the fourth injection surface; the light incident surface being bonded to the display element.

In some embodiments, injection is performed into the injection cavity through the inlet runner 231′ on the side wall 23′ of the injection mold 20′ to form the main body 40′. The light incident surface 420′ is completely bonded to the display element 30′ without any gap. It can be understood that the cured molten main body material can further fix the display element 30′ and the formed main body 40′ together, thereby reducing the subsequent process of separately coating optical glue on the display element 30′ or the main body 40′ to bond them together, as shown in FIG. 51. In some embodiments, molten main body material is injected through the inlet runner 231′ on the side wall 23′ of the injection mold 20′ to form the main body 40′ within the injection cavity. The main body material includes, but is not limited to, glass, vitrified glass, polymethyl methacrylate (PMMA plastic), polycarbonate (PC plastic), and resin.

In some embodiments, when the injection cavity contains an air medium, the micro-display screen 320′ and the backplane 310′ are assembled later after the cavity is formed.

Step S14: removing the injection mold; where light from the display element is configured to enter the main body from the light incident surface, be sequentially reflected by the first reflective surface and the second reflective surface, and then exit through the light exit surface.

In some embodiments, after injecting the molten main body material into the injection cavity, it is allowed to cool so that the temperature of the main body material is far below the corresponding solidification point, then the injection mold 20′ can be removed, for example, using a clamp to demold the mold 20′ to expose the main body 40′. The main body 40′ includes a light incident surface 420′ corresponding to and bonded to the display element 30′, a first reflective surface 410′ corresponding to the second injection surface 210′, a second reflective surface 430′ corresponding to the third injection surface 230′, and a light exit surface 411′ corresponding to the fourth injection surface 211′, as shown in FIG. 52. In another embodiment, after injecting the molten main body material into the injection cavity, if the temperature of the main body material is not below the corresponding solidification point, cooling methods such as air cooling, water cooling, or natural heat dissipation can be used to continue cooling until it is below the corresponding solidification point, thereby allowing the removal of the injection mold 20′ and exposing the main body 40′. At this time, the display element 30′ can be fixed as an integral unit with the main body 40′.

In some embodiments, the light exit surface 411′ and the light incident surface 420′ can be planes, respectively. The first reflective surface 410′ and the second reflective surface 430′ can be planes, spherical surfaces, aspherical surfaces, or free-form surfaces, etc. The light exit surface 411′ and the first reflective surface 410′ are two different types of surfaces, respectively, and the second reflective surface 430′ and the light incident surface 420′ are two different types of surfaces, respectively.

In other embodiments, the light incident surface 420′ and the first reflective surface 410′ are the same continuous surface. For example, they can both be spherical surfaces, aspherical surfaces, or free-form surfaces, etc. The outline shapes of the light incident surface 420′ and the first reflective surface 410′ can be the same, for example, polygonal, circular, or elliptical, etc. The first reflective surface 410′ and the light exit surface 411′ are the same continuous surface. For example, they can both be one of spherical, aspherical, or free-form surfaces, such as generated using Zernike polynomials. In other embodiments, the light incident surface 420′, the first reflective surface 410′, the second reflective surface 430′, and the light exit surface 411′ are the same continuous surface. In optical design, they can be designed by the same function, for example, generated using Zernike polynomials. For this part, reference can be made to the relevant embodiments described above.

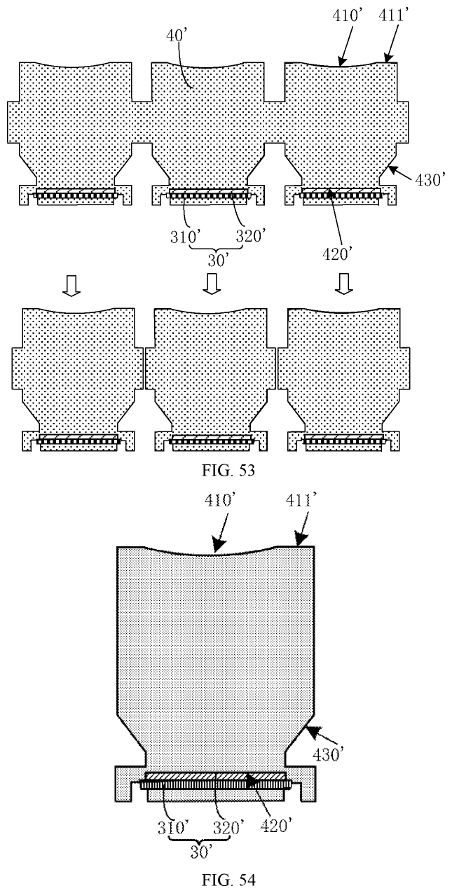

In some embodiments, after removing the injection mold, it further includes: cutting the connected plurality of main bodies. In some embodiments, adjacent two main bodies are cut along the runner to separate them into individual main bodies, as shown in FIG. 53. The cutting method includes, but is not limited to, mechanical cutting methods and laser cutting methods.

In some embodiments, the individual main bodies formed after cutting are polished to remove residual material and burrs from the surface, as shown in FIG. 54. In some embodiments, the polishing method can be mechanical polishing, wet polishing, dry polishing, etc.

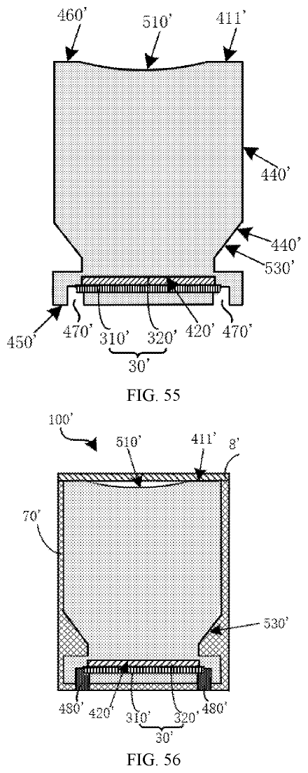

In some embodiments, further operations can be performed on the cut main body. The main body 40′ includes a side surface 440′, a bottom surface 450′, and a top surface 460′. The side surface 440′ includes a second mirror surface 530′. The top surface 460′ includes a first mirror surface 510′ and the light exit surface 411′. The bottom surface 450′ includes a through hole 470′. The through hole 470′ can be formed corresponding to the positioning posts 2210 provided on the first injection surface 220′. For example, the positions of the positioning posts 2210 are not filled by the molten main body material. After removing the mold 20′, the positions corresponding to the positioning posts 2210 form the through hole 470′. In some embodiments, the main body 40′ can be subjected to mirror surface evaporation coating first, and then the evaporated main body 40′ is encapsulated. In some embodiments, evaporation coating is performed on the first reflective surface 410′ of the main body 40′ to form a first mirror surface 510′; and evaporation coating is performed on the second reflective surface 430′ of the main body 40′ to form a second mirror surface 530′, as shown in FIG. 55. A metal mask can be used to shield areas other than the first reflective surface 410′, so that a layer of metal is evaporated on the first reflective surface 410′ to form the first mirror surface 510′. This metal can be aluminum, silver, or a mixture of aluminum and silver, etc. For evaporating a layer of metal on the second reflective surface 430′ to form the second mirror surface 530′, the same method as above can be used, or other coating methods such as sputter coating, ion plating can be used. When evaporating a layer of metal on the second reflective surface 430′ to form the second mirror surface 530′, the metal evaporation direction can be rotated, or the main body can be rotated while keeping the evaporation direction fixed. It should be noted that when forming the first mirror surface 510′ and the second mirror surface 530′, there is no fixed order for forming the mirror surfaces. Furthermore, the metal used to form the mirror surfaces can be the same material for the first mirror surface 510′ and the second mirror surface 530′, or they can be different materials.

In some embodiments, a conductive structure 480′ is provided in the through hole 470′ of the evaporated main body 40′. The conductive structure can be metal or alloy, etc., so that the display element 30′ is electrically connected through the conductive structure. For example, the conductive structure 480′ can be provided in the through hole 470′ by welding or other methods, and then encapsulated while allowing the conductive structure 480′ to be exposed relative to the encapsulation material, achieving electrical conduction between the conductive structure 480′ and the exterior. In other embodiments, the conductive structure 480′ can also be configured as a corresponding male and/or female electrical plug-in form. For example, the conductive structure 480′ can be an electrical male connector, which can be electrically connected to the display element 30′. An electrical female connector can be used for plug-in connection to an external power source or driver. Alternatively, the conductive structure 480′ can be an electrical female connector sleeved in the through hole 470′, which can be electrically connected to the display element 30′. For connection, a cable with an electrical male connector can be used for plug-in connection to an external power source or driver. Of course, the electrical connection of the above conductive connection structure may also be spot welding or other electrical connection methods. In some embodiments, it may also include providing an encapsulation layer 70′ on the side surface 440′ of the main body 40′. In other embodiments, an encapsulation layer 70′ may also be further provided on the bottom surface 450′. In some embodiments, it also includes forming an optical protective layer 8′ on the top surface 460′ of the main body 40′. The optical protective layer 8′ can be understood the same as or similar to the light-transmitting layer 8 in the above embodiments. As shown in FIG. 56. The material for forming the encapsulation layer 70′ includes, but is not limited to, black epoxy resin, black silicone rubber, carbon black, nickel black, black chrome, and Vantablack. It should be noted that the material used for encapsulation must not cover the light exit surface 411′. The optical protective layer 8′ can be a light-transmitting material, which may not alter the original light propagation path, can protect the light exit surface 411′ and the first mirror surface 510′, reduce wear and tear, and also prevent dust and other debris from entering and affecting the optical efficiency.

In some embodiments, the through hole 470′ formed corresponding to the positioning posts 2210 provided on the first injection surface 220′ can be filled first, for example, with a post of the same shape, or covered with a cover plate. Then, the main body 40′ is encapsulated. The encapsulation order may also be: forming a first encapsulation layer on the side surface 440′ of the main body 40′, then forming a second encapsulation layer on the bottom surface 450′ of the main body 40′, and finally forming an optical protective layer 8′ on the top surface 460′ of the main body. After encapsulation is completed, the filling material or cover is removed to expose the through hole, so that the backplane 310′ can be metal-connected through the through hole.

In another embodiment, the demolded main body 40′ can be subjected to evaporation coating first, then cut, the cut main body 40′ polished, and finally encapsulated.

It can be understood that in the process of manufacturing a near-eye display module, there are currently problems such as high preparation cost and complex process. For example, the existing technology mostly involves forming the optical module first, and then using additional fixtures to align, bond, attach, and fix the optical module and the display, followed by subsequent encapsulation and other operations. This process may require additional fixtures or operating steps to first clamp and position the optical module and the display separately, and then bond them together, requiring more fixtures, workstations, or steps. However, in this embodiment, an injection mold is provided, and the near-eye display module is prepared by injection molding. The display element is pre-fixed and placed into the injection mold in advance. During the injection molding process to form the near-eye display module, the molten and cured near-eye display module can be directly fixed with the display element, reducing the subsequent steps of separately aligning, bonding, attaching, and fixing the optical module and the display, making the entire preparation process more streamlined. Furthermore, since the display element is integrated with the main body, there is no need to use fixtures or clamps for bonding, reducing related fixtures, workstations, etc., thereby effectively lowering production costs.

The present application provides a method for manufacturing a near-eye display module. The preparation method includes: providing an injection mold, the injection mold including an injection cavity, an inner surface of the injection cavity at least including a first injection surface, a second injection surface, a third injection surface, and a fourth injection surface, the first injection surface and the second injection surface being disposed opposite to each other, the second injection surface and the fourth injection surface being located on the same side, and the third injection surface being located on a side of the first injection surface; placing a display element on the first injection surface; performing injection into the injection cavity to form a main body within the injection cavity, the main body including a light incident surface corresponding to the display element, a first reflective surface corresponding to the second injection surface, a second reflective surface corresponding to the third injection surface, and a light exit surface corresponding to the fourth injection surface; removing the injection mold; where light from the display element enters the main body from the light incident surface, is sequentially reflected by the first reflective surface and the second reflective surface, and then exits through the light exit surface. Through the above method, using an injection mold and manufacturing the near-eye display module by injection molding, the display element and the main body are integrated into one unit, eliminating the need for separate fixtures to clamp and bond the display element and the main body, thereby effectively reducing manufacturing costs. In addition, the near-eye display module has a small volume, allowing users to choose to wear different forms of glasses according to their needs, while also enjoying the digital content display effect brought by the near-eye display module, thus improving the user's wearing experience.

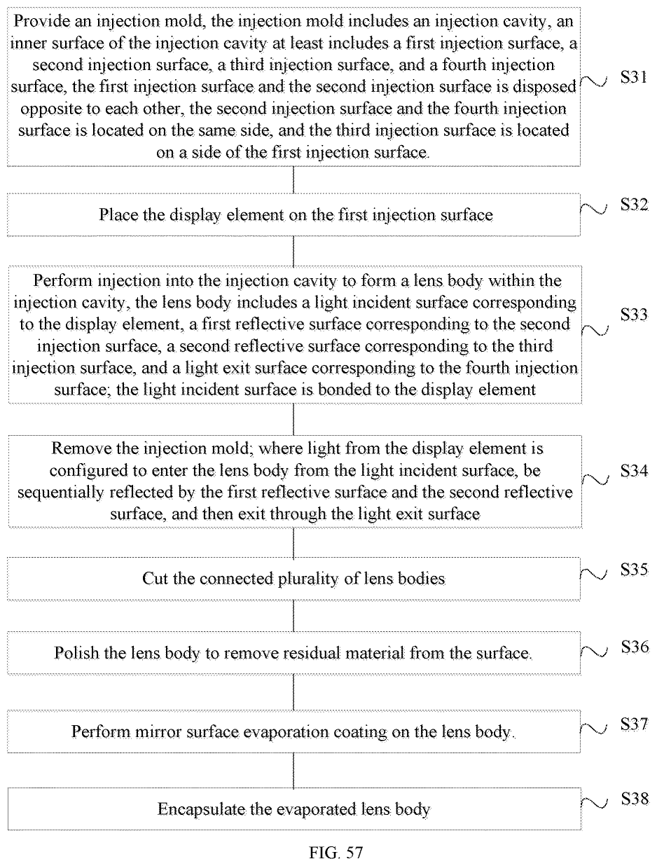

As shown in FIG. 57, a flow diagram of another embodiment of a method for manufacturing a near-eye display module is provided by the present application. The method includes the following steps:

Step S31: providing an injection mold, the injection mold including an injection cavity, an inner surface of the injection cavity at least including a first injection surface, a second injection surface, a third injection surface, and a fourth injection surface; the first injection surface and the second injection surface is disposed opposite to each other, the second injection surface and the fourth injection surface is located on the same side, and the third injection surface is located on a side of the first injection surface.

On the same side, the third injection surface is located on a side of the first injection surface. In some embodiments, the injection mold 20′ includes an injection cavity, an inner surface of the injection cavity at least including a first injection surface 220′, a second injection surface 210′, a third injection surface 230′, and a fourth injection surface 211′. The first injection surface 220′ and the second injection surface 210′ are disposed opposite to each other. The second injection surface 210′ and the fourth injection surface 211′ are located on the same side. The third injection surface 230′ is located on a side of the first injection surface 220. The injection mold 20′ includes a top wall 21′, a bottom wall 22′, and a side wall 23′. The first injection surface 220′ is located on the bottom wall 22′. The second injection surface 210′ and the fourth injection surface 211′ are located on the top wall 21′. The third injection surface 230′ is located on the side wall 23′. The first injection surface 220′ is provided with a positioning mechanism 221′. The positioning mechanism 221′ includes at least two positioning posts 2210. The positioning posts 2210 are provided with step portions. The display element 30′ is placed between the step portions of the at least two positioning posts 2210 to fix the display element 30′. The lateral distance between the side surfaces of the step portions of the two positioning posts 2210 may be less than or equal to the minimum lateral distance between the third injection surfaces 230′. Of course, in other embodiments, the lateral distance between the side surfaces of the step portions of the two positioning posts 2210 may also be greater than the minimum lateral distance between the third injection surfaces 230′. In this case, the display element 30′ can be placed on the positioning posts 2210 from the side rather than from above. The vertical height of the positioning posts 2210 may be lower than the third injection surface 230′, and there is a gap between the positioning posts 2210 and the side wall 23′. The top wall 21′ protrudes toward the first injection surface 220′ to form a first protrusion 200′. At least a portion of the surface of the first protrusion 200′ forms the second injection surface 210′. The second injection surface 210′ includes any one of an inclined surface, a spherical surface, an aspherical surface, or a free-form surface. The fourth injection surface 211′ is arranged surrounding the contour of the first protrusion 200′. The side wall 23′ protrudes laterally to form a second protrusion 201′. At least a portion of the surface of the second protrusion 201′ forms the third injection surface 230′. The third injection surface 230′ may be inclined relative to the fourth injection surface 211′. The third injection surface 230′ may face the second injection surface 210′ and the fourth injection surface 211′. The third injection surface 230′ includes any one of an inclined surface, a spherical surface, an aspherical surface, or a free-form surface. The transverse dimension of the second injection surface 210′ is greater than or equal to the transverse dimension of the first injection surface 220′. The first injection surface 220′ and the second injection surface 210′ are center-aligned. The maximum transverse dimension of the third injection surface 230′ may be equal to the transverse dimension of the fourth injection surface 211′. The side wall 23′ is provided on opposite sides with an inlet runner 231′ and an outlet runner 232′ communicating the exterior with the injection cavity, for performing injection into the injection cavity. The vertical heights of the inlet runner 231′ and the outlet runner 232′ are both higher than the third injection surface 230′. The position of the inlet runner 231′ is horizontally flush with the position of the outlet runner 232′. In other embodiments, the inlet runner 231′ may also be provided on the top wall 21′ and/or the bottom wall 22′, and the outlet runner 232′ may correspondingly be provided on the top wall 21′ and/or the bottom wall 22′. For example, the top wall 21′ is provided with the inlet runner 231′, and the bottom wall 22′ is provided with the outlet runner 232′. The number of inlet runners 231′ and outlet runners 232′ can be selected according to the actual injection array size, as long as uniform injection can be achieved. For the shapes of the various injection surfaces, reference can also be made to the relevant embodiments described above.

In some embodiments, the positioning mechanism 221′ provided on the first injection surface 220′. The positioning mechanism 221′ may include a plurality of positioning posts 2210. The plurality of positioning posts 2210 may surround the first injection surface 220′ to fix or pre-fix the display element 30′. In some embodiments, the injection cavity includes a plurality arranged in an array. The inlet runner 231′ of a centrally located injection cavity communicates with the outlet runner 232 of an adjacent injection cavity. It can be understood that in two adjacent injection cavities, the inlet runner 231′ of one injection cavity communicates with the outlet runner 232′ of the other injection cavity. Here, the outlet runner 232′ can be relative to the inlet runner 231′ within a single array. In some embodiments, the outlet runner 232′ can be the inlet runner 231′ of another adjacent cavity. In some embodiments, the cavity formed by the injection mold can be cylindrical, prismatic, frustoconical, or other regular shapes.

Step S32: placing the display element on the first injection surface.

In some embodiments, the positioning mechanism 221′ may include positioning posts 2210, and the display element 30′ is placed on the positioning posts 2210. In other embodiments, the positioning posts 2210 may also be provided with step portions, and the display element 30′ is placed between at least two step portions to pre-place or fix the display element 30′. In some embodiments, the display element 30′ may further include a backplane 310′ and a micro-display screen 320′. The backplane 310′ may be a substrate or a circuit board. The micro-display screen 320′ may be a light-emitting element. The circuit board and the light-emitting element are electrically connected. On the first injection surface 220′, the backplane 310′ is placed, and the micro-display screen 320′ is placed on the backplane 310′. The backplane 310′ can be connected to an external circuit for image signal input and energy supply. The micro-display screen 320′ can provide the displayed image content. The micro-display screen 320′ can be understood the same as or similar to the micro-display 6. For a description of this component, refer to the above embodiments and will not be repeated here.

Step S33: performing injection into the injection cavity to form a main body within the injection cavity, the main body including a light incident surface corresponding to the display element, a first reflective surface corresponding to the second injection surface, a second reflective surface corresponding to the third injection surface, and a light exit surface corresponding to the fourth injection surface; the light incident surface being bonded to the display element.

In some embodiments, molten main body material is injected through the inlet runner 231′ on the side wall 23′ of the injection mold 20′ to form the main body 40′ within the injection cavity. The main body material includes, but is not limited to, glass, vitrified glass, polymethyl methacrylate (PMMA plastic), polycarbonate (PC plastic), and resin.

Step S34: removing the injection mold; where light from the display element is configured to enter the main body from the light incident surface, be sequentially reflected by the first reflective surface and the second reflective surface, and then exit through the light exit surface.

In some embodiments, after injecting the molten main body material into the injection cavity, it is allowed to cool sufficiently so that the temperature of the main body material is far below the corresponding solidification point, then the injection mold 20′ can be removed to expose the main body 40′. The main body 40′ includes a light incident surface 420′ corresponding to the display element 30′, a first reflective surface 410′ corresponding to the second injection surface 210′, a second reflective surface 430′ corresponding to the third injection surface 230′, and a light exit surface 411′ corresponding to the fourth injection surface 211′.

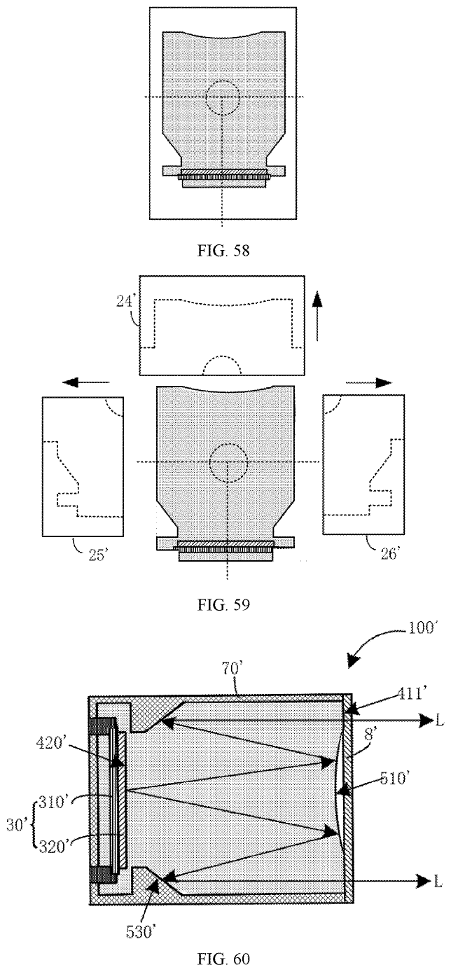

As shown in FIGS. 58 and 59, FIG. 58 is a schematic left perspective structural diagram of an embodiment of injection molding using the injection mold provided by the present application. FIG. 59 is a schematic left perspective structural diagram corresponding to an embodiment after demolding from the mold in FIG. 58. The injection mold 20′ can be arranged in a 1×N array, where N can be 1, 2, 3, or other numbers. The injection mold can be divided into three sub-molds: a first sub-mold 24′, a second sub-mold 25′, and a third sub-mold 26′. The second injection surface 210′ and the fourth injection surface 211′ are located on the first sub-mold 24′. The first injection surface 220′ is located on the second sub-mold 25′ and the third sub-mold 26′. The third injection surface 230′ is located on the second sub-mold 25′ and the third sub-mold 26′. The second sub-mold 25′ and the third sub-mold 26′ are symmetrical structures. That is, the first sub-mold 24′ includes the second injection surface 210′ and the fourth injection surface 211′ of the injection mold. The second sub-mold 25′ includes a part of the first injection surface 220′ and a part of the third injection surface 230′ of the injection mold. The third sub-mold 26′ includes a part of the first injection surface 220′ and a part of the third injection surface 230′ of the injection mold. In some embodiments, the first sub-mold 24′ of the injection mold can be removed from above (arrow direction) to expose the light exit surface 411′ and the first reflective surface 410′ of the main body 40′. The second sub-mold 25′ and the third sub-mold 26′ are removed from opposite sides, i.e., the second sub-mold 25′ is removed from the left (arrow direction) and the third sub-mold 26′ is removed from the right (arrow direction), to expose the second reflective surface 430′ of the main body 40′.

It can be understood that compared with existing methods such as molding, this solution uses an injection molding method to prepare the near-eye display module. Since the display element is pre-fixed and placed into the injection mold during the injection process, after the molten main body material is injected into the injection cavity and cured, simply performing a vertical demolding when removing the injection mold could easily damage the main body. Therefore, the design in this embodiment allows for removing the mold from above, left, and right sides separately, enabling smooth demolding and exposing the main body.

Step S35: cutting the connected plurality of main bodies.

In some embodiments, after removing the injection mold, adjacent two main bodies are cut along the runner to separate them into individual main bodies. The cutting method includes, but is not limited to, mechanical cutting methods and laser cutting methods.

Step S36: polishing the main body to remove residual material from the surface.

In some embodiments, the polishing method can be mechanical polishing, wet polishing, dry polishing, etc.

Step S37: performing mirror surface evaporation coating on the main body.

In some embodiments, step S37 may specifically be: performing evaporation coating on the first reflective surface of the main body to form a first mirror surface; and performing evaporation coating on the second reflective surface of the main body to form a second mirror surface.

In some embodiments, a metal mask is used to shield areas other than the first reflective surface 410′, so that a layer of metal or alloy is evaporated on the first reflective surface 410′ to form the first mirror surface 510′. This metal can be aluminum, silver, or a mixture of aluminum and silver, etc. For evaporating a layer of metal or alloy on the second reflective surface 430′ to form the second mirror surface 530′, the same method as above can be used, or other coating methods such as sputter coating, ion plating can be used. When evaporating a layer of metal on the second reflective surface 430′ to form the second mirror surface 530′, the metal evaporation direction can be rotated, or the main body can be rotated while keeping the evaporation direction fixed. It should be noted that when forming the first mirror surface 510′ and the second mirror surface 530′, there is no fixed order for forming the mirror surfaces. Furthermore, the metal used to form the mirror surfaces can be the same material for the first mirror surface 510′ and the second mirror surface 530′, or they can be different materials.

Step S38: encapsulating the evaporated main body.

In some embodiments, step S38 may specifically be: forming an encapsulation layer on the side surface and the bottom surface of the main body; forming an optical protective layer on the top surface of the main body. In some embodiments, a conductive structure is provided in the through hole of the evaporated main body 40′ to electrically connect the display element 30′ through the conductive structure, and then encapsulation is performed. In some embodiments, the main body 40′ includes a side surface 440′, a bottom surface 450′, and a top surface 460′. The side surface 440′ includes a second mirror surface 530′. The top surface 460′ includes a first mirror surface 510′ and the light exit surface 411′. The bottom surface 450′ includes a through hole 470′. The through hole 470′ can be formed corresponding to the positioning posts 2210 provided on the first injection surface 220′. For example, the positions of the positioning posts 2210 are not filled by the molten main body material. After removing the mold 20′, the positions corresponding to the positioning posts 2210 form the through hole 470′. A conductive structure 480′ is provided in the through hole 470′ to electrically connect the display element 30′ through the conductive structure, in some embodiments. Then, an encapsulation layer 70′ is formed on the side surface 440′ and the bottom surface 450′ of the main body 40′. An optical protective layer 8′ is formed on the top surface 460′ of the main body. The material for forming the encapsulation layer 70′ includes, but is not limited to, black epoxy resin, black silicone rubber, carbon black, nickel black, black chrome, and Vantablack. It should be noted that the material used for encapsulation must not cover the light exit surface 411′. The optical protective layer 8′ can be a light-transmitting material, which may not alter the original light propagation path, can protect the light exit surface 411′ and the first mirror surface 510′, reduce wear and tear, and also prevent dust and other debris from entering and affecting the optical efficiency.

In some embodiments, the through hole 470′, i.e., the through hole formed corresponding to the positioning posts 2210 provided on the first injection surface 220′, is filled, for example, with a post of the same shape, or covered with a cover plate. Then, the main body 40′ is encapsulated. In some embodiments, a first encapsulation layer is formed on the side surface 440′ of the main body 40′, then a second encapsulation layer is formed on the bottom surface 450′ of the main body 40′, and finally an optical protective layer 8′ is formed on the top surface 460′ of the main body. After encapsulation is completed, the filling material or cover is removed to expose the through hole 470′, so that the backplane 310′ can be electrically connected through the metal conductive structure 480′ in the through hole. In another embodiment, the demolded main body 40′ can be subjected to evaporation coating first, then cut, the cut main body 40′ polished, and finally encapsulated.

As shown in FIG. 60, FIG. 60 is a schematic structural diagram of an embodiment of a near-eye display module provided by the present application. The near-eye display module 100′ is a near-eye display module 100′ prepared by the above preparation method. In some embodiments, the overall length, width, and height dimensions of the near-eye display module 100′ may each be no greater than 2 mm. In some embodiments, light emitted by the micro-display screen 320′ in the near-eye display module 100′ enters the main body 40′ from the light incident surface 420′, is sequentially reflected by the first reflective surface 410′ provided with the first mirror surface 510′ and the second reflective surface 430′ provided with the second mirror surface 530′, and then exits through the light exit surface 411′.

In some embodiments, the near-eye display module 100′ can be disposed on a lens or frame of a near-eye display device (e.g., glasses, goggles, helmet, virtual reality device, mixed reality device, etc.). Of course, such near-eye display devices may also include some eye-tracking sensors to track and determine the direction of the eyes. In some embodiments, the entire near-eye display module 100′ can be cylindrical or prismatic, etc.

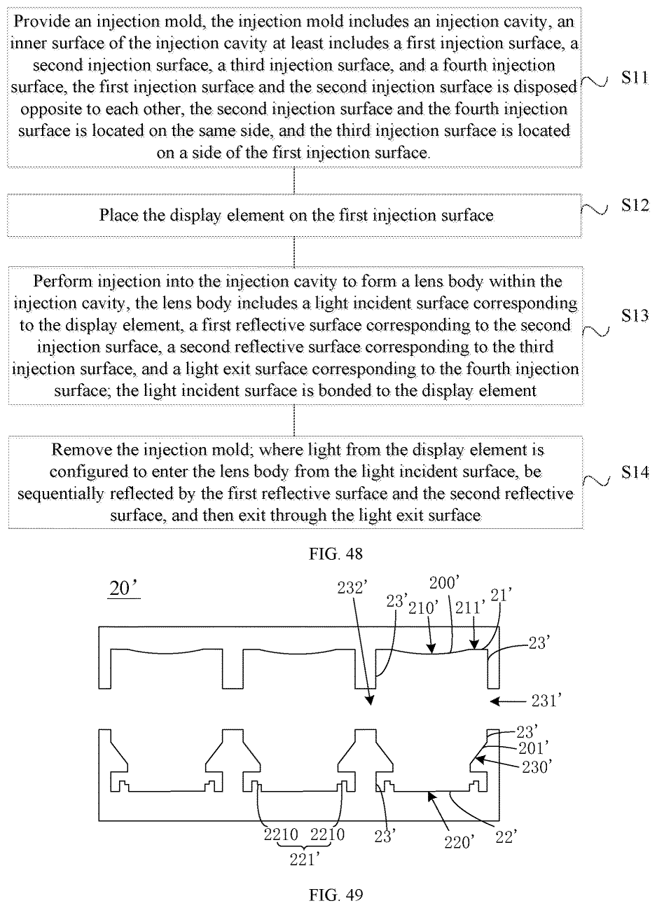

In some embodiments, the injection mold 20′ includes an injection cavity, an inner surface of the injection cavity at least including a first injection surface 220′, a second injection surface 210′, a third injection surface 230′, and a fourth injection surface 211′. The first injection surface 220′ and the second injection surface 210′ are disposed opposite to each other. The first injection surface 220′ is configured to have a display element 30′ placed thereon. The second injection surface 210′ and the fourth injection surface 211′ are located on the same side. The third injection surface 230′ is located on a side of the first injection surface 220′. The injection cavity is configured to receive an injection material to form a main body 40′. The main body 40′ includes a light incident surface 420′ corresponding to the display element 30′, a first reflective surface 410′ corresponding to the second injection surface 210′, a second reflective surface 430′ corresponding to the third injection surface 230′, and a light exit surface 411′ corresponding to the fourth injection surface 211′. The light incident surface 420′ is bonded to the display element 30′. Light from the display element 30′ is configured to enter the main body 40′ from the light incident surface 420′, be sequentially reflected by the first reflective surface 410′ and the second reflective surface 430′, and then exit through the light exit surface 411′. The injection mold 20′ includes a top wall 21′, a bottom wall 22′, and a side wall 23′. The first injection surface 220′ is located on the bottom wall 22′. The second injection surface 210′ and the fourth injection surface 211′ are located on the top wall 21′. The third injection surface 230′ is located on the side wall 23′. The first injection surface 220′ is provided with a positioning mechanism 221′. The transverse dimension of the second injection surface 210′ may be greater than or equal to the transverse dimension of the first injection surface 220′. The first injection surface 220′ and the second injection surface 210′ may be center-aligned. The maximum transverse dimension of the third injection surface 230′ may be equal to the transverse dimension of the fourth injection surface 211′. Of course, if it is not limited to being cylindrical, the maximum transverse dimension of the third injection surface 230′ and the transverse dimension of the fourth injection surface 211′ may also have other size relationships. The top wall 21′ protrudes toward the first injection surface 220′ to form a first protrusion 200′. At least a portion of the surface of the first protrusion 200′ forms the second injection surface 210′. The second injection surface 210′ includes any one of an inclined surface, a spherical surface, an aspherical surface, or a free-form surface. The fourth injection surface 211′ is arranged surrounding the contour of the first protrusion 200′. The side wall 23′ protrudes laterally to form a second protrusion 201′. At least a portion of the surface of the second protrusion 201′ forms the third injection surface 230′. The third injection surface 230′ is non-parallel to the fourth injection surface 211′. The third injection surface 230′ faces the second injection surface 210′ and the fourth injection surface 211′. The third injection surface 230′ includes any one of an inclined surface, a spherical surface, an aspherical surface, or a free-form surface. The positioning mechanism 221′ includes positioning posts 2210 and/or positioning holes. The positioning posts 2210 and/or positioning holes are provided with step portions. The display element 30′ is placed between the step portions to pre-fix the display element 30′. The number of positioning mechanisms 221′ is at least two. The lateral distance between the side surfaces of the step portions of two adjacent positioning posts 2210 is less than or equal to the minimum lateral distance between the third injection surfaces 230′. The vertical height of the positioning posts 2210 is lower than the third injection surface 230′. There is a gap between the positioning posts 2210 and/or positioning holes and the side wall 23′. The side wall 23′ is provided on opposite sides with an inlet runner 231′ and an outlet runner 232′ communicating the exterior with the injection cavity, for performing injection into the injection cavity. The vertical heights of the inlet runner 231′ and the outlet runner 232′ are not flush with the third injection surface 230′. The position of the inlet runner 231′ is horizontally flush with the position of the outlet runner 232′, as shown in FIG. 48. This can be beneficial for the formation of a reference surface for the injection molding, cooling, and solidification of the second reflective surface 430′ at the position corresponding to the non-vertical third injection surface 230′.

In other embodiments, the inlet runner 231′ may also be provided on the top wall 21′ and/or the bottom wall 22′, and the outlet runner 232′ may correspondingly be provided on the top wall 21′ and/or the bottom wall 22′. For example, the top wall 21′ is provided with the inlet runner 231′, and the bottom wall 22′ is provided with the outlet runner 232′. The number of inlet runners 231′ and outlet runners 232′ can be selected according to the actual injection array size, as long as uniform injection can be achieved. In some embodiments, the injection cavity includes a plurality arranged in an array. The inlet runner 231′ of a centrally located injection cavity communicates with the outlet runner 232 of an adjacent injection cavity. It can be understood that in two adjacent injection cavities, the inlet runner 231′ of one injection cavity communicates with the outlet runner 232′ of the other injection cavity. Here, the outlet runner 232′ can be relative to the inlet runner 231′ within a single array. In some embodiments, the outlet runner 232′ can be the inlet runner 231′ of another adjacent cavity.

An embodiment of the present application provides a method for manufacturing a near-eye display module including: providing an injection mold, the injection mold including an injection cavity, an inner surface of the injection cavity at least including a first injection surface, a second injection surface, a third injection surface, and a fourth injection surface, the first injection surface and the second injection surface being disposed opposite to each other, the second injection surface and the fourth injection surface being located on the same side, and the third injection surface being located on a side of the first injection surface; placing a display element on the first injection surface; performing injection into the injection cavity to form a lens body within the injection cavity, the lens body including a light incident surface corresponding to the display element, a first reflective surface corresponding to the second injection surface, a second reflective surface corresponding to the third injection surface, and a light exit surface corresponding to the fourth injection surface; the light incident surface being bonded to the display element; removing the injection mold; where light from the display element is configured to enter the lens body from the light incident surface, be sequentially reflected by the first reflective surface and the second reflective surface, and then exit through the light exit surface. The injection mold includes a top wall, a bottom wall, and a side wall. The first injection surface is located on the bottom wall, the second injection surface and the fourth injection surface are located on the top wall, the third injection surface is located on the side wall, the first injection surface is provided with a positioning mechanism, and the display element is disposed on the positioning mechanism. A transverse dimension of the second injection surface is greater than or equal to a transverse dimension of the first injection surface, and the first injection surface and the second injection surface are center-aligned. A maximum transverse dimension of the third injection surface is equal to a transverse dimension of the fourth injection surface. The injection mold further includes a detachable first sub-mold, a second sub-mold, and a third sub-mold. The second injection surface and the fourth injection surface are located on the first sub-mold. The first injection surface is located on the second sub-mold and the third sub-mold. The third injection surface is located on the second sub-mold and the third sub-mold. The second sub-mold and the third sub-mold are symmetrical. The second injection surface and the third injection surface include any one of an inclined surface, a spherical surface, an aspherical surface, or a free-form surface. The fourth injection surface is disposed on a periphery of the second injection surface, and the fourth injection surface is parallel to the first injection surface. The top wall protrudes toward the first injection surface to form a first protrusion, at least a portion of a surface of the first protrusion forming the second injection surface, and the fourth injection surface is arranged surrounding a contour of the first protrusion. The side wall protrudes laterally to form a second protrusion, at least a portion of a surface of the second protrusion forming the third injection surface, the third injection surface being non-parallel to the fourth injection surface, and the third injection surface facing the second injection surface and the fourth injection surface. The positioning mechanism includes positioning posts and/or positioning holes. The positioning posts and/or positioning holes are provided with step portions. The display element is placed between the step portions to pre-fix the display element. The number of positioning mechanisms is at least two. A lateral distance between side surfaces of the step portions of adjacent positioning posts and/or positioning holes is less than or equal to a minimum lateral distance between the third injection surfaces. A vertical height of the positioning posts is lower than the third injection surface. There is a gap between the positioning posts and/or positioning holes and the side wall.

The side wall, the top wall, and/or the bottom wall are provided with an inlet runner and an outlet runner for performing injection into the injection cavity. The vertical heights of the inlet runner and the outlet runner are not flush with the third injection surface. The side wall is provided with the inlet runner and the outlet runner, and a position of the inlet runner is horizontally flush with a position of the outlet runner. The injection cavity includes a plurality arranged in an array, and an inlet runner of a centrally located injection cavity communicates with an outlet runner of an adjacent injection cavity. After removing the injection mold, the method further includes: cutting the connected plurality of lens bodies; polishing the lens bodies to remove residual material from surfaces of the lens bodies. After removing the injection mold, the method further includes: performing mirror surface evaporation coating on the lens bodies; and encapsulating the evaporated lens bodies.

Performing mirror surface evaporation coating on the lens bodies includes: performing evaporation coating on the first reflective surface of the lens bodies to form a first mirror surface; and performing evaporation coating on the second reflective surface of the lens bodies to form a second mirror surface. Encapsulating the evaporated lens bodies includes: forming an encapsulation layer on side surfaces of the lens bodies; and forming an optical protective layer on top surfaces of the lens bodies. The lens bodies further include through holes, the through holes being formed corresponding to the positioning posts provided on the first injection surface, and the method further includes: providing a conductive structure in the through holes, so that the display element is electrically connected via the conductive structure.

The present application provides an injection mold, where the injection mold includes an injection cavity, an inner surface of the injection cavity at least including a first injection surface, a second injection surface, a third injection surface, and a fourth injection surface; the first injection surface and the second injection surface are disposed opposite to each other, the first injection surface being configured to have a display element placed thereon; the second injection surface and the fourth injection surface are located on the same side; the third injection surface is located on a side of the first injection surface; the injection cavity is configured to receive an injection material to form a lens body, where the lens body includes a light incident surface corresponding to the display element, a first reflective surface corresponding to the second injection surface, a second reflective surface corresponding to the third injection surface, and a light exit surface corresponding to the fourth injection surface; the light incident surface is bonded to the display element, and light from the display element is configured to enter the lens body from the light incident surface, be sequentially reflected by the first reflective surface and the second reflective surface, and then exit through the light exit surface.

The injection mold includes a top wall, a bottom wall, and a side wall. The first injection surface is located on the bottom wall. The second injection surface and the fourth injection surface are located on the top wall. The third injection surface is located on the side wall. The first injection surface is provided with a positioning mechanism, and the display element is disposed on the positioning mechanism. A transverse dimension of the second injection surface is greater than or equal to a transverse dimension of the first injection surface. The first injection surface and the second injection surface are center-aligned. A maximum transverse dimension of the third injection surface is equal to a transverse dimension of the fourth injection surface. The injection mold further includes a detachable first sub-mold, a second sub-mold, and a third sub-mold. The second injection surface and the fourth injection surface are located on the first sub-mold. The first injection surface is located on the second sub-mold and the third sub-mold. The third injection surface is located on the second sub-mold and the third sub-mold. The second sub-mold and the third sub-mold are symmetrical. The second injection surface and the third injection surface include any one of an inclined surface, a spherical surface, an aspherical surface, or a free-form surface. The fourth injection surface is disposed on a periphery of the second injection surface, and the fourth injection surface is parallel to the first injection surface. The top wall protrudes toward the first injection surface to form a first protrusion, at least a portion of a surface of the first protrusion forming the second injection surface, and the fourth injection surface is arranged surrounding a contour of the first protrusion. The side wall protrudes laterally to form a second protrusion, at least a portion of a surface of the second protrusion forming the third injection surface, the third injection surface being non-parallel to the fourth injection surface, and the third injection surface facing the second injection surface and the fourth injection surface. The positioning mechanism includes positioning posts and/or positioning holes. The positioning posts and/or positioning holes are provided with step portions. The display element is placed between the step portions to pre-fix the display element. The number of positioning mechanisms is at least two. A lateral distance between side surfaces of the step portions of adjacent positioning posts and/or positioning holes is less than or equal to a minimum lateral distance between the third injection surfaces. A vertical height of the positioning posts is lower than the third injection surface. There is a gap between the positioning posts and/or positioning holes and the side wall. The side wall, the top wall, and/or the bottom wall are provided with an inlet runner and an outlet runner for performing injection into the injection cavity. The vertical heights of the inlet runner and the outlet runner are not flush with the third injection surface. The side wall is provided with the inlet runner and the outlet runner, and a position of the inlet runner is horizontally flush with a position of the outlet runner. The injection cavity includes a plurality arranged in an array, and an inlet runner of a centrally located injection cavity communicates with an outlet runner of an adjacent injection cavity.

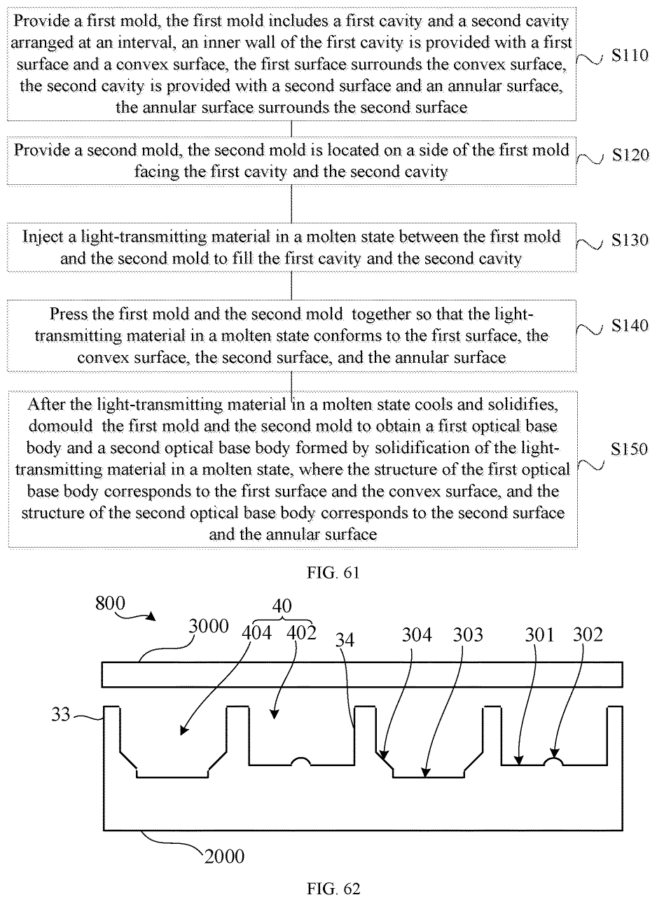

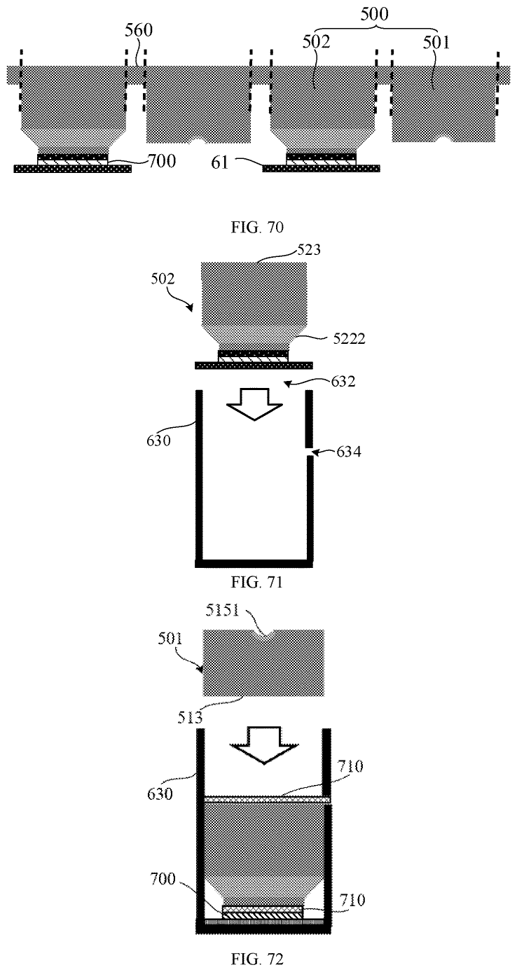

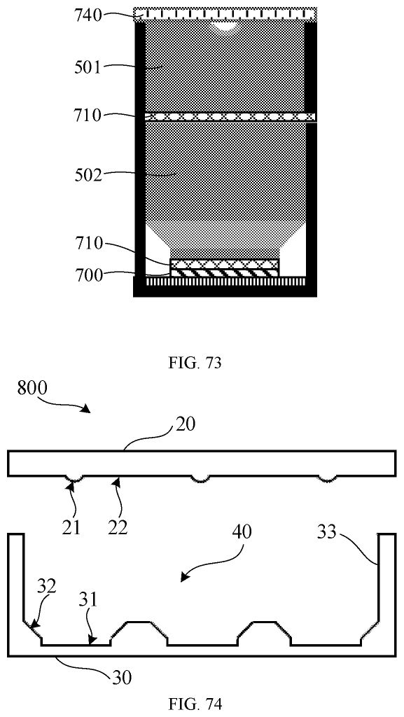

In some embodiments, as shown in FIGS. 61-73, the present application also provides a method for manufacturing a near-eye display module, where the method includes:

S110, providing a first mold 2000, the first mold 2000 including a first cavity 402 and a second cavity 404 arranged at an interval, an inner wall of the first cavity 402 being provided with a first surface 301 and a convex surface 302, the first surface 301 surrounding the convex surface 302, the second cavity 404 being provided with a second surface 303 and an annular surface 304, the annular surface 304 surrounding the second surface 303. In some embodiments, the cavity may further include a sidewall 33 connected to the annular surface 304, and the sidewalls 33 may be parallel to each other. The first surface 301 and the second surface 303 may be planes, and the convex surface 302 and the annular surface 304 may be spherical surfaces, aspherical surfaces, or free-form surfaces, etc. The first surface 301, the second surface 303, the convex surface 302, and the annular surface 304 may be designed by the same function, for example, generated using Zernike polynomials. In some embodiments, the second surface 303 and the convex surface 302 may be the same type of surface, and they may have the same outer contour shape, such as polygonal, circular, or elliptical, etc., for example, designed by the same function. In other embodiments, the first surface 301 and the convex surface 302 are the same continuous surface, and the second surface 303 and the annular surface 304 are the same continuous surface. For this part, reference can be made to the relevant descriptions in the above embodiments.

In some embodiments, the first mold 2000 provided includes at least one set of the first cavity 402 and the second cavity 404 arranged at an interval. They may also be arranged in a line or in an array, etc. The transverse dimensions of the first cavity 402 and the second cavity 404 may all be the same. The first cavities 402 may be multiple consecutively distributed, and the second cavities 404 may also be multiple consecutively distributed, with the first cavity 402 and the second cavity 404 arranged at intervals in between. In some embodiments, the first cavity 402 and the second cavity 404 may also be alternately arranged at intervals. In other embodiments, the first cavity 402 and the second cavity 404 may also be arranged in other regular patterns, but at least a portion of the first cavity 402 and the second cavity 404 are arranged at intervals. In some embodiments, the transverse dimensions of the first cavity 402 and the second cavity 404 may be the same. In other embodiments, at least one set of the first cavity 402 and the second cavity 404 having the same transverse dimension exists, while the transverse dimensions of other sets of the first cavity 402 and the second cavity 404 may be different. For example, taking an array arrangement, the transverse dimensions of the first cavities 402 and the second cavities 404 alternately arranged in the first row may be the same, possibly having a transverse dimension A, and the transverse dimensions of the first cavities 402 and the second cavities 404 alternately arranged in the second row may be the same, having a transverse dimension B, where A and B are different. This allows for batch production of multiple same or different sizes. The transverse dimensions of the first cavity 402 and the second cavity 404 being the same can be understood as the transverse (e.g., maximum transverse) dimension of the annular surface 304 being equal to the transverse dimension of the first surface 301. The first cavity 402 and the second cavity 404 having the same transverse dimension can be combined during subsequent injection molding to form a complete optical base body 501. In some embodiments, the transverse dimension of the convex surface 302 is greater than or equal to the transverse dimension of the second surface 303. In other embodiments, the first surface 301 and the second surface 303 are parallel to each other, or the first surface 301 and the second surface 303 are collinear with each other.

S120, providing a second mold 3000, the second mold 3000 being located on a side of the first mold 2000 facing the first cavity 402 and the second cavity 404.

The second mold 3000 may be an integral flat plate, or it may also be provided with corresponding cavities. The second mold 3000 may be movable relative to the first mold 2000, for example, they can be pressed together.

S130, injecting a light-transmitting material in a molten state between the first mold 2000 and the second mold 3000 to fill the first cavity 402 and the second cavity 404.

An injection hole may be provided on one or both of the first mold 2000 and the second mold 3000, and the light-transmitting material in a molten state is injected through the injection hole. In other embodiments, there may be a gap between the first mold 2000 and the second mold 3000, and injection can also be performed through the gap. The light-transmitting material in a molten state can be a transparent molten material, for example, it can be any one of polymethyl methacrylate, polycarbonate, plastic, resin, or glass.

S140, pressing the first mold 2000 and the second mold 3000 together so that the light-transmitting material in a molten state conforms to the first surface 301, the convex surface 302, the second surface 303, and the annular surface 304;

A clamp or the like can be used to hold the first mold 2000 and the second mold 3000. One of them can be positioned and fixed, and the other can be pressed toward the fixed one. For example, the first mold 2000 having the first cavity 402 and the second cavity 404 can be fixed, and the second mold 3000 can be pressed toward the first mold 2000 using a pressure mechanism. In some embodiments, both molds can be controlled to move toward each other simultaneously for pressing. Pressing ensures that the molten material fully conforms to the first surface 22, the convex surface 21, the second surface 31, and the annular surface 32. This process may allow excess molten material to overflow. It can be understood that the pressing process should ensure that the molten material fully conforms to the first surface 22, the convex surface 21, the second surface 31, and the annular surface 32, and also needs to control the height of the resulting optical base body to meet the preset size. After pressing the first mold 2000 and the second mold 3000 together, the first cavity 402 and the second cavity 404 may be independent cavities, i.e., the cavities are not connected to each other. The subsequently molded optical base bodies will be independent of each other and not connected into a whole. This allows for subsequent transfer using a suction cup, etc., facilitating flexible acquisition of the desired optical base bodies. In other embodiments, the first cavity 402 and the second cavity 404 may be interconnected cavities, i.e., the cavities can be connected to each other. The subsequently molded optical base bodies will be connected and formed as a whole, facilitating batch transfer and processing.

S150, after the light-transmitting material in a molten state cools and solidifies, demolding the first mold 2000 and the second mold 3000 to obtain a first optical base body 501 and a second optical base body 502 formed by solidification of the light-transmitting material in a molten state, where the structure of the first optical base body 501 corresponds to the first surface 301 and the convex surface 302, and the structure of the second optical base body 502 corresponds to the second surface 303 and the annular surface 304.

It can be understood that after the light-transmitting material in a molten state has fully cooled, a clamp or the like can be used to hold the molds and separate them. The demolded product can be a whole array with the first optical base body 501 and the second optical base body 502 connected together, or the first optical base body 501 and the second optical base body 502 may be independent of each other. In other embodiments, the first optical base body 501 and the second optical base body 502 having the same transverse dimension may be a whole, while those with different transverse dimensions constitute different array wholes. The specific configuration can be designed according to actual conditions.

It can be understood that the above method of the present application does not require cutting the main body material, reducing raw material loss and greatly lowering production costs. By simultaneously designing multiple different surfaces, such as the first surface 301 and the convex surface 302, the second surface 303 and the annular surface 304, on one mold, and then injecting the molten material to conform to the corresponding designed surfaces, the number of molds to be developed is effectively reduced. Since the first surface 301 and the convex surface 302, and the second surface 303 and the annular surface 304 are all on the same side, the molded first optical base body 501 and second optical base body 502 can also be on the same side. Thus, in subsequent steps (e.g., coating), processing can be performed at one time without separately processing the two separate surfaces, effectively reducing processing steps and greatly lowering production costs. In some embodiments, before demolding the first mold 2000 and the second mold 3000, it also includes determining whether the temperature of the injected light-transmitting material in a molten state has dropped below the corresponding solidification point. If yes, demolding can proceed; if not, cooling must continue, for example, using air cooling, water cooling, or natural heat dissipation.

In some embodiments, as shown in FIGS. 62-65, the first cavity 402 and the second cavity 404 of the first mold 2000 have the same transverse dimension. It can be understood that all first cavities 402 and second cavities 404 have the same transverse dimension, ensuring that all first optical base bodies 501 and second optical base bodies 502 can form a regular whole in subsequent processing, without introducing other processing steps like cutting or grinding, thus reducing costs. In other embodiments, at least one set of the first cavity 402 and the second cavity 404 has the same transverse dimension, while the transverse dimensions of the first cavity 402 and the second cavity 404 in different sets may be different, thereby producing optical base bodies of different sizes in batches.

A first end of the first optical base body 501 includes a first wall 512 and a concave wall 515 lower than the first wall 512, the first wall 512 surrounding the concave wall 515. The first optical base body 501 further includes a first pressing wall 513 opposite the first end. The first pressing wall 513 can be a wall formed by pressing with the second mold 3000. A first end of the second optical base body 502 includes a second wall 521 and an annular wall 522. A second end of the second optical base body 502 opposite the first end includes a second pressing wall 523. The second pressing wall 523 can be a wall formed by pressing with the second mold 3000. The shapes of the second pressing wall 523 and the first pressing wall 513 can be the same or complementary. For example, the second pressing wall 523 and the first pressing wall 513 can both be flat walls.

The shape of the first surface 301 is the same as the shape of the first wall 512. The shape of the annular wall 522 is complementary to the shape of the annular surface 304. The shape of the second surface 303 is the same as the shape of the second wall 523. The shape of the concave wall 515 is complementary to the shape of the convex surface 302. Complementary here means that after bonding, they still form an integral body without obvious gaps. For example, if one is concave and the other is convex, after complementary bonding, they still form an integral body. The first pressing wall 513 and the second pressing wall 523 may have the same or different heights, and their shapes should be complementary and fit together to form an integral body, for example, without gaps. In other embodiments, one of the second pressing wall 523 and the first pressing wall 513 has one or more protrusions, and the other has corresponding one or more grooves. After complementary bonding, they also form an integral body without obvious gaps. In some embodiments, if one of the second pressing wall 523 and the first pressing wall 513 is an upward inclined surface, the other is a downward inclined surface. After complementary bonding, they also form an integral body. After the above complementary bonding, optical glue can be further added, or techniques like laser fusion can be used.

In some embodiments, the first wall 512 can be a plane, and the concave wall 515 can be a spherical surface, an aspherical surface, or a free-form surface, etc., the two being two different types of surfaces. In other embodiments, the first wall 512 can be a spherical surface, an aspherical surface, or a free-form surface, etc., and the concave wall 515 can be a spherical surface, an aspherical surface, or a free-form surface, etc. The first wall 512 and the concave wall 515 may together form a continuous surface. The first wall 512 and the concave wall 515 can be designed by the same function in optical design, for example, generated using Zernike polynomials.

In some embodiments, the second wall 521 and the annular wall 522 can be planes. The second wall 521 and the annular wall 522 can also be spherical surfaces, aspherical surfaces, or free-form surfaces, etc. The second wall 521 and the annular wall 522 can be two different types of surfaces, respectively. In other embodiments, the second wall 521 and the annular wall 522 together form a continuous surface. The second surface 31 and the annular surface 32 can be designed by the same function in optical design, for example, generated using Zernike polynomials. In some embodiments, the first wall 512 can be a plane, or it can be one of a spherical surface, an aspherical surface, or a free-form surface. The concave wall 515 can be one of a spherical surface, an aspherical surface, or a free-form surface. The outline shapes of the concave wall 515 and the first wall 512 can be the same, for example, polygonal, circular, or elliptical, etc. The first wall 512 and the concave wall 515 can be the same continuous surface, for example, designed by the same function, such as generated using Zernike polynomials. In other embodiments, the first wall 512, the concave wall 515, the second wall 521, and the annular wall 522 can all be a continuous surface designed by the same function, for example, generated using Zernike polynomials.

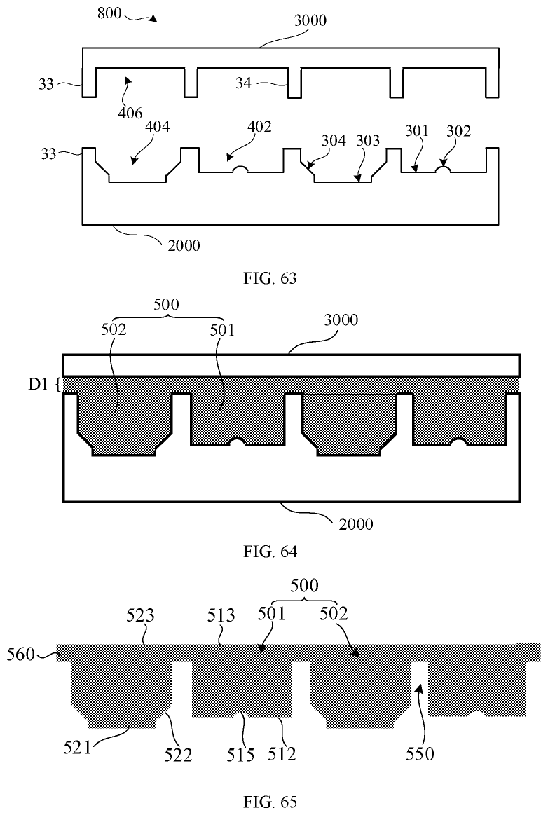

In some embodiments, as shown in FIG. 63, the second mold 3000 is further provided with a plurality of third cavities 406. Each third cavity 406 has the same transverse dimension and is coaxial with the first cavity 402 and the second cavity 404. It can be understood that providing the third cavities 406 on the corresponding second mold 3000, in some embodiments, the third cavities 406 may also be provided with sidewalls 33, which can reduce the depth of the first cavity 402 and the second cavity 404 in a single mold, ensuring that the pressure during material injection is relatively low, which is beneficial for the light-transmitting material in a molten state to fully conform to the first surface 301, the convex surface 302, the second surface 303, and the annular surface 304.

In some embodiments, as shown in FIGS. 64-67, there is a gap D1 between the first mold 2000 and the second mold 3000, and the light-transmitting material in a molten state fills the gap to form a connecting layer 560. It can be understood that the gap D1 facilitates the molded first optical base body 501 and second optical base body 502 being connected into a whole through the connecting layer 560, which is beneficial for batch transfer, clamping, or processing. If the gap (or connecting layer 560) is too thick, subsequent cutting is difficult; if too thin, the overall structural stability is compromised. The thickness of the gap or connecting layer 560 can be between 100 and 500 micrometers, for example, 100 micrometers, 300 micrometers, 400 micrometers, or 500 micrometers, etc.

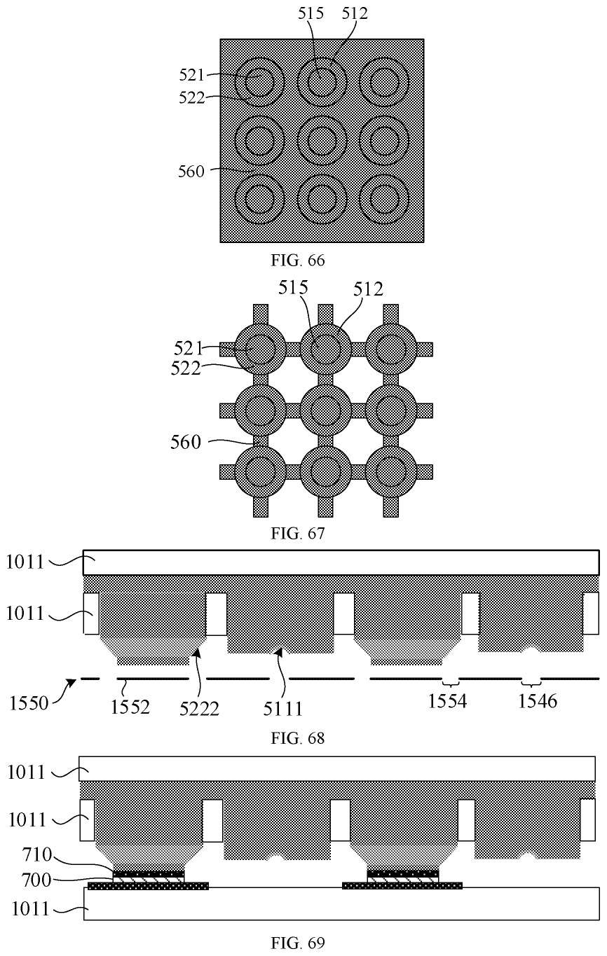

In some embodiments, as shown in FIGS. 66-67, the connecting layer 560 is fixed along the entire circumference of each optical base body, thereby making the entire array more stable. In some embodiments, the connecting layer 560 is arranged at intervals along the circumference of each optical base body, which can reduce the amount of injected light-transmitting material, lowering costs. In some embodiments, as shown in FIG. 68, after obtaining the array base body 500 formed by solidification of the light-transmitting material, it further includes depositing a reflective layer 5111 on the concave wall 515, depositing a reflective layer 5222 on the annular wall 522, to form the first reflection window 2 and the second reflection window 4, respectively.

The reflective layer 5111 and the reflective layer 5222 can be metal or metal alloys, such as silver, aluminum, aluminum-magnesium alloy, etc. For example, physical vapor deposition or chemical vapor deposition methods can be used, such as mask coating, sputter coating, or ion plating. Since the present application forms the concave wall 515 and the annular wall 522 on the same side of the mold, the reflective layer can be deposited on the concave wall 515 and the annular wall 522 at one time to form the first reflection window 2 and the second reflection window 4 described in the relevant embodiments of the optical module 10, thus eliminating the need to coat one side first, then turn the optical base body over and coat the other side, reducing the processing steps for coating and effectively saving manufacturing costs.

In some embodiments, as shown in FIG. 70, after depositing the reflective layer on the concave wall 515 and the annular wall 522, the method further includes:
mounting the micro-display 700 on the second wall 521 of each second optical base body 502, where the backplane 61 of the micro-display 700 may be located on the side away from the second wall 521, the micro-display 70 and the second wall 521 being in close contact, and the transverse dimension of the micro-display 70 being less than or equal to the transverse dimension of the second wall 521. In other embodiments, the mounting of the micro-display 700 can also be performed before coating.

The micro-display 700 can be referred to the relevant embodiments described above, and will not be repeated here. Optical glue or the like can be used to bond the micro-display 700 to the second wall 521. The thickness of the optical glue layer can be sufficiently small so as not to affect optical performance.

In some embodiments, as shown in FIG. 70, the manufacturing method further includes: cutting the array base body 500 in a direction perpendicular to the first wall 512. After cutting, the connecting structure between adjacent base bodies can be separated into individual base bodies 501, 502. It can be understood that cutting can be performed after demolding, after coating, or after mounting the micro-display 700. The cutting method can be mechanical or laser cutting, etc. Cutting can be performed along the gaps 550 between the first optical base body 501 and the second optical base body 502. These gaps are formed by the spaced-apart first cavities 402 and second cavities 404. During the injection process, molten material does not enter between the first cavity 402 and the second cavity 404, maintaining the gaps 550, thereby ensuring that the sidewalls of the first optical base body 501 and the second optical base body 502 are unaffected. Additionally, these gaps are beneficial for clamping or positioning by fixtures.

In some embodiments, as shown in FIG. 68, the method of the embodiment of the present application further includes: providing a baffle 1550, the baffle 1550 including a shielding area 1552, a first opening 1554, and a second opening 1556 arranged in line. The shielding area 1552 shields the first wall 512 and the second wall 521. For example, metal particles cannot pass through the shielding area 1552. The opening of the first opening 1554 corresponds to the width of the annular wall 522. The opening of the second opening 1556 corresponds to the width of the concave wall 515. The size of the second opening 1556 may be larger than the first opening 1554. A clamp 1011 or positioning member can be used to fix the base body, and the metal or metal alloy reflective layer is deposited on the annular wall 522 and the concave wall 51 through the first opening 1554 and the second opening 1556. It can be understood that the above method does not require making a separate baffle for the first wall 512 and the concave wall 511, and another baffle for the second wall 521 and the annular wall 522. Only one integral baffle (e.g., a mask) is needed to deposit the reflective layer on both the first wall 512 and the second wall 521, effectively reducing the cost of baffles and the steps for depositing the reflective layer, greatly reducing costs.

In some embodiments, as shown in FIGS. 71-73, the method of the embodiment of the present application further includes: providing an sleeve 630 for encapsulation. The sleeve 630 can be non-transmissive. The sleeve 630 is provided with a first opening 632 and a second opening 634. The sleeve 630 can be made of black or other non-transmissive materials, or the outer wall of the sleeve 630 can be coated with a black material, such as black epoxy resin, black silicone rubber, carbon black, nickel black, black chrome, Vantablack, or other coatings or materials. The sleeve 630 can be cylindrical. The first opening 632 can be an end of the sleeve configured to receive the first optical base body 501 and the second optical base body 502. The size of the first opening 632 can be greater than or equal to the transverse dimensions of the first optical base body 501 and the second optical base body 502. The size of the second opening 634 is smaller than the first opening 632. The second opening 634 can be located in the middle of the sleeve 630. The second opening 634 can be one or a plurality spaced apart. When it is one, the second opening 634 should preferably not occupy the entire circumference of the sleeve 630 to ensure the mechanical support of the entire sleeve 630. In other embodiments, the sleeve 630 can be divided into an upper sleeve and a lower sleeve (not shown), in which case the second opening 634 is formed between the upper sleeve and the lower sleeve. In some embodiments, the sleeve 630 can be cylindrical. The sleeve 630 can also protect the internal first optical base body 501 and second optical base body 502. One of the first optical base body 501 and the second optical base body 502 is placed into the sleeve 630 along the first opening 632. The order of placement is related to the above-mentioned processes, such as coating and mounting the micro-display. If the coating is completed first and the micro-display 700 has not yet been mounted, either the first optical base body 501 or the second optical base body 502 can be placed into the sleeve 630. If the process of mounting the micro-display has been completed, the second optical base body 502 with the mounted micro-display 700 can also be placed into the sleeve firstly, and then the first optical base body 501 with the reflective layer is placed into the sleeve.

An optical adhesive layer 710 is coated on the second pressing wall 523 or the first pressing wall 513. The optical adhesive layer 710 can be as thin as possible without affecting the light transmission efficiency after bonding.

The other of the first optical base body 501 and the second optical base body 502 is placed into the sleeve 630 along the first opening 632, with the optical adhesive layer 710 adjacent to the second opening 634. “Adjacent” means that regardless of which of the first optical base body 501 and the second optical base body 502 is placed first, the entire sidewalls of the first optical base body 501 and the second optical base body 502 will not completely block the second opening 634. It can be understood that the end surfaces of the first optical base body 501 and the second optical base body 502 can communicate with the second opening 634 to facilitate the overflow of excess optical adhesive layer 710 through the second opening 634 when the optical adhesive layer 710 is subsequently added.

The second pressing wall 523, the optical adhesive layer 710, and the first pressing wall 513 are bonded together, with excess optical adhesive layer 710 overflowing through the second opening 634. This step further presses the first optical base body 501 and the second optical base body 502 together tightly, for example, reducing the presence of different transmission media layers such as air.

In some embodiments, the first optical base body 501 with the reflective layer coated can be placed into the sleeve 630 first, and then the first optical base body 501 and the second optical base body 502 can be bonded together using the optical adhesive layer 710. In some embodiments, the second optical base body 54 with the micro-display 700 mounted can be placed into the sleeve 630 first. At this time, the entire height of the second optical base body 54 may not be completely higher than the second opening 634. Then, the optical adhesive layer 710 is coated on the end surface of the second optical base body 54 away from the micro-display 700, or the optical adhesive layer 710 is coated on the end surface of the first optical base body 501 away from the first wall 512. In other embodiments, glue may also be coated on both to form the optical adhesive layer 710.

In some embodiments, the sleeve 630 further includes a wiring hole. The wiring hole may be located at a position of the sleeve 630 corresponding to the micro-display 700, for example, on the bottom wall or side wall of the sleeve 630. The wiring hole allows the electrical leads of the micro-display 700 to be connected to other electrical components, such as a driver board or a battery.

In some embodiments, the manufacturing method of the present application further includes: placing the second optical base body 502 with the micro-display 700 mounted along the first opening 632 into the sleeve 630, with at least a portion of the micro-display 700 exposed relative to the wiring hole, thereby ensuring that the micro-display 700 can be electrically connected to external electrical components, such as a control board or a battery. Coating the optical adhesive layer 710 on the second pressing wall 523 or the first pressing wall 513. Placing the first pressing wall 513 of the first optical base body 501 along the first opening 632 into the sleeve 630. Bonding the second pressing wall 523, the optical adhesive layer 710, and the first pressing wall 513 together, with excess optical adhesive layer 710 overflowing through the second opening 634.

It can be understood that the sleeve 630 can encapsulate the first optical base body 501 and the second optical base body 502, and can also encapsulate the micro-display 700 together, making the whole a relatively complete module, which is conducive to subsequent applications, such as transfer, assembly with other devices (e.g., glasses, head-mounted devices), etc.

In some embodiments, as shown in FIG. 63, the method of the embodiment of the present application further includes:

Providing a light-transmitting layer 740. The light-transmitting layer 740 can be placed on the sleeve 630. The light-transmitting layer 740 can be made of PMMA (polymethyl methacrylate), PC (polycarbonate) plastic, resin glass, etc. The light-transmitting layer 740 is placed covering the first wall 512 and the concave wall 515, and the size of the light-transmitting layer 740 is greater than or equal to the size of the first wall 52. The light-transmitting layer 740 may not alter the original light propagation path, can protect the first wall 512 and the concave wall 515, reduce wear and tear, and also prevent dust and other debris from entering and affecting the optical efficiency. In some embodiments, the size of the light-transmitting layer 740 can be the same as the size enclosed by the non-transmissive encapsulation material 90, so that the overall structure is more regular, facilitating subsequent assembly. In some embodiments, the micro-display 700 may also include a backplane and other components, and the backplane can be connected to related electrical components by wires or flexible flat cables through the wiring holes in the above embodiment.

The present application also provides an embodiment of a near-eye display module manufactured by the above manufacturing method. The near-eye display module as a whole can be cylindrical or prismatic. The overall size can be from 0.5 cubic millimeters to 5 cubic centimeters, for example, 0.5 cubic millimeters, 1 cubic millimeter, 8 cubic millimeters, 1 cubic centimeter, 2 cubic centimeters, 5 cubic centimeters, etc. Its size is relatively small to the naked eye, making it easier to integrate into various other devices without affecting the original device's appearance or large-area structure. For example, the near-eye display module can be used in prescription glasses, reading glasses, sunglasses, goggles, smart glasses, or other head-mounted devices, etc., offering good adaptability.

The present application provides a method for manufacturing a near-eye display module, including: providing a first mold, the first mold including a first cavity and a second cavity arranged at an interval, an inner wall of the first cavity being provided with a first surface and a convex surface, the first surface surrounding the convex surface, the second cavity being provided with a second surface and an annular surface, the annular surface surrounding the second surface; providing a second mold, the second mold being located on a side of the first mold facing the first cavity and the second cavity; injecting a light-transmitting material in a molten state between the first mold and the second mold to fill the first cavity and the second cavity; pressing the first mold and the second mold together so that the light-transmitting material in a molten state conforms to the first surface, the convex surface, the second surface, and the annular surface; after the light-transmitting material in a molten state cools and solidifies, demolding the first mold and the second mold to obtain a first optical base body and a second optical base body formed by solidification of the light-transmitting material in a molten state, where the structure of the first optical base body corresponds to the first surface and the convex surface, and the structure of the second optical base body corresponds to the second surface and the annular surface.

The method for manufacturing a near-eye display module of the present application can have different planes arranged on the same side of the mold to form walls of different designs after injection molding. This allows for depositing the reflective layer at one time, reducing the number of molds and baffles for depositing the reflective layer, further reducing the steps of separately depositing the reflective layer on two different walls, and greatly reducing production and preparation costs.

As shown in FIGS. 35-37, 62-63, and 74, the present application also provides a mold for manufacturing an optical module. The mold includes a main body 800, which may be a combination of one or more molds. The main body 800 forms cavities 40, 402, 404, 406. The cavities 40, 402, 404, 406 may be a single integral cavity, or a combination of a plurality of small cavities arranged in an array. When there are multiple cavities 40, they may have uniform sizes, or they may have different sizes. In this case, they may be arranged in a regular size pattern, for example, sizes increasing or alternating along a certain direction. Corresponding to the position of the cavity 40, there are provided a first surface 22, 301 and a convex surface 21, 302. The convex surface 21 protrudes relative to the first surface 22. The convex surface 21 is provided at the center of the first surface 22. Corresponding to the position of the cavity 40, there are also provided a second surface 31, 303 and an annular surface 32, 304. The annular surface surrounds the second surface 31 and is non-coplanar with the second surface 31. It can be understood that the first surface 22 and the second surface 31 may be surfaces that appear flat or approximately flat to the naked eye. Their surfaces may also have a certain non-visible roughness. The above-mentioned “corresponding to the position of the cavity 40” can be understood as within a sealed cavity or a cavity with gaps, for example, a complete cavity formed after pressing the molds together. It can also be understood as a cavity with gaps formed after pressing two or three molds together. For example, in one embodiment including an upper mold and a lower mold, the upper mold is roughly a plate, and the lower mold is provided with a cavity. In this case, although the upper mold is not directly inside the cavity, it is part of the match process when the upper and lower molds are pressed together after injecting the light-transmitting material in a molten state. At this time, the area of the upper mold corresponding to the vertical projection of the cavity of the lower mold should also be understood as corresponding to the position of the cavity 40. That is, as long as the area of the mold that can be covered by the vertical projection of the cavity 40 can be understood as corresponding to the position of the cavity 40. It can be understood that even without injecting molten material, the area directly facing the cavity 40 but not on the inner wall or inside of the cavity 40 should also be understood as corresponding to the position of the cavity 40. The first mold 2000 and the first mold 20, the second mold 3000 and the second mold 30, the first surface 22 and the first surface 301, the convex surface 21 and the convex surface 302, the second surface 31 and the second surface 303, the annular surface 32 and the annular surface 304, and the cavities 40, 402, 404, 406, can be understood as the same. For convenience of description, the following description of the embodiments will only use one set of reference numerals. Different reference numerals in other drawings should be understood as the same without violating the overall technical concept.

In some embodiments, the size of the cavity 40 may be between 0.4 cubic millimeters and 4 cubic centimeters, for example, 0.4 cubic millimeters, 1 cubic millimeter, 8 cubic millimeters, 1 cubic centimeter, 2 cubic centimeters, 4 cubic centimeters, etc. The space is small, so the size of the final single base body 50 is relatively small to the naked eye, making it easier to integrate into various other devices, such as glasses or other head-mounted devices, without affecting the original device's appearance or large-area structure, offering good adaptability.

In some embodiments, the first surface 22 and the second surface 31 may be arranged in parallel or collinearly, for example, the first surface 22 and the second surface are on the same side with different height differences, i.e., parallel. If the height difference is the same, they are collinear. The first surface 22 and the second surface may be on the same side or on different sides. The first surface 22 and the convex surface 21 are a set at the first end, and the second surface 31 and the annular surface 32 are a set at the second end. The first end and the second end are parallel, or the first surface 22 and the convex surface 21, and the second surface 31 and the annular surface 32 are all at the same end.

In this case, they can be arranged in parallel. The convex surface 21 and the annular surface 32 include any one or a combination of an inclined surface, a spherical surface, an aspherical surface, or a free-form surface. The cavity 40 is configured to have a light-transmitting material in a molten state injected therein. The light-transmitting material in a molten state conforms to the first surface 22, the convex surface 21, the second surface 31, and the annular surface 32 and solidifies to form the optical module 10. The light-transmitting material in a molten state can be any one of polymethyl methacrylate, polycarbonate, plastic, resin, or glass. In some embodiments, it can be a transparent molten material.

In the present application, the molten material is injected into the cavity, allowing it to conform to the corresponding designed first surface 22, convex surface 21, second surface 31, and annular surface 32, and finally solidify. This eliminates the need for thicker light-transmitting or transparent materials as in cutting processes, reduces material loss during cutting, thus lowering costs, and also reduces the impact of cutting on optical surfaces. In some embodiments, the size of a single cavity 40 corresponding to the positions of the first surface 22, the convex surface 21, the second surface 31, and the annular surface 32 can be between 1 cubic millimeter and 3 cubic centimeters. That is, the size of the formed optical module 10 is small to the naked eye.

In some embodiments, as shown in FIGS. 35-37, 62-63, and 74, the cavity 40 may include a plurality arranged in a line or an array. The transverse dimension of the first surface 22 corresponding to each cavity 40 is equal to the transverse dimension of the annular surface 32. The transverse dimension of the convex surface 21 may be less than or equal to the transverse dimension of the second surface 31. In some embodiments, the cavity 40 may include a plurality arranged in a line or an array. The transverse dimension of the first surface 22 corresponding to each cavity 40 is equal to the transverse dimension of the annular surface 32 and gradually increases along a first direction. For example, in a plurality of cavities 40 arranged in a line or array, the size of each cavity 40 is uniform, but other numbers of cavities 40 have different sizes, such as increasing or decreasing from left to right, thereby allowing for the production of optical arrays of different sizes at one time, meeting different design requirements.

In some embodiments, as shown in FIGS. 35-37 and FIG. 74, the main body 800 includes a first mold 20. The first surface 22 and the convex surface 21 are provided on the first mold 20. A second mold 30 is spaced apart from the first mold 20 and configured to be pressed together with the first mold 20. The second surface 31 and the annular surface 32 are provided on the second mold 30. The first mold 20 and the second mold 30 are aligned, and the convex surface 21 and the second surface 31 correspond coaxially. A first sidewall 33 is provided around the first mold 20 and/or the second mold 30 to form the cavity 40. It can be understood that the first sidewall 33 may be provided only on one of the first mold 20 and the second mold 30, or on both molds. The first sidewall 33 may be integral with the first mold 20 and the second mold 30, or it may be a separate component. It can be understood that the first sidewall 33 is designed to surround and thus form a groove to accommodate the light-transmitting material in a molten state. As shown in FIG. 1, the formed cavity 40 is a single unit, but its corresponding positions still have corresponding designed surfaces. In this case, pressing the molds forms an integral optical module. As long as the positions of the designed surfaces are controlled in advance, and the demolded optical module array is cut at accurate preset positions during cutting, separation of individual optical modules can also be achieved.

In some embodiments, as shown in FIGS. 35-37, the mold main body 800 further includes a plurality of second sidewalls 34. The plurality of second sidewalls 34 may be part of the first mold 20, or part of the second mold 30. Of course, they may also be separate components disposed on the first mold 20 or the second mold 30. The height of the second sidewall 34 is the same as the height of the first sidewall 33. The second sidewall 34 is provided on the first mold 20 and/or the second mold 30 and located between the first sidewalls 33. The plurality of second sidewalls 34 are spaced apart to partition the cavity 40. It can be understood that the second sidewall 34 can block the light-transmitting material in a molten state from entering, so that after solidification, the molten material has gaps 17 (FIG. 10) between the cavities 40 arranged in an array. For example, the optical module array shown in FIG. 10 enables quick identification of separation positions, facilitating subsequent cutting of the optical module array. Additionally, these gaps 17 are beneficial for clamping or positioning by fixtures.

In some embodiments, as shown in FIGS. 35-39, after pressing the first mold 20 and the second mold 30 together, there is a gap D2 between the highest end surface of the first mold 20 and the highest end surface of the second mold 30. A cross-section perpendicular to the line connecting the gaps is not flush with the annular surface 32. The gap distance meets a preset value. The highest end surface can be considered the mold as a whole, i.e., the highest end surface formed by the overall shape. For example, in the following embodiments involving the first sidewall 33 and the second sidewall 34 located on the mold, they can be understood as the sidewalls and the mold being integral. The corresponding sidewall being the highest is the highest end surface. The gap D2 can be about 500 micrometers, so that the subsequently formed optical module array is an integral whole, facilitating subsequent processing, such as batch clamping, transfer, cutting, etc. It can be understood that, as shown in FIG. 38, after injecting the molten material into the first mold 20 and the second mold 30, there is a gap D1 between the first mold 20 and the second mold 30. To ensure that the material fully conforms to the designed surfaces, further pressure can be applied, for example, by further pressing the first mold 20 and the second mold 30 together, resulting in a smaller gap D2 between the first mold 20 and the second mold 30. At this time, excess molten material during the pressing process (from D1 to D2) can overflow from the gap D1 or D2. In some embodiments, since the annular surface 32 is on the outside of the second surface 31 and is not a regular vertical surface, to ensure that the annular surface 32 can still maintain the intended design of any one or combination of an inclined surface, spherical surface, aspherical surface, or free-form surface during the pressing process, i.e., to reduce the possibility of the annular surface 32 deforming due to being too close to the gap during overflow, it is necessary to ensure that the gap opening is as far away from the annular surface 32 as possible. That is, ensure that the cross-section perpendicular to the line connecting the gaps is not flush with the annular surface 32, for example, higher or lower than the position of gap D1 or D2, which is conducive to maintaining the reference surface formation of the annular surface. In some embodiments, the gap D2 may also be absent. In this case, the demolded optical module 10 exists as individual units rather than an array connected together. This facilitates personalized design in subsequent processes.

In some embodiments, as shown in FIG. 35, the second mold 30 is provided with a first sidewall 33 and a plurality of second sidewalls 34 to form a plurality of cavities 40. The second surface 31 and the annular surface 32 are located on the inner wall of the cavities 40. The first mold 20 is provided with the first surface 22 and the convex surface 21 in the area corresponding to the vertical projection of the cavities 40. It can be understood that the cavity 40 is formed only on the second mold 30. At this time, the distance from the end surfaces of the first sidewall 33 and the second sidewall 34 to the first surface 22 of the first mold 20 has a gap D2 after pressing. The distance between the first surface 22 and the second surface 31 is the thickness of the optical module. This way, only the height of the first sidewall 33 or the second sidewall 34 of one mold needs to be controlled, and then pressing is performed with the other mold containing the convex surface 21. Additionally, the position of the overflow gap is farthest from the annular surface 32, which is conducive to the formation of the reference surface of the annular surface 32. Since the first surface 22 is a flat surface, the impact of overflow during pressing on it is negligible.

In some embodiments, as shown in FIG. 37, the first mold 20 is provided with a first sidewall 33 and a plurality of second sidewalls 34 to form a plurality of cavities 40. The first surface 22 and the convex surface 21 are located on the inner wall of the cavities 40. The second mold 30 is provided with the second surface 31 and the annular surface 32 in the area corresponding to the vertical projection of the cavities 40. Different from the embodiment in FIG. 2 above, this embodiment reverses the order of the first sidewall 33 and the plurality of second sidewalls 34. By providing the sidewalls on the first mold 20, which only has the relatively simpler first surface 22 and convex surface 21, the workload of the mold design is simplified.

In some embodiments, as shown in FIG. 36, the first mold 20 is provided with a first sidewall 33 and a plurality of second sidewalls 34 to form a plurality of first cavities 40. The first surface 22 and the convex surface 21 are located on the inner wall of the first cavities 40. The second mold 30 is provided with a first sidewall 33 and a plurality of second sidewalls 34 to form a plurality of second cavities 40. The second surface 31 and the annular surface 32 are located on the inner wall of the second cavities 40. The first cavities 40 and the second cavities 40 are arranged one above the other to form the cavity 40. The first surface 22 and the convex surface 21, and the second surface 31 and the annular surface 32 are located on different mold sides. Different from the embodiments in FIGS. 35 and 37 above, this application provides the first sidewall 33 and the plurality of second sidewalls 34 on both the first mold 20 and the second mold 30 simultaneously. The first cavity 41 and the second cavity 42 may have the same height, thereby allowing the two molds to have the same height, which is beneficial for preliminary mold design. Additionally, the height relationship of the sidewalls on the first mold 20 and the second mold 30 can be flexibly designed, making the overall design more flexible. In some embodiments, the first cavity 41 and the second cavity 42 may also have different heights, as long as their combined height meets the thickness requirement of the preset optical module. Compared with providing the cavity on only one side, providing cavities on both sides can appropriately share the height required for designing the cavity in only one mold, which is beneficial for injecting the light-transmitting material in a molten state.

In some embodiments, as shown in FIGS. 62 and 63, the main body 800 includes a first mold 2000. A second mold 3000 is configured to be pressed together with the first mold 2000. The first mold 2000 is provided with cavities 40, where the cavities 40 include at least one third cavity 402 and a fourth cavity 404. For example, the third cavities 402 and the fourth cavities 404 are alternately arranged. Of course, a plurality of third cavities 402 may be arranged in sequence, and a plurality of fourth cavities 404 may be arranged in sequence in combination. The first surface 301 and the convex surface 302 are provided in the third cavity 402. The second surface 303 and the annular surface 304 are provided in the fourth cavity 404. The first surface 301, the convex surface 302, the second surface 303, and the annular surface 304 are all located on the same side of the first mold 2000. It can be understood that by injecting the molten material and then pressing the molds, the first surface 301 and the convex surface 302, and the second surface 303 and the annular surface 304 will simultaneously form walls of corresponding shapes. At this time, in subsequent processes, such as coating, operations can be performed together, reducing the operation steps for the optical module in subsequent processes, improving production efficiency, and reducing costs.

In some embodiments, as shown in FIG. 62, the first mold 2000 is provided with a first sidewall 33 and a plurality of second sidewalls 34 having the same height to form the third cavities 402 and the second cavities 404 arranged along a first direction. The first surface 301 and the convex surface 302 are located on the inner wall of the third cavities 402. The second surface 303 and the annular surface 304 are located on the inner wall of the fourth cavities 404. The first mold 20 is plate-shaped, which can greatly simplify the design time and cost of the mold. The third cavities 402 and the second cavities 404 may have the same height, thereby ensuring that the pressure of the injected molten material is as consistent as possible and ensuring uniform distribution of the light-transmitting material in a molten state. In other embodiments, the third cavities 402 and the second cavities 404 may also have different heights, depending on considerations such as the difficulty of the molten material conforming to the respective designed surfaces. For example, if the annular surface 304 requires greater pressure to conform, the corresponding fourth cavity 44 can be made relatively deeper.

In some embodiments, as shown in FIG. 63, the first mold 2000 is provided with a first sidewall 33 and a plurality of second sidewalls 34 to form the third cavities 402 and the fourth cavities 404 arranged along a first direction. The first surface 301 and the convex surface 302 are located on the inner wall of the third cavities 402. The second surface 303 and the annular surface 304 are located on the inner wall of the fourth cavities 404. The second mold 3000 is provided with a first sidewall 33 and a plurality of second sidewalls 34 to form fifth cavities 406 arranged along the first direction. Each fifth cavity 406 is aligned with and has the same transverse dimension as each third cavity 402. Each fifth cavity 406 is aligned with and has the same transverse dimension as each fourth cavity 404. Different from the embodiment in FIG. 62, this embodiment further provides the fifth cavities 406 on the second mold 3000. This can reduce the height of the first sidewall 33 and the second sidewall 34 of the first mold 2000, reducing the weight of the first mold 2000. Additionally, the position of the overflow port can be controlled to be in the middle, facilitating the conforming of the molten material to the respective surfaces.

In some embodiments, as shown in FIGS. 39-40, the distance of the gap D2 after pressing can be between 100 and 500 micrometers. It can be understood that if it is too thin, it may be difficult to ensure the overall structural strength of the optical module array; if it is too thick, subsequent separation of the optical module array may be difficult to perform by mechanical cutting. It can be understood that regarding the types and shapes of the relevant mold surfaces or walls, reference can be made to the relevant descriptions in the above embodiments, which will not be repeated.

The present application provides a mold for manufacturing an optical module, the optical module being applied in a near-eye display apparatus, including: a main body, the main body forming a cavity; a first surface and a convex surface are provided at a position corresponding to the cavity, the convex surface protruding relative to the first surface, the convex surface being provided at a center of the first surface; a second surface and an annular surface are also provided at the position corresponding to the cavity, the annular surface surrounding the second surface and being non-coplanar with the second surface, where the first surface and the second surface are arranged parallel to each other or collinearly, the convex surface and the annular surface include any one or a combination of an inclined surface, a spherical surface, an aspherical surface, or a free-form surface, and where the cavity is configured to have a light-transmitting material in a molten state injected therein, the light-transmitting material in a molten state conforming to the first surface and the convex surface, and the second surface and the annular surface, and solidifying to form the optical module. The mold for manufacturing an optical module according to the embodiment of the present application can directly inject the molten material into the cavity of the mold main body, allowing the molten material to conform to the corresponding designed surfaces and solidify, eliminating the need for thicker light-transmitting or transparent materials, reducing material loss during cutting, and thus lowering costs.

The above are only preferred embodiments of the present application and are not intended to limit the present application. Any modifications, equivalent substitutions, improvements, etc. made within the spirit and principle of the present application shall be included within the protection scope of the present application.

What is claimed is:

1. An optical module, applied in a near-eye display module, wherein the optical module comprises:
a first reflection window configured to reflect light;
a second reflection window, spaced apart from the first reflection window at an opposite end of the first reflection window, the second reflection window facing the first reflection window, the second reflection window being configured to receive light reflected from the first reflection window;
an entrance window, disposed at a center of the second reflection window and aligned with the first reflection window, the entrance window being configured to allow light to be incident into a space formed by the first reflection window and the second reflection window; and
an exit window, surrounding the first reflection window, the exit window being disposed opposite to the second reflection window, the exit window being configured to allow light to exit from the space formed by the first reflection window and the second reflection window;
wherein the entrance window is used for mounting a micro-display, and light from the micro-display is incident into the first reflection window from the entrance window, is reflected by the first reflection window to the second reflection window, and then exits through the exit window to form a projected image.

2. The optical module according to claim 1, wherein the first reflection window is any one of an inclined surface, a spherical surface, an aspherical surface, or a free-form surface; the second reflection window is any one of an inclined surface, a spherical surface, an aspherical surface, or a free-form surface, and the first reflection window and the second reflection window are respectively provided with a reflective layer, the reflective layer being a metal reflective layer, the metal reflective layer being configured to reflect light.

3. The optical module according to claim 2, wherein the optical module further comprises a sidewall, one end of the sidewall being connected to the exit window, and the opposite end of the sidewall being connected to the second reflection window; wherein a region enclosed by the first reflection window, the exit window, the sidewall, the second reflection window, and the entrance window is a solid light-transmitting medium with uniform light transmittance, and the reflective layers of the first reflection window and the second reflection window are disposed on a side away from the solid light-transmitting medium.

4. The optical module according to claim 2, wherein the optical module further comprises a sidewall, one end of the sidewall being connected to the exit window, and the opposite end of the sidewall being connected to the second reflection window; wherein a region enclosed by the first reflection window, the exit window, the sidewall, the second reflection window, and the entrance window is hollow, the reflective layer of the first reflection window is coated on a side facing the hollow region, and the reflective layer of the second reflection window is disposed on a side facing or away from the hollow region.

5. The optical module according to claim 3, wherein a transverse dimension of the first reflection window is greater than or equal to a transverse dimension of the entrance window, the first reflection window and the entrance window are center-aligned, the transverse dimension of the first reflection window is greater than or equal to a transverse dimension of the micro-display; and a dimension of a region enclosed by the first reflection window, the exit window, the sidewall, the second reflection window, and the entrance window is from 1 cubic millimeter to 1 cubic centimeter.

6. The optical module according to claim 3, wherein the optical module further comprises a first non-transmissive layer that does not allow light to pass through, the first non-transmissive layer covering the sidewall, the first non-transmissive layer being flush with the second reflection window and the exit window, and allowing the entrance window and the exit window to be exposed relative to the first non-transmissive layer; a transverse dimension of the exit window being equal to a transverse dimension of the second reflection window; wherein the first non-transmissive layer comprises one of a black epoxy resin coating, a black silicone rubber coating, a carbon black coating, a nickel black coating, a black chrome coating, or a Vantablack coating.

7. A near-eye display module, wherein the near-eye display module comprises a micro-display and the optical module according to claim 1, the micro-display is disposed at the entrance window of the optical module.

8. The near-eye display module according to claim 7, further comprising a backplane, the backplane being located on a side of the micro-display away from the entrance window and electrically connected to the micro-display, the backplane being used for connecting to a driving power source.

9. The near-eye display module according to claim 7, wherein the near-eye display module further comprises a light-transmitting layer, the light-transmitting layer being disposed on an end surface of the exit window, the light-transmitting layer covering the exit window and the first reflection window;
an overall size of a structure composed of the first reflection window, the second reflection window, the entrance window, the exit window, a sidewall, the micro-display, and the light-transmitting layer is from 0.5 cubic millimeters to 5 cubic centimeters.

10. The near-eye display module according to claim 7, wherein the micro-display has a resolution of not less than 2 arcminutes per pixel for a wearer's field of view, a pixel-to-pixel pitch of the micro-display not exceeding 5 micrometers; a projected image of the micro-display covers at least an 8° field of view of the wearer, and a magnification of the projected image is not less than 2.5.

11. The near-eye display module according to claim 7, wherein the near-eye display module further comprises a first housing, the first housing is provided with a first connecting portion, the optical module is provided with a second connecting portion, the second connecting portion is integrally formed with the optical module, the first connecting portion and the second connecting portion are matched with each other to adjust a distance between the micro-display and the entrance window.

12. The near-eye display module according to claim 11, wherein the near-eye display module further comprises a flexible member, a material hardness of the flexible member is less than a material hardness of the first housing, and the material hardness of the flexible member is less than a material hardness of the optical module; the first housing is provided with a mounting hole, the flexible member surrounds the optical module, the flexible member is clamped between an inner wall of the mounting hole and the optical module, and the optical module and the inner wall of the mounting hole are tightly fitted together to deform the flexible member at least partially in a circumferential direction and an axial direction.

13. The near-eye display module according to claim 12, wherein the first housing comprises a front cover and a rear cover, a mounting groove is formed between the front cover and the rear cover, the front cover is provided with the mounting hole, the mounting groove and the mounting hole communicating with each other, and the micro-display is at least partially located within the mounting groove.

14. A near-eye display apparatus, wherein the near-eye display apparatus comprises a second housing and the near-eye display module according to claim 7 disposed in the second housing.

15. A method for manufacturing a near-eye display module according to claim 7, wherein the method comprises:
providing a first mold;
providing a second mold, wherein a plurality of convex surfaces, a plurality of first surfaces, a plurality of second surfaces, and a plurality of annular surfaces are comprised between the first mold and the second mold;
injecting a light-transmitting material in a molten state between the first mold and the second mold;
pressing the first mold and the second mold together so that the light-transmitting material in a molten state conforms to the convex surfaces, the first surfaces, the second surfaces, and the annular surfaces;
demolding the first mold and the second mold to obtain a base body formed by solidification of the light-transmitting material; wherein the base body comprises: a concave wall complementary in shape to the convex surfaces, a first wall surrounding the concave wall; and the base body further comprises an annular wall complementary to the annular surfaces, and a second wall surrounded by the annular wall; and
depositing a reflective layer on the concave wall and the annular wall to form a first reflection window and a second reflection window respectively, while without depositing a reflective layer on the first wall and the second wall to form an exit window and an entrance window respectively.

16. The method for manufacturing a near-eye display module according to claim 15, wherein the method further comprises: mounting a micro-display corresponding to the entrance window, cutting a connecting structure between two adjacent base bodies to separate them into individual base bodies, and encapsulating each individual base body to expose the exit window, wherein an encapsulation material is non-transmissive.

17. The method for manufacturing a near-eye display module of claim 15, the method further comprising: cutting a connecting structure between two adjacent base bodies to separate them into a first base body and a second base body;
providing a sleeve for encapsulation, the sleeve being made of a non-transmissive material; the sleeve being provided with a first opening and a second opening;
placing the first base body and the second base body into the sleeve along the first opening and bonding them with an optical adhesive layer; and
pressing the first base body and the second base body together and allowing excess optical adhesive layer to overflow through the second opening;
wherein the method further comprises: placing a micro-display into the sleeve, the sleeve having a wiring hole, at least a portion of the micro-display being exposed relative to the wiring hole, and mounting the micro-display to correspond to the entrance window within the sleeve.

18. The method for manufacturing a near-eye display module according to claim 15, wherein the method further comprises:
providing a light-transmitting layer, a size of the light-transmitting layer being greater than or equal to a size of the exit window;
covering the light-transmitting layer on the first reflection window and the exit window.

19. The method for manufacturing a near-eye display module according to claim 15, wherein before demolding the first mold and the second mold, the method further comprises determining whether a temperature of the light-transmitting material is below a solidification point;
if the temperature of the light-transmitting material is below the solidification point, demolding the first mold and the second mold; if the temperature of the light-transmitting material is not below the solidification point, controlling the temperature of the light-transmitting material to reach below the solidification point.

20. The method for manufacturing a near-eye display module according to claim 15, wherein both of the first mold and the second mold comprise a plurality of convex surfaces and a plurality of annular surfaces arranged in an array; or
one of the first mold and the second mold comprises a plurality of convex surfaces and a plurality of annular surfaces arranged in an array;
the convex surfaces and the annular surfaces include any one or a combination of an inclined surface, a spherical surface, an aspherical surface, or a free-form surface.
